(19) United States
(12) Patent Application Publication
(10) Pub. No.: US 2017/0022458 A1
(43) Pub. Date: Jan. 26, 2017

(54) CONSUMER PRODUCTS HAVING AN ASEPSIS CONNOTATION

(71) Applicant: The Procter & Gamble Company, Cincinnati, OH (US)

(72) Inventors: Rafael TRUJILLO, Mason, OH (US); Katrina San Gabriel REYES, Singapore (SG); Junji HAMANO, Singapore (SG); Hiroki ITO, Singapore (SG)

(21) Appl. No.: 15/214,734

(22) Filed: Jul. 20, 2016

Related U.S. Application Data
(60) Provisional application No. 62/194,486, filed on Jul. 20, 2015.

(51) Int. Cl. C11D 3/50; C11D 17/00; B01J 13/04; C11B 9/00; B01J 13/06

(52) U.S. Cl. CPC C11D 3/505; C11B 9/0015; C11B 9/0061; B01J 13/06; B01J 13/043; C11D 3/50; C11D 17/0039

(57) ABSTRACT

The present application relates to perfume compositions, delivery systems comprising such perfumes products comprising such perfumes and/or delivery systems, and processes for making and using same. Such perfume compositions, delivery systems comprising such perfumes and products containing such perfumes and/or delivery systems can deliver a character that can signal/connotes that a situs treated with such materials has superior cleanliness and is essentially asepsis.

### FIELD OF INVENTION

The present application relates to perfume compositions, delivery systems comprising such perfumes, products comprising such perfumes and/or delivery systems, and processes for making and using same.

### BACKGROUND OF THE INVENTION

Perfumes are formulated to provide a product with a pleasing smell. Generally, individuals use products, at least in part, because of the pleasant smell. As a result many products are used incorrectly and/or for the wrong application. Thus, what is needed is a perfume that can identify a particular benefit of a product so that the consumer uses such product as intended. Here, in addition to providing a pleasing smell, the inventors have found that specific combinations of perfume raw materials (PRM's) provide a character that can signal/connotes that a situs treated with such perfume has superior cleanliness and is essentially asepsis. When incorporated into a perfume delivery system and/or a consumer product such perfume continues to deliver such connotation.

### SUMMARY OF THE INVENTION

The present application relates to perfume compositions, delivery systems comprising such perfumes, products comprising such perfumes and/or delivery systems, and processes for making and using same.

### BRIEF DESCRIPTION OF THE DRAWINGS

FIG. 1 depicts the average attribute score for germ removal of the different odors of Example 49.

FIG. 2 depicts the average attribute score for germ kill of the different odors of Example 49.

FIG. 3 depicts the average attribute score for cleanliness of the different odors of Example 49.

FIG. 4 depicts the average self-reporting scores for hedonicity of the different odors of Example 49.

FIG. 5 depicts the average self-reporting scores for intensity of the different odors of Example 49.

FIG. 6 depicts the average self-reporting scores for cleanliness of the different odors of Example 49.

FIGS. 7A-7C show the scoring for different attributes based on odorants in Example 50. FIG. 7A shows the scoring for sanitized/hygienic attribute. FIG. 7B shows the scoring for the clean attribute. FIG. 7C shows the scoring for the proud attribute.

FIG. 8A-8F show the scoring for different attributes based on odorants in Example 51. FIG. 8A show hygiene scores. FIG. 8B shows cleanliness scores. FIG. 8C shows proud scores. FIG. 8D shows hedonicity scores. FIG. 8E shows hygiene scores. FIG. 8F shows intensity scores.

FIGS. 9A-9F show the scoring for different attributes based on odorants in Example 52. FIG. 9A show germ removal scores. FIG. 9B shows germ kill scores. FIG. 9C shows cleanliness scores. FIG. 9D shows hedonicity scores. FIG. 9E shows cleanliness scores. FIG. 9F shows intensity scores.

FIG. 10 shows the participant cleansing brand use history over the past 6 months for the participants as described by Example 53.

FIG. 11 shows the average assessment score for the “germ removal” attribute for each of odors 1-3 as described by Example 53.

FIG. 12 shows the average assessment score for the “germ kill” attribute for each of odors 1-3 as described by Example 53.

FIG. 13 shows the average assessment score for the “clean” attribute for each of odors 1-3 as described by Example 53.

FIG. 14 shows the average self-report assessment score for the impression of “hedonicity” for each of odors 1-3 as described by Example 53.

FIG. 15 shows the average self-report assessment score for the impression of “cleanliness” for each of odors 1-3 as described by Example 53.

FIG. 16 shows the average self-report assessment score for the impression of “intensity” for each of odors 1-3 as described by Example 53.

FIG. 17 shows the average assessment score for the “germ kill” attribute by participant cleansing brand use history for each of odors 1-3 as described by Example 53.

FIG. 18 shows the average assessment score for the “germ kill” attribute by participant cleansing fragrance use history for each of odors 1-3 as described by Example 53.

FIG. 19 shows the average assessment score for the “germ kill” attribute for each of the kitchen images tested with each of odors 1-3 as described by Example 53.

FIG. 20 shows the participants' overall rating of the odors as described by Example 54.

FIG. 21 shows the participants' overall rating of the odors categorized by brand product user as described by Example 54.

FIG. 22 shows the participants' perception of the attribute of “hygiene” as described by Example 54.

FIG. 23 shows the participants' perception of the attribute of “germ kill” categorized by brand product user as described by Example 54.

FIG. 24 shows the participants' perception of the attribute of “germ removal” categorized by brand product user as described by Example 54.

FIG. 25 shows the participants' perception of product suitability as described by Example 54.

FIG. 26 shows the participants' perception of product strength as described by Example 54.

### DETAILED DESCRIPTION OF THE INVENTION

### Definitions

As used herein “consumer product” means baby care, beauty care, fabric & home care, family care, feminine care, health care, or devices intended to be used or consumed in the form in which it is sold, and not intended for subsequent commercial manufacture or modification. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use; and shaving products, products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, and feminine napkins.

As used herein, the term “cleaning and/or treatment composition” includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, car or carpet shampoos, bathroom cleaners; hair shampoos and hair-rinses; shower gels and foam baths and metal cleaners; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists.

As used herein, the term “fabric care composition” includes, unless otherwise indicated, fabric softening compositions, fabric enhancing compositions, fabric freshening compositions and combinations thereof.

As used herein, the articles “a” and “an” when used in a claim, are understood to mean one or more of what is claimed or described.

As used herein, the terms “include”, “includes” and “including” are meant to be synonymous with the phrase “including but not limited to”.

As used herein, the term “solid” includes granular, powder, bar and tablet product forms.

As used herein, the term “situs” includes paper products, fabrics, garments, hard surfaces, hair and skin.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Perfume

Table 1 contains five perfume formulas. Applicants discovered that four of such perfumes, perfumes 1 and 3-5, deliver a character that can signal/connotes that a situs treated with such a perfume has superior cleanliness and is essentially asepsis.

TABLE 1

| | | | | Perfume | Perfume | Perfume | Perfume | Perfume |
|---|---|---|---|---|---|---|---|---|
| No. | Common Name | CAS No. | IUPAC Name | 1 | 2 | 3 | 4 | 5 |
| 1 | ALDEHYDE C- | 112-54-9 | Dodecanal | — | 0.150 | — | 0.250 | 0.030 |
| | 12 LAURIC | | | | | | | |
| 2 | DECENAL, CIS- | 21662-09-9 | (Z)-dec-4-enal | 0.050 | 0.100 | 0.0513 | 0.100 | 0.020 |
| | 4 | | | | | | | |
| 3 | DECENAL, | 3913-81-3 | (E)-dec-2-enal | 0.005 | 0.010 | 0.001026 | 0.010 | 0.002 |
| | TRANS-2, | | | | | | | |
| 4 | MANDARIN | 20407-84-5 | trans-2- | 0.500 | 1.000 | 0.256 | 0.500 | 0.200 |
| | ALDEHYDE | | Dodecenal | | | | | |
| | 10% TEC | | | | | | | |
| 5 | CYMENE, | 99-87-6 | 1-methyl-4- | 3.750 | — | 3.846 | 1.25 | 1.500 |
| | PARA, | | propan-2- | | | | | |
| | | | ylbenzene | | | | | |
| 6 | LEMON OIL | 68917-33-9 | N/A | — | — | — | — | 0.700 |
| | TERPENES | | | | | | | |
| | WHITE | | | | | | | |
| 7 | LIMONENE | 68921-26-6 | N/A | 0.250 | — | 0.256 | 0.250 | 0.100 |
| | THIOL 1% TEC | | | | | | | |
| | 10% TEC | | | | | | | |
| 8 | LINALOOL | 1365-19-1 | 2-(5-methyl-5- | — | — | — | — | 0.007 |
| | OXIDE | 11063-76-6 | vinyltetrahydro- | | | | | |
| | | | 2-furanyl)-2- | | | | | |
| | | | propanol | | | | | |
| 9 | ORANGE OIL | 8008-57-9 | N/A | 50.000 | — | 12.821 | 5.000 | 40.000 |
| | PERA BRAZIL | | | | | | | |
| 10 | ORANGE OIL | 8028-48-6 | N/A | — | — | 12.821 | 7.500 | 20.000 |
| | TERPENES | | | | | | | |
| | WHITE | | | | | | | |
| 11 | OXANE 969380/ | 0059323-76- | 1,3-Oxathiane, | 0.150 | 0.300 | 0.1026 | 0.100 | 0.030 |
| | TEC 50% | 1 | 2-methyl-4- | | | | | |
| | | | propyl-, cis- | | | | | |
| 12 | RHUBAFURAN | 82461-14-1 | 2,4-dimethyl-4- | 0.075 | 0.150 | 0.0513 | 0.050 | 0.030 |
| | | | phenyloxolane | | | | | |
| 13 | RINGONOL 50 | 38462-22-5 | mercaptomenthone- | 0.050 | 0.100 | 0.0513 | 0.050 | 0.020 |
| | TEC | | 8 | | | | | |
| 14 | TERPINOLENE | 586-62-9 | 1-methyl-4- | — | 1.750 | 1.026 | — | 0.350 |
| | 20 | | propan-2- | | | | | |
| | | | ylidenecyclohexene | | | | | |
| 15 | THIOGERANIOL | 39067-80-6 | (2E)-3,7- | 0.00075 | 0.0015 | 0.000769 | 0.00075 | 0.0003 |
| | | | dimethylocta- | | | | | |
| | | | 2,6-diene-1-thiol | | | | | |
| 16 | THYMOL | 89-83-8 | 5-methyl-2- | 1.000 | 2.000 | 1.0260 | 0.500 | 0.400 |
| | CRYSTALS | | propan-2- | | | | | |
| | | | ylphenol | | | | | |
| 17 | CITRONELLYL | 150-84-5 | 3,7-dimethyloct- | | — | — | 7.500 | 0.150 |
| | ACETATE | | 6-enyl acetate | | | | | |
| 18 | DIMETHYL | 85-91-6 | methyl 2- | — | 3.500 | — | 1.500 | 0.700 |
| | ANTHRANILATE | | methylaminobenzoate | | | | | |
| 19 | EUGENOL | 97-53-0 | 2-Methoxy-4-(2- | 0.0375 | — | 0.1282 | 0.025 | 0.015 |
| | | | propen-1-yl)- | | | | | |
| | | | phenol | | | | | |
| 20 | INDOLE | 120-72-9 | 1H-indole | | 0.001 | | 0.001 | 0.0002 |
| | CRYSTALS | | | | | | | |
| 21 | METHYL | 134-20-3 | Benzoic acid, 2- | — | 0.0035 | — | — | 0.0007 |
| | ANTHRANILATE | | amino-, methyl | | | | | |
| | | | ester | | | | | |
| 22 | METHYL | 39924-52-2 | methyl 2-(3-oxo- | — | 0.10 | — | 0.050 | 0.020 |
| | JASMONATE | | 2-pent-2- | | | | | |
| | | | enylcyclopentyl) | | | | | |
| | | | acetate | | | | | |
| 23 | DYNASCONE | 23696-85-7 | 1-(2,6,6- | .0375 | .0750 | 0.0513 | 0.025 | 0.015 |
| | NEAT 939.745 | | Trimethyl-1,3- | | | | | |
| | | | cyclohexadien-1- | | | | | |
| | | | yl)-2-butene-1- | | | | | |
| | | | one | | | | | |
| 24 | GALBANUM | 8023-91-4 | ferula | 0.0075 | 0.0015 | 0.005128 | 0.025 | 0.0003 |
| | OIL A NAT | | galbaniflua resin | | | | | |
| | | | oil | | | | | |
| 25 | HEXEN-1-OL, | 928-96-1 | (Z)-hex-3-en-1- | 3.750 | 7.500 | 3.846 | 1.000 | 1.500 |
| | CIS-3, | 95123-47-0 | ol | | | | | |
| 26 | HEXENAL, | 6728-26-3 | (E)-hex-2-enal | 0.050 | 0.100 | 0.0513 | 0.050 | 0.020 |
| | TRANS-2, | | | | | | | |
| 27 | PERILLA | 2111-75-3 | 4-prop-1-en-2- | 0.500 | 1.000 | 0.256 | 0.250 | 0.200 |
| | ALDEHYDE | | ylcyclohexene-1- | | | | | |
| | | | carbaldehyde | | | | | |
| 28 | PHELLANDRENE, | 99-83-2 | 2-methyl-5- | — | 0.500 | 0.513 | 0.250 | 0.100 |
| | ALPHA | | propan-2- | | | | | |
| | | | ylcyclohexa-1,3- | | | | | |
| | | | diene | | | | | |
| 29 | LINALOOL | 78-70-6 | 3,7-Dimethyl- | 17.500 | 35.000 | 25.641 | 20.000 | 7.000 |
| | | 11024-20-7 | 1,6-octadiene-3- | | | | | |
| | | | ol | | | | | |
| 30 | DIPROPYLENE | 25265-71-8 | 3-(3- | 22.28675 | 46.6575 | 37.19778 | 40.500 | 25.2398 |
| | GLYCOL | | hydroxypropoxy) | | | | | |
| | | | propan-1-ol | | | | | |
| 31 | TRIETHYL | 77-93-0 | triethyl 2- | — | — | — | — | 1.6497 |
| | CITRATE | | hydroxypropane- | | | | | |
| | | | 1,2,3- | | | | | |
| | | | tricarboxylate | | | | | |

A fragrance accord is a combination of two of more compounds, which provides a scent different from that of the individual compounds. Thus, additional perfumes/fragrance accords that can provide deliver a character that can signal/connotes that a situs treated with such a perfume has superior cleanliness and is essentially asepsis are provided below.

A fragrance accord includes, but is not limited to, one or more fragrance compounds. In one non-limiting example, a fragrance accord includes, but is not limited to, one or more a citrus compound(s), and/or one or more herbal/aromatic compound(s) and/or one or more fruity compound(s), or combinations thereof.

In one aspect, a fragrance composition for eliciting a consumer's perception of hygiene comprising at least one fragrance accord, wherein said fragrance accord comprises (i) two or more sulfur containing components; and (ii) at least one additional component selected from the group consisting of a citrus component, herbal component, fruity component, and combinations thereof is disclosed.

A fragrance composition comprising: aldehyde c-12 lauric; decenal, cis-4; decenal, trans-2; mandarin aldehyde 10% TEC; Cymene, P; Lemon Oil Terpenes White; Limonene Thiol 1% TEC 10% TEC; Orange Oil Pera Brazil; Orange Oil Terpenes White; Oxane 969380/TEC 50%; Rhubafuran; Ringonol 50 TEC; Terpinolene 20; Thiogeraniol; Thymol Crystals; Citronellyl Acetate; Dimethyl Anthranilate; Eugenol; Indole Crystal; Methyl Anthranilate, Meth Jasmonate; Perilla Aldehyde; Phellandrene, Alpha; Linalool Syn; Dynascone Neat 939.745; Galbanum Oil A Nat; Hexen-1-Ol, Cis-3; Hexenal, trans-2; Perilla Ald; Phellandrene, Alpha; Linalool Syn; and Triethyl Citrate is disclosed.

A fragrance composition comprising: Cymene, P; decenal, cis-4 @ 10% in DPG; decenal, trans-2, @ 1% in DPG; dipropylene glycol; Dynascone Neat 939.745 @ 10% in DPG; Eugenol @ 10% in DPG; Galbanum Oil A Nat @ 1% in DPG; Hexen-1-ol, Cis-3; Hexenal, trans-2 @ 10% in DPG; Limonene Thiol 1% TEC 10% TEC; Linalool Syn; mandarin aldehyde 10% TEC; Orange Pera Brazil Nat EO; Oxane 969380 @ 10% in TEC; Perilla Aldehyde; Rhubafuran @ 10% in DPG; Ringonol 50 @ 10% in TEC; Thiogeraniol @ 0.1% in TEC; and Thymol Crystals is disclosed.

A fragrance composition comprising: aldehyde c-12 lauric @ 10% in DPG; decenal, cis-4 @ 10% in DPG; decenal, trans-2 @ 1% in DPG; dimeth anth; dipropylene glycol; Dynascone Neat 939.745; Galbanum Nat EO @ 1% in DPG; Hexen-1-ol, Cis-3; Hexenal, trans-2, @ 10% in DPG; Indole Crystal @ 0.1% in DPG; Linalool Syn; mandarin aldehyde 10% TEC; Methyl Anthranilate @ 1% in DPG; Meth Jasmonate @ 10% in DPG; Oxane 969380 @ 10% in DPG; Perilla Aldehyde; Phellandrene, Alpha; Rhubafuran @ 10% in DPG; Ringonol 50 @ 10% in TEC; Terpinolene 20; Thiogeraniol @ 0.1% in TEC; and Thymol Crystals is disclosed.

A fragrance composition comprising: Cymene, P; decenal, cis-4 @ 10% in DPG; decenal, trans-2 @ 1% in DPG; dipropylene glycol; Dynascone Neat 939.745 @ 10% in DPG; Eugenol @ 10% in DPG; Galbanum Nat EO @ 1% in DPG; Hexen-1-Ol, Cis-3; Hexenal, trans-2, @ 10% in DPG; Limonene Thiol 1% TEC 10% TEC; Linalool Syn; mandarin aldehyde 10% TEC; Orange Pera Brazil Nat EO; Orange White Terpenes Nat EO; Oxane 969380 @ 10% in TEC; Perilla Aldehyde; Phellandrene, Alpha; Rhubafuran @ 10% in DPG; Ringonol 50 @ 10% in TEC; Terpinolene 20; Thiogeraniol @ 0.1% in TEC; and Thymol Crystals is disclosed.

A fragrance composition comprising: aldehyde c-12 lauric @ 10% in DPG; citronellyl acetate; Cymene, P; decenal, cis-4 @ 10% in DPG; decenal, trans-2 @ 1% in DPG; dimeth anth; dipropylene glycol; Dynascone Neat 939.745 @ 10% in DPG; Eugenol @ 10% in DPG; Galbanum Nat EO @ 1% in DPG; Hexen-1-Ol, Cis-3; Hexenal, trans-2, @ 10% in DPG; Indole cryst @ 0.1% in DPG; Limonene Thiol 1% TEC 10% TEC; Linalool Syn; mandarin aldehyde 10% TEC; meth jasmonate @ 10% in DPG; Orange Pera Brazil Nat EO; Orange White Terpenes Nat EO; Oxane 969380 @ 10% in TEC; Perilla Aldehyde; Phellandrene, Alpha; Rhubafuran @ 10% in DPG; Ringonol 50 @ 10% in TEC; Thiogeraniol @ 0.1% in TEC; and Thymol Crystals is disclosed.

In certain embodiments, the one or more citrus compounds include, but are not limited to, citrus oils or extracts such as orange, lime, grapefruit, litsea cubeba essential oils, concentrated citrus oils (folded oils), citronellol (3,7-dimethyloct-6-en-1-ol) [CAS No. 106-22-9], dodecane nitrile [CAS No. 2437-25-4], citronellyl nitrile (3,7-Dimethyl-6-octenenitrile) [CAS No. 51566-62-2], clonal, limonene (1-methyl-4-(1-methylethenyl)-cyclohexene) [CAS No. 138-86-3], citral ((2E)-3,7-dimethylocta-2,6-dienal) [CAS Nos. 141-27-5, 5392-40-5], iso-cyclo citral (2,4,6-trimethyl-cyclohex-3-ene-1-carbaldehyde) [CAS No. 1335-66-6], nerol ((2Z)-3,7-dimethylocta-2,6-dien-1-ol) [CAS No. 106-25-2], citronellal (3,7-dimethyloct-6-enal) [CAS No. 106-23-0], Dihydromyrcenol [CAS No. 18479-58-8], farnesene, nopol (2-(6,6-dimethyl-4-bicyclo[3.1.1]hept-3-enyl)ethanol) [CAS No. 128-50-7], nopyl acetate (2-(6,6-Dimethyl-bicyclo[3.1.1]hept-2-ene-2-yl) ethyl acetate) [CAS No. 128-51-8] and other essential oils, extract fractions or isolates containing >50% limonene, or >50% citral, or >50% citronellal compounds by weight, and combinations thereof.

In certain embodiments, the one or more herbal/aromatic compounds include, but are not limited to, bornyl acetate ((4,7,7-trimethyl-3-bicyclo[2.2.1]heptanyl) acetate) [CAS No. 125-12-2], iso-bornyl acetate ([(1R,3S,4S)-4,7,7-trimethyl-3-bicyclo[2.2.1]heptanyl] acetate) [CAS No. 125-12-2], pinene alpha (6,6-trimethylbicyclo[3.1.1]hept-3-ene) [CAS No. 80-56-8], pinene beta (6,6-dimethyl-4-methylidenebicyclo[3.1.1]heptane) [127-91-3], pine oils, terpinolene 20 (1-methyl-4-propan-2-ylidenecyclohexene) [CAS Number: 586-62-9], terpinolene 90(1-methyl-4-propan-2-ylidenecyclohexene) [CAS Number: 586-62-9], terpinene alpha (1-Isopropyl-4-methyl-1,3-cyclohexadiene) [CAS No. 99-86-5], alpha-terpineol (2-(4-methylcyclohex-3-en-1-yl)propan-2-ol) [CAS No. 98-55-5], terpine gama (1-methyl-4-propan-2-ylcyclohexa-1,4-diene) [CAS No. 99-85-4], DH terpineol (2-(4-methylcyclohexyl)propan-2-ol) [CAS No. 58985-02-7], terpinol, terpinyl acetate ((±)-2-(4-Methyl-3-cyclohexenyl)isopropyl acetate) [CAS No. 80-26-2], terpineol (2-(4-methylcyclohex-3-en-1-yl)propan-2-ol) [CAS No. 98-55-5], Linalool (3,7-Dimethyl-1,6-octadiene-3-ol) [CAS No. 78-70-6 11024-20-7], linalyl esters such as linanlyl acetate (3,7-dimethylocta-1,6-dien-3-yl acetate) [CAS No. 115-95-7], and essential oils or extracts containing >50% linalool and linalyl acteate combined (i.e., lavender oils) by weight, thymol (5-methyl-2-propan-2-ylphenol) [CAS No. 89-83-8], essential oils or extracts containing >50% thymol by weight, essential oils containing a combination of >50% of pinene alpha and pinene beta by weight, and combinations thereof.

In certain embodiments, the one or more fruity compounds include, but are not limited to, raspberry ketone (4-(4-Hydroxyphenyl)-2-butanone) [CAS No. 5471-51-2], esters of aliphatic saturated linear or branched fatty acids with a number of carbon atoms from C₂-C₇, reacted with aliphatic saturated or unsaturated linear or branched alcohols with a number of carbon atoms from C₁-C₇, and combinations thereof. In certain embodiments, the total number of carbon atoms is less than 12. In certain embodiments, the total number of carbon atoms is less than 10.

In certain embodiments, the compositions also include one or more solvents or diluents. Such solvents or diluents include but are not limited to dipropylene glycol (DPG) (3-(3-hydroxypropoxy)propan-1-ol) [CAS Number: 25265-71-8], triethyl citrate (triethyl 2-hydroxypropane-1,2,3-tricarboxylate) [CAS Number: 77-93-0], and combinations thereof. Additional solvents or diluents known in the art can also be used. The specific solvent used will depend on the particular end use product. As such, additional known solvents in the art can be used as appropriate.

In certain embodiments, the one or more citrus, herbal/aromatic and/or fruity compounds are formulated in an accord at a concentration from about 0.001% to about 99% by weight, or from about 0.01% to about 90% by weight, or from about 0.1% to about 80% by weight, or from about 1% to about 70% by weight, or from about 2% to about 60% by weight, or from about 5% to about 50% by weight, or from about 10% to about 40% by weight, or from about 15% to about 30% by weight, or from about 20% to about 25% by weight.

In certain embodiments, the one or more citrus compounds are formulated in an accord at a concentration of more than about 30%, more than about 40%, or more than about 50% by weight. In certain embodiments, the one or more herbal/aromatic compounds are formulated in an accord at a concentration of less than about 50%, or less than about 30% by weight. In certain embodiments, the one or more fruity compounds are formulated in an accord at a concentration of less than about 5% by weight. In certain embodiments, the remainder of the compounds in the accord should constitute less than about 50%, or less than about 25%, by weight.

In another embodiment, the one or more citrus compounds are present in an accord at a concentration from about 0.2% to about 50% or from about 0.2% to about 60% by weight. In certain embodiments, the one or more herbal/aromatic compounds are present in an accord at a concentration from about 0.2% to about 35% or from about 0.5% to about 37% by weight.

In certain embodiments, the one or more solvents are present in an accord at a concentration from about 10% to about 50% or from about 15% to about 40% by weight.

In certain embodiments, the fragrance compositions of the presently disclosed subject matter comprise one or more accords. In certain embodiments, the fragrance compositions of the present disclosure comprise two or more accords, or three or more accords. In certain embodiments, the fragrance compositions of the present disclosure comprise four fragrance accords.

In certain embodiments, the one or more floral compounds include, but are not limited to, Citronellyl Acetate; Dimethyl Anthranilate; Eugenol; Indole Crystal; Methyl Anthranilate, Meth Jasmonate; and combinations thereof.

In certain embodiments, the one or more green compounds include, but are not limited to, Dynascone Neat 939.745; Galbanum Oil A Nat; Hexen-1-Ol, Cis-3; Hexenal, Trans-2; and combinations thereof.

In certain embodiments, the accords of the presently disclosed subject matter comprise a least one, at least two, at least three, or at least four sulfur-containing compounds. In certain embodiments, the sulfur-containing compound is selected from the group consisting of limonene thiol [CAS No. 68921-26-6], thiogeraniol ((2E)-3,7-dimethylocta-2,6-diene-1-thiol) [CAS No. 39067-80-6], ringonol (mercapto-3-menthone) [CAS No. 38462-22-5], oxane (e.g., 1,3-Oxathiane, 2-methyl-4-propyl-, cis-, CAS No. 0059323-76-1), and combinations thereof. In specific embodiments, the accord comprises thiogeraniol and rigonol.

In certain embodiments, the one or more sulfur containing compounds are present in an accord at a concentration of about 0.0001 to about 1.5% by weight. In certain embodiments, the one or more sulfur containing compounds are present in an accord at a concentration of about 0.025% by weight. In certain embodiments, the accord comprises 0.0001% limonene thiol, 0.0003% thiogeraniol, 0.01% ringonol, and 0.015% oxane by weight. In certain embodiments, the accord comprises about 0.0001 to about 0.01% limonene thiol by weight. In certain embodiments, the accord comprises about 0.0003 to about 0.03% thiogeraniol by weight. In certain embodiments, the accord comprises about 0.01 to about 1.0% ringonol by weight. In certain embodiments, the accord comprises about 0.015 to about 1.5% oxane by weight.

In certain embodiments, the fragrance compositions can comprise one or more accords and one or more additional fragrance compounds. In certain embodiments, the fragrance compositions can comprise two or more accords and one or more additional fragrance compounds. In certain embodiments, the fragrance compositions can comprise three or more accords and one or more additional fragrance compounds. In certain embodiments, the additional fragrance compounds in the accord constitute less than about 50%, or less than about 25%, by weight.

In certain embodiments, the fragrance compositions of the presently disclosed subject matter comprise an accord consisting of at least one citrus, herbal/aromatic and/or fruity compound and combinations thereof. In certain embodiments, the ratio of citrus to aromatic/herbal compounds is from about 7:1 to about 0.65:1. In certain embodiments, the ratio of citrus to aromatic/herbal compounds is from about 5:1 to about 1:1.

In certain embodiments, the accords are formulated in an composition at a concentration from about 0.001% to about 99% by weight, or from about 0.01% to about 90% by weight, or from about 0.1% to about 80% by weight, or from about 1% to about 70% by weight, or from about 2% to about 60% by weight, or from about 5% to about 50% by weight, or from about 10% to about 40% by weight, or from about 15% to about 30% by weight, or from about 20% to about 25% by weight. In other embodiments, the accords are formulated in a composition at a concentration from about 1.0% to about 99% by weight, or from about 10% to about 99% by weight, or from about 20% to about 99% by weight, or from about 30% to about 99% by weight, or from about 40% to about 99% by weight, or from about 50% to about 99% by weight, or from about 60% to about 99% by weight, or from about 70% to about 99% by weight, or from about 80% to about 99% by weight, or from about 85% to about 99% by weight, or from about 90% to about 99% by weight.

In certain embodiments, one or more citrus compounds are present in a fragrance composition comprising one or more accords at a concentration from about 0.0003% to about 40% or from about 0.0003% to about 65% by weight. In certain embodiments, one or more herbal/aromatic compounds are present in a fragrance composition comprising one or more accords at a concentration from about 0.1% to about 7.0% or from about 0.1% to about 10% by weight. In certain embodiments, one or more fruity compounds are present in a fragrance composition comprising one or more accords at a concentration from about 0.0003% to about 1.5% or from about 0.0003% to about 2.0% by weight. In certain embodiments, one or more solvents are present in a fragrance composition comprising one or more accords at a concentration from about 1.5% to about 26.0% or from about 1.5% to about 30.0% by weight.

### Consumer Products and Perfume Delivery Systems

A consumer product comprising:

a) selected from the group consisting of Table 1 perfumes 1, 3, 4, and 5, preferably said perfume is selected from the group consisting of Table 1 perfumes 1 and 5, more preferably said perfume is Table 1 Perfume 5; and

b) a cleaning and/or treatment ingredient is disclosed.

A perfume delivery system selected from the group consisting of a Polymer Assisted Delivery (PAD) system, Molecule-Assisted Delivery (MAD) system, Cyclodextrin (CD) system, Starch Encapsulated Accord (SEA) system, Zeolite & Inorganic Carrier (ZIC) system, said perfume delivery system comprising a perfume selected from the group consisting of Table 1 perfumes 1, 3, 4, and 5, a perfume is selected from the group consisting of Table 1 perfumes 1 and 5, or Table 1 Perfume 5, is disclosed.

In one aspect, said perfume delivery system is a Polymer Assisted Delivery (PAD) system according to claim 2, wherein said Polymer Assisted Delivery (PAD) system comprises a Polymer Assisted Delivery (PAD) Reservoir system.

In one aspect, said Polymer Assisted Delivery (PAD) Reservoir system comprises a perfume delivery particle that comprises a shell material and a core material, said shell material encapsulating said core material, said core material comprising a perfume selected from the group consisting of Table 1 perfumes 1, 3, 4, and 5, a perfume is selected from the group consisting of Table 1 perfumes 1 and 5, or Table 1 Perfume 5; said shell comprising a material selected from the group consisting of polyethylenes; polyamides; polystyrenes; polyisoprenes; polycarbonates; polyesters; polyacrylates; aminoplasts, preferably said aminoplast comprises a polyureas, polyurethane, and/or polyureaurethane, preferably said polyurea comprises polyoxymethyleneurea and/or melamine formaldehyde; polyolefins; polysaccharides, preferably said polysaccharides comprises alginate and/or chitosan; gelatin; shellac; epoxy resins; vinyl polymers; water insoluble inorganics; silicone; and mixtures thereof.

In one aspect of said perfume delivery particle, said perfume delivery particle's shell comprises melamine formaldehyde and/or cross linked melamine formaldehyde.

In one aspect, said perfume delivery particle's shell is coated by a water-soluble cationic polymer selected from the group that consists of polysaccharides, cationically modified starch and cationically modified guar, polysiloxanes, dimethyldiallylammonium polyhalogenides, copolymers of dimethyldiallylammonium polychloride and vinyl pyrrolidone, acrylamides, imidazoles, imidazolinium halogenides and imidazolium halogenides and polyvinyl amine and its copolymers with N-vinyl formamide.

In one aspect of said perfume delivery particle, said coating that coats said perfume delivery particle's shell, comprises a cationic polymer and an anionic polymer.

In one aspect of said perfume delivery particle said cationic polymer comprises hydroxyl ethyl cellulose; and said anionic polymer comprises carboxyl methyl cellulose.

In one aspect, said perfume delivery particle is a perfume microcapsule.

In one aspect, a consumer product comprising a perfume delivery system comprising a perfume selected from Table 1 perfumes 1, 3-5 and mixtures thereof, a perfume is selected from the group consisting of Table 1 perfumes 1 and 5, or Table 1 Perfume 5 is disclosed.

In one aspect, a consumer product comprising a perfume delivery system comprising a perfume selected from Table 1 perfumes 1, 3-5 and mixtures thereof, a perfume is selected from the group consisting of Table 1 perfumes 1 and 5, or Table 1 Perfume 5; and/or a perfume selected from Table 1 perfumes 1, 3-5 and mixtures thereof, a perfume is selected from the group consisting of Table 1 perfumes 1 and 5, or Table 1 Perfume 5 is disclosed.

In one aspect, the perfumes and/or delivery systems comprising same that are disclosed herein may be incorporated into solid particles, particularly polymeric based particles. Preferably said perfume delivery system is a microcapsule that comprises said perfume one or more of said perfumes. Examples of such polymeric particles may include particles comprising polyethylene glycol, starches and polysaccharides, polyvinyl alcohol, celluloses. Such particles may additionally comprise additional components such as other benefit agents, inorganic fillers such as carbonate, silicate, clay, metal oxides. Particularly useful particles include particles based on polyethylene glycol.

In one aspect, such composition may be a consumer product that may comprise, based on total composition weight, from about 0.001% to about 50%, from about 0.01% to about 10%, or even from about 0.1% to about 5%, of a perfume disclosed in the present specification—from about 0.001% to about 90%, from about 0.01% to about 50%, or even from about 0.1% to about 10%, of said perfume, based on said perfume's weight, may be provided by a perfume delivery system according to the present specification.

In one aspect, said composition may comprise an encapsulate wherein said encapsulate' s density may be such that the density ratio of said encapsulate to one or more fluids of the composition's fluids may be from about 0.9:1 to about 1.1:1; from about 0.98:1 to about 1.02:1; from about 0.99:1 to about 1.01:1 or even 1:1.

While the precise level of encapsulate that is employed depends on the type and end use of the consumer product, in one aspect a consumer product may comprise, based on total composition weight, at least about 0.01%, from about 0.01% to about 80%, or even from about 0.02% to about 10% wt % of a encapsulate disclosed herein.

In one aspect, a consumer product that is compact is disclosed.

In one aspect, a consumer products including liquid detergents having a water content, based on total consumer product formulation weight, of from about 0% to about 15%, from about 0.01% to about 15%,from about 0.5% to about 10% or even from about 1% to about 8% water are disclosed.

In one aspect, the consumer product is a cleaning and/or treatment composition or fabric care composition that may comprise an encapsulate disclosed in the present specification and at least one cleaning and/or treatment composition or fabric care adjunct ingredient.

In one aspect, a cleaning composition may comprise, from about 0.005% to about 5% weight % of such encapsulate based on total cleaning composition weight of such encapsulate. In one aspect, a fabric treatment composition may comprise, based on total fabric treatment composition weight from about 0.005% to about 20% of such encapsulate.

Aspects of the invention include the use of the encapsulates of the present invention in detergent compositions (e.g., TIDE™), hard surface cleaners (e.g., MR CLEAN™), automatic dishwashing liquids (e.g., CASCADE™), dishwashing liquids (e.g., DAWN™), and floor cleaners (e.g., SWIFFER™). The cleaning compositions disclosed herein may be formulated such that, during use in aqueous cleaning operations, the wash water will have a pH of between about 6.5 and about 12, or between about 7.5 and 10.5. Liquid dishwashing product formulations typically have a pH between about 6.8 and about 9.0. Cleaning products are typically formulated to have a pH of from about 2 to about 11. Techniques for controlling pH at recommended usage levels include the use of buffers, alkalis, acids, etc., and are well known to those skilled in the art.

Fabric treatment compositions disclosed herein typically comprise a fabric softening active (“FSA”). Suitable fabric softening actives, include, but are not limited to, materials selected from the group consisting of quats, amines, fatty esters, sucrose esters, silicones, dispersible polyolefins, clays, polysaccharides, fatty oils, polymer latexes and mixtures thereof.

### Formaldehyde Scavenger

In one aspect, the perfume delivery system disclosed herein may be combined with a formaldehyde scavenger. In one aspect, such perfume delivery system may comprise the encapsulates of the present invention. Suitable formaldehyde scavengers include materials selected from the group consisting of sodium bisulfite, melamine, urea, ethylene urea, cysteine, cysteamine, lysine, glycine, serine, carnosine, histidine, glutathione, 3,4-diaminobenzoic acid, allantoin, glycouril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, thiabendazole, benzotriazol, triazole, indoline, sulfanilic acid, oxamide, sorbitol, glucose, cellulose, poly(vinyl alcohol), partially hydrolyzed poly(vinylformamide), poly(vinyl amine), poly(ethylene imine), poly(oxyalkyleneamine), poly(vinyl alcohol)-co-poly(vinyl amine), poly(4-aminostyrene), poly(1-lysine), chitosan, hexane diol, ethylenediamine-N,N′-bisacetoacetamide, N-(2-ethylhexyl)acetoacetamide, 2-benzoylacetoacetamide, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-dimethyl-1,3-dioxan-4,6-dione, 2-pentanone, dibutyl amine, triethylenetetramine, ammonium hydroxide, benzylamine, hydroxycitronellol, cyclohexanone, 2-butanone, pentane dione, dehydroacetic acid, or a mixture thereof. These formaldehyde scavengers may be obtained from Sigma/Aldrich/Fluka of St. Louis, Mo. U.S.A. or PolySciences, Inc. of Warrington, Pa., U.S.A.

Such formaldehyde scavengers are typically combined with a slurry containing said benefit agent containing delivery particle, at a level, based on total slurry weight, of from about 2 wt. % to about 18 wt. %, from about 3.5 wt. % to about 14 wt. % or even from about 5 wt. % to about 13 wt. %.

In one aspect, such formaldehyde scavengers may be combined with a product containing a benefit agent containing delivery particle, said scavengers being combined with said product at a level, based on total product weight, of from about 0.005% to about 0.8%, alternatively from about 0.03% to about 0.5%, alternatively from about 0.065% to about 0.25% of the product formulation.

Hard Surface Cleaners

The consumer products according to the present invention encompass cleaners for a variety of household hard surfaces. Such cleaners typically contain from about 0.2% to about 2%, more preferably from about from about 0.4% to about 0.8% of a perfume disclosed herein. Preferably said perfume is selected from the group consisting of Table 1 perfumes 1, 3, 4, and 5, preferably said perfume is selected from the group consisting of Table 1 perfumes 1 and 5, more preferably said perfume is Table 1 Perfume 5.

By “household hard surface”, it is meant herein any kind of surface typically found in and around houses like kitchens, bathrooms, e.g., floors, walls, tiles, windows, cupboards, sinks, showers, shower plastified curtains, wash basins, WCs, fixtures and fittings and the like made of different materials like ceramic, vinyl, no-wax vinyl, linoleum, melamine, glass, Inox®, Formica®, any plastics, plastified wood, metal or any painted or varnished or sealed surface and the like. Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments.

In a preferred embodiment herein, the liquid compositions herein are aqueous compositions. Therefore, they may comprise from 50% to 99.5% by weight of the total composition of water, preferably from 70% to 98% and more preferably from 80% to 95%.

The compositions according to the present invention are thickened liquid compositions as opposed to the compositions having water like viscosity, solids or gases.

The compositions of the present invention have a viscosity from 50 cps to 600 cps, more preferably of from 100 cps to 500 cps, more preferably from 150 cps to 350 cps, even more preferably from 150 cps to 300 cps and most preferably from 150 cps to 250 cps at 20° C. when measured with a AD1000 Advanced Rheometer from Atlas® shear rate 10 s⁻¹ with a coned spindle of 40 mm with a cone angle 2° and a truncation of ±60 μm.

The pH of the compositions herein is from 9.0 to 11.0, preferably from 9.5 to 10.8, more preferably from 10.0 to 10.7, even more preferably from 10.2 to 10.5 and most preferably pH is 10.3. Indeed, it has been surprisingly found that the greasy soil and particulate greasy soil cleaning performance is further improved at these preferred alkaline pH ranges. Accordingly, the compositions herein may further comprise an acid or base to adjust pH as appropriate.

A suitable acid for use herein is an organic and/or an inorganic acid. A preferred organic acid for use herein has a pka of less than 6. A suitable organic acid is selected from the group consisting of citric acid, lactic acid, glycolic acid, succinic acid, glutaric acid and adipic acid and mixtures thereof. A mixture of said acids may be commercially available from BASF under the trade name Sokalan® DCS. A suitable inorganic acid is selected from the group consisting hydrochloric acid, sulphuric acid, phosphoric acid and mixtures thereof.

A typical level of such an acid, when present, is of from 0.01% to 5.0% by weight of the total composition, preferably from 0.04% to 3.0% and more preferably from 0.05% to 1.5%.

A suitable base to be used herein is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate, K₂CO₃, Na₂CO₃ and alkanolamines (as e.g. monoethanolamine).

Typical levels of such bases, when present, are of from 0.01% to 5.0% by weight of the total composition, preferably from 0.05% to 3.0% and more preferably from 0.1% to 2.0%.

Surfactant System

The thickened liquid hard surface cleaning composition according to present invention comprises a specific surfactant system as described herein, preferably wherein said surfactant system has a low σ_{L/O} (interfacial tension of the surfactant system-containing composition to the greasy soil) preferably less than 4 mN/m measured at a 0.15% total surfactant concentration in deionised water at 25° C.; and a σ_{L/S} (interfacial tension of the surfactant system-containing composition to the hard surface) that is lower than the interfacial tension of the greasy soil to be removed to the hard surface to be cleaned (σ_{O/S}). Low inter facial tension in the thickened liquid hard surface cleaning composition allows composition to penetrate stuck on dirt and then lifts it from the hard surface to be suspended to the wash solution to provide an improved greasy soil and/or particulated greasy soil removal. Interfacial tension is measured according to the method described in patent application WO02/02724 pages 9-11.

By “interfacial tension” it is meant herein, the tension measured between the two phases of substantially non-mixable liquid compositions or between a liquid composition and a solid surface.

By “the interfacial tension of the surfactant system-containing composition to the greasy soil (σ_{L/O})” it is meant herein, the interfacial tension between the surfactant system-containing composition and the greasy soil, measured at a 0.15% total surfactant concentration in deionized water at 25° C. Interfacial tension is measured according to the method described in patent application WO02/02724, page 9 lines 14-31 and page 10 lines 1-12.

Preferably, said surfactant system has a σ_{L/O} (interfacial tension of the surfactant system-containing composition to the greasy soil) of less than 2 mN/m, more preferably less than 1 mN/m measured at a 0.15% total surfactant concentration in deionized water at 25° C.

By “the interfacial tension of the surfactant system-containing composition to the hard surface (σ_{L/S})” it is meant herein, the interfacial tension between the surfactant system and the hard surface to be cleaned. Preferably, the interfacial tension of the surfactant system-containing composition to the hard surface (σ_{L/S}) is also assessed at a 0.15% total surfactant concentration in deionized water at 25° C. Interfacial tension is measured according the method described in patent application WO02/02724, page 10 lines 14-30 and page 11 lines 1-2.

By “interfacial tension of the greasy soil to the hard surface (σ_{O/S})” it is meant herein, the interfacial tension between the greasy soil and the hard surface to be cleaned. The interfacial tension of the greasy soil to the hard surface strongly depends on the type of greasy soil to be found on the hard surface. Interfacial tension is measured according the method described in patent application WO02/02724, page 11, lines 4-9.

The three interfacial tensions described herein are dependent on the physical and/or chemical properties of the surfactant system used, the hard surface to be cleaned and the greasy soil on said surface. However, the physical and/or chemical properties of hard surfaces and the greasy soils depend on the type of hard surface to be cleaned and the type of greasy soil found on said hard surface. Therefore, it is essential for the present invention to choose a suitable surfactant system, providing the interfacial tensions σ_{L/O} and σ_{L/S} as described herein above. Indeed, to provide a cleaning composition having the specific σ_{L/O} (interfacial tension of the surfactant system-containing composition to the greasy soil) and the σ_{L/S} (interfacial tension of the surfactant system-containing composition to the hard surface) interfacial tensions any surfactant system known to those skilled in the art providing said specific σ_{L/O} and σ_{L/S} interfacial tensions may be used.

The surfactant system according to the present invention consists of a sulphated or sulphonated anionic surfactant, a neutralising co-surfactant and an alkoxylated nonionic surfactant.

The thickened liquid hard surface cleaning composition comprises from 1.8% to 20.0% by weight of the composition of said surfactant system, preferably from 4.0% to 18.0%, more preferably from 6.0% to 16.0% and most preferably from 8.0% to 15.0%.

The weight ratio of said anionic surfactant to said neutralizing co-surfactant is from 0.7 to 2.5, preferably from 0.9 to 2.2, more preferably 1.0 to 2.0 and most preferably from 1.1 to 1.8.

The weight ratio of said anionic surfactant to said nonionic surfactant is from 0.15 to 1.0, preferably from 0.2 to 0.75, more preferably from 0.2 to 0.5 and most preferably from 0.2 to 0.45.

The weight ratio of said neutralizing co-surfactant to said nonionic surfactant is from 0.05 to 1.0, preferably from 0.10 to 0.70, more preferably 0.15 to 0.6 and most preferably from 0.15 to 0.50.

All ratios are calculated as a weight/weight level.

Sulphated or Sulphonated Anionic Surfactant

The surfactant system according to the present invention comprises a sulphated or sulphonated anionic surfactant or a mixture thereof.

Suitable sulphated anionic surfactants for use herein are all those commonly known by those skilled in the art. Preferably, the sulphated anionic surfactants for use herein are selected from the group consisting of: alkyl sulphates; and alkylalkoxylated sulphates; and mixtures thereof.

Suitable alkyl sulphates for use herein include water-soluble salts or acids of the formula ROSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphates include C₁₂₋₁₄ alkyl sulphate like EMPICOL® 0298/, EMPICOL® 0298/F or EMPICOL® XLB commercially available from ALBRIGHT & WILSON.

By “linear alkyl sulphate” it is meant herein a non-substituted alkyl sulphate wherein the linear alkyl chain comprises from 6 to 16 carbon atoms, preferably from 8 to 14 carbon atoms, and more preferably from 10 to 14 carbon atoms, and wherein this alkyl chain is sulphated at one terminus.

Suitable sulphonated anionic surfactants for use herein are all those commonly known by those skilled in the art. Preferably, the sulphonated anionic surfactants for use herein are selected from the group consisting of: alkyl sulphonates; alkyl aryl sulphonates; naphthalene sulphonates; alkyl alkoxylated sulphonates; and C₆-C₁₆ alkyl alkoxylated linear or branched diphenyl oxide disulphonates; and mixtures thereof.

Suitable alkyl sulphonates for use herein include water-soluble salts or acids of the formula RSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₁₈ linear or branched saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphonates include C₁₂-C₁₆ paraffin sulphonate like Hostapur® SAS commercially available from Hoechst. Particularly preferred alkyl aryl sulphonates are alkyl benzene sulphonates commercially available under trade name Nansa® available from Albright&Wilson.

By “linear alkyl sulphonate” it is meant herein a non-substituted alkyl sulphonate wherein the alkyl chain comprises from 6 to 18 carbon atoms, preferably from 8 to 16 carbon atoms, and more preferably from 10 to 16 carbon atoms, and wherein this alkyl chain is sulphonated at one terminus.

Suitable alkoxylated sulphonate surfactants for use herein are according to the formula R(A)ₘSO₃M, wherein R is an unsubstituted C₆-C₁₈ alkyl, hydroxyalkyl or alkyl aryl group, having a linear or branched C₆-C₁₈ alkyl component, preferably a C₈-C₁₆ alkyl or hydroxyalkyl, more preferably C₁₂-C₁₆ alkyl or hydroxyalkyl, and A is an ethoxy or propoxy or butoxy unit, and m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like.

Exemplary surfactants are C₁₂-C₁₈ alkyl polyethoxylate (1.0) sulphonate (C₁₂-C₁₈E(1.0)SM), C₁₂-C₁₈ alkyl polyethoxylate (2.25) sulphonate (C₁₂-C₁₈E(2.25)SM), C₁₂-C₁₈ alkyl polyethoxylate (3.0) sulphonate (C₁₂-C₁₈E(3.0)SM), and C₁₂-C₁₈ alkyl polyethoxylate (4.0) sulphonate (C₁₂-C₁₈E(4.0)SM), wherein M is conveniently selected from sodium and potassium. Particularly suitable alkoxylated sulphonates include alkyl aryl polyether sulphonates like Triton X-200® commercially available from Dow Chemical.

Preferably said sulphated or sulphonated anionic surfactant for use herein is selected from the group consisting of alkyl sulphates (AS) preferably C₁₂, C₁₃, C₁₄ and C₁₅ AS, sodium linear alkyl sulphonate (NaLAS), sodium paraffin sulphonate NaPC₁₂₋₁₆S, and mixtures thereof. Most preferably sulphated or sulphonated anionic surfactant for use herein is selected from the group consisting of alkyl sulphates (AS) preferably, C₁₂, C₁₃, C₁₄ and C₁₅ AS, sodium linear alkyl sulphonate (NaLAS), sodium paraffin sulphonate NaPC₁₂₋₁₆S and mixtures thereof.

Typically, the liquid composition herein may comprise from 0.5% to 9.5% by weight of the total composition of said sulphated or sulphonated anionic surfactant, preferably from 1.0% to 5.0%, more preferably from 1.5% to 3.5% and most preferably from 2.0% to 3.0%.

Neutralising Co-Surfactant

The surfactant system according to the present invention preferably comprises a neutralising co-surfactant. Preferably, said neutralising co-surfactant at least partially neutralises the negative charges of said sulphated or sulphonated anionic surfactant.

Preferably, said neutralising co-surfactant is uncharged or comprises positive and negative charges within the same molecule. More preferably, said neutralising co-surfactant is an (overall) uncharged polar surfactant (with a strong dipole moment) or comprises positive and negative charges within the same molecule. Even more preferably, said neutralising co-surfactant is an uncharged polar surfactant or comprises the same amount of positive and negative charges within the same molecule. Most preferably, said neutralising co-surfactant is not a cationic surfactant.

Any neutralising co-surfactant having the desired property of at least partially neutralising the negative charges of said sulphated or sulphonated anionic surfactant may be used.

Preferred neutralising co-surfactants are selected from the group consisting of: amine oxide surfactants and betaine surfactants and mixtures thereof.

Suitable betaine and sulfobetaine surfactants are according to the formulae:

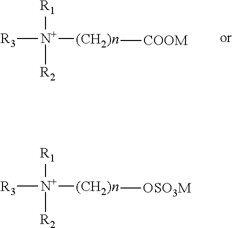

wherein: R₁ and R₂ are each independently linear or branched, saturated or unsaturated hydrocarbon chains of from 1 to 30 carbon atoms, preferably 1 to 20, more preferably 1 to 7 carbon atoms; R₃ is a linear or branched hydrocarbon chain of from 10 to 20 carbon atoms, preferably of from 10 to 18, more preferably 12 to 16 carbon atoms; n is an integer of from 1 to 20, preferably 1 to 10, more preferably 1 to 5; and M is H or an alkali metal, or mixtures thereof.

Suitable betaine surfactant include coconut-dimethyl betaine commercially available under tradename Mackam35® from McIntyre.

Suitable amine oxide surfactants are according to the formula: R₁R₂R₃NO wherein each of R₁, R₂ and R₃ is independently a saturated or unsaturated, substituted or unsubstituted, linear or branched hydrocarbon chain of from 10 to 30 carbon atoms. Preferred amine oxide surfactants to be used according to the present invention are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain.

Suitable amine oxides for use herein are for instance preferably C₁₂-C₁₄ dimethyl amine oxide, commercially available from Albright & Wilson, C₁₂-C₁₄ amine oxides commercially available under the trade name Genaminox® LA from Clamant or AROMOX® DMC from AKZO Nobel.

Preferably, said neutralising co-surfactant is selected from the group consisting of: amine oxide surfactants betaine surfactants and mixtures thereof. More preferably, said neutralising co-surfactant is an amine oxide surfactant.

Typically, the liquid composition herein may comprise from 0.3% to 5.0% by weight of the total composition of said neutralising co-surfactant, preferably from 0.5% to 3.0%, more preferably from 0.7% to 2.5% and most preferably from 1.0% to 2.0%.

Alkoxylated Nonionic Surfactant

The surfactant system according to the present invention further comprises an alkoxylated nonionic surfactant. Suitable alkoxylated nonionic surfactants herein to be mentioned are primaly C₆-C₁₆ alcohol polyglycol ether i.e. ethoxylated alcohols having 6 to 16 carbon atoms in the alkyl moiety and 4 to 30 ethylene oxide (EO) units. When referred to for example C₉₋₁₄ it is meant average carbons and alternative reference to for example EO8 is meant average ethylene oxide units.

Suitable alkoxylated nonionic surfactants are according to the formula RO-(A)ₙH, wherein: R is a C₆ to C₁₈, preferably a C₈ to C₁₆, more preferably a C₉ to C₁₁ alkyl chain, or a C₆ to C₂₈ alkyl benzene chain; A is an ethoxy or propoxy or butoxy unit or a mixture thereof; and wherein n is from 1 to 30, preferably from 1 to 15 and, more preferably from 4 to 12 even more preferably from 5 to 10. Preferred R chains for use herein are the C₈ to C₂₂ alkyl chains. Even more preferred R chains for use herein are the C₉ to C₁₂ alkyl chains. Non-capped ethoxy/butoxylated, ethoxy/propoxylated, butoxy/propoxylated and ethoxy/butoxy/propoxylated nonionic surfactants may also be used herein. Preferred non-capped alkoxylated nonionic surfactants are non-capped ethoxylated nonionic surfactants.

Suitable non-capped ethoxylated nonionic surfactants for use herein are Dobanol® 91-2.5 (HLB=8.1; R is a mixture of C₉ and C₁₁ alkyl chains, n is 2.5), Dobanol® 91-10 (HLB=14.2; R is a mixture of C₉ to C₁₁ alkyl chains, n is 10), Dobanol® 91-12 (HLB=14.5; R is a mixture of C₉ to C₁₁ alkyl chains, n is 12), Lialethl® 11-5 (R is a C₁₁ alkyl chain, n is 5), Isalchem® 11-5 (R is a mixture of linear and branched C11 alkyl chain, n is 5), Lialethl® 11-21 (R is a mixture of linear and branched C₁₁ alkyl chain, n is 21), Isalchem® 11-21 (R is a C₁₁ branched alkyl chain, n is 21), Empilan® KBE21 (R is a mixture of C₁₂ and C₁₄ alkyl chains, n is 21) or mixtures thereof. Preferred herein are Dobanol® 91-5, Neodol® 11-5, Lialethl® 11-21 Lialethl® 11-5 Isalchem® 11-5 Isalchem® 11-21 Dobanol® 91-8, or Dobanol® 91-10, or Dobanol® 91-12, or mixtures thereof. These Dobanol®/Neodol® surfactants are commercially available from SHELL. These Lutensol® surfactants are commercially available from BASF and these Tergitol® surfactants are commercially available from Dow Chemicals.

Suitable chemical processes for preparing the alkoxylated nonionic surfactants for use herein include condensation of corresponding alcohols with alkylene oxide, in the desired proportions. Such processes are well known to the person skilled in the art and have been extensively described in the art.

Preferably, said alkoxylated nonionic surfactant is selected from the group consisting of alkoxylated nonionic surfactants and mixtures thereof. More preferably, said alkoxylated nonionic surfactant is a C₉₋₁₁ EO5 alkylethoxylate, C₁₂₋₁₄ EO5 alkylethoxylate, a C₁₁ EO5 alkylethoxylate, C₁₂₋₁₄ EO21 alkylethoxylate, or a C₉₋₁₁ EO8 alkylethoxylate or a mixture thereof. Most preferably, said alkoxylated nonionic surfactant is a C₁₁ EO5 alkylethoxylate or a C₉₋₁₁ EO8 alkylethoxylate or a mixture thereof.

Typically, the thickened liquid composition herein may comprise from 1.0% to 10.0% by weight of the total composition of said alkoxylated non-ionic surfactant, preferably from 3.0% to 9.5%, more preferably from 4.0% to 9.0% and most preferably from 5.0% to 8.0%.

Optional Thickener

The thickened liquid hard surface cleaning composition according to the present invention further comprises thickener. Thickener provides a thicker cleaning composition which gives longer contact time and therefore surfactant system penetrates better on greasy soil and/or particulated greasy soil to improve cleaning effectiveness. Use of a thickener provides a needed product stability.

Suitable thickeners are herein include polyacrylate based polymers, preferably hydrophobically modified polyacrylate polymers; hydroxyl ethyl cellulose, preferably hydrophobically modified hydroxyl ethyl cellulose, xanthan gum, hydrogenated castor oil (HCO) and mixtures thereof.

Preferred thickeners are polyacrylate based polymers, preferably hydrophobically modified polyacrylate polymers. Preferably a water soluble copolymer based on main monomers acrylic acid, acrylic acid esters, vinyl acetate, methacrylic acid, acrylonitrile and mixtures thereof, more preferably copolymer is based on methacrylic acid and acrylic acid esters having appearance of milky, low viscous dispersion. Most preferred hydrologically modified polyacrylate polymer is Rheovis® AT 120, which is commercially available from BASF.

Other suitable thickeners are hydroxethylcelluloses (HM-HEC) preferably hydrophobically modified hydroxyethylcellulose.

Suitable hydroxethylcelluloses (HM-HEC) are commercially available from Aqualon/Hercules under the product name Polysurf 76® and W301 from 3V Sigma.

Xanthan gum is one suitable thickener used herein. Xanthan gum is a polysaccharide commonly used rheoligy modifier and stabilizer. Xanthan gum is produced by fermentation of glucose or sucrose by the xanthomonas campestris bacterium.

Suitable Xanthan gum is commercially available under trade name Kelzan T® from CP Kelco.

Hydrogenated castor oil is one suitable thickener used herein. Suitable hydrogenated castor oil is available under trade name TIXCIN R from Elementis.

The most preferred thickener used herein is hydrologically modified polyacrylate polymer Rheovis® AT 120, which is commercially available from BASF.

Typically, the thickened liquid composition herein comprises from 0.1% to 10.0% by weight of the total composition of said thickener, preferably from 0.2% to 5.0%, more preferably from 0.2% to 2.5% and most preferably from 0.2% to 2.0%.

Chelating Agents

The thickened liquid hard surface cleaning composition according to the present invention further comprises chelating agent or mixtures thereof. Suitable chelating agents, in combination with the surfactant system, improve the shine benefit.

Chelating agent can be incorporated in the compositions herein in amounts ranging from 0.05% to 5.0% by weight of the total composition, preferably from 0.1% to 3.0%, more preferably from 0.2% to 2.0% and most preferably from 0.2% to 0.4%.

Suitable phosphonate chelating agents for use herein may include ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agent to be used herein is diethylene triamine penta methylene phosphonate (DTPMP). Such phosphonate chelating agents are commercially available from Monsanto under the trade name DEQUEST®.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Most preferred biodegradable chelating agent is L-glutamic acid N,N-diacetic acid (GLDA) commercially available under tradename Dissolvine 47S from Akzo Nobel.

Suitable amino carboxylates for use herein include ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanoldiglycines, and methyl glycine diacetic acid (MGDA), both in their acid form, or in their alkali metal, ammonium, and substituted ammonium salt forms. Particularly suitable amino carboxylate to be used herein is propylene diamine tetracetic acid (PDTA) which is, for instance, commercially available from BASF under the trade name Trilon FS® and methyl glycine di-acetic acid (MGDA). Most preferred aminocarboxylate used herein is diethylene triamine pentaacetate (DTPA) from BASF.

Further carboxylate chelating agents for use herein include salicylic acid, aspartic acid, glutamic acid, glycine, malonic acid or mixtures thereof.

Polymers

The thickened composition according to the present invention may further comprise a polymer as highly preferred optional ingredient. It has been found that the presence of a specific polymer as described herein, when present, allows further improving the grease removal performance of the thickened liquid composition due to the specific sudsing/foaming characteristics they provide to said composition.

The polymer can be selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/polyacrylic acid copolymer (PVP-AA); a polyvinylpyrrolidone/vinylacetate copolymer (PVP-VA); a polyacrylic polymer or polyacrylicmaleic copolymer; and a polyacrylic or polyacrylic maleic phosphono end group copolymer; and mixtures thereof.

Typically, the liquid composition herein may comprise from 0.005% to 5.0% by weight of the total composition of said polymer, preferably from 0.10% to 4.0%, more preferably from 0.1% to 3.0% and most preferably from 0.20% to 1.0%.

Fatty Acid

The thickened liquid compositions of the present invention may comprise fatty acid, or mixtures thereof as a highly preferred optional ingredient. Fatty acids are desired herein as they reduce the sudsing of the thickened liquid composition according to the present invention when the composition is rinsed of the surface to which it has been applied before.

Suitable fatty acids for use herein are the alkali salts of a C₈-C₂₄ fatty acid. Such alkali salts include the metal fully saturated salts like sodium, potassium and/or lithium salts as well as the ammonium and/or alkylammonium salts of fatty acids, preferably the sodium salt. Preferred fatty acids for use herein contain from 8 to 22, preferably from 8 to 20 and more preferably from 8 to 18 carbon atoms.

Suitable fatty acids may be selected from caprylic acid, capric acid, lauric acid, myristic acid, palmitic acid, stearic acid, oleic acid, and mixtures of fatty acids suitably hardened, derived from natural sources such as plant or animal esters (e.g., palm oil, olive oil, coconut oil, soybean oil, castor oil, tallow, ground oil, whale and fish oils and/or babassu oil.

For example coconut fatty acid is commercially available from UNICHEMA under the name PRIFAC 5900®.

Typically, the liquid composition herein may comprise up to 6.0% by weight of the total composition of said fatty acid, preferably from 0.1% to 3.0%, more preferably from 0.1% to 2.0% and most preferably from 0.15% to 1.5% by weight of the total composition of said fatty acid.

Branched Fatty Alcohol

The thickened liquid compositions of the present invention may comprise a branched fatty alcohol, or mixtures thereof as a highly preferred optional ingredient.

Suitable branched fatty alcohols to be used in the present invention are the 2-alkyl alkanols having an alkyl chain comprising from 6 to 16, preferably from 7 to 13, more preferably from 8 to 12, most preferably from 8 to 10 carbon atoms and a terminal hydroxy group, said alkyl chain being substituted in the a position (i.e., position number 2) by an alkyl chain comprising from 1 to 10, preferably from 2 to 8 and more preferably 4 to 6 carbon atoms.

Such suitable compounds are commercially available, for instance, as the Isofol® series such as Isofol® 12 (2-butyl octanol) or Isofol® 16 (2-hexyl decanol) commercially available from Condea.

Typically, the liquid composition herein may comprise up to 2.0% by weight of the total composition of said branched fatty alcohol, preferably from 0.10% to 1.0%, more preferably from 0.1% to 0.8% and most preferably from 0.1% to 0.5%.

Solvent

The thickened liquid compositions of the present invention may comprise a solvent or mixtures thereof as a preferred optional ingredient.

Suitable solvent is selected from the group consisting of: ethers and diethers having from 4 to 14 carbon atoms; glycols or alkoxylated glycols; alkoxylated aromatic alcohols; aromatic alcohols; alkoxylated aliphatic alcohols; aliphatic alcohols; C₈-C₁₄ alkyl and cycloalkyl hydrocarbons and halohydrocarbons; C₆-C₁₆ glycol ethers; terpenes; and mixtures thereof.

Other Optional Ingredients:

The thickened liquid compositions according to the present invention may comprise a variety of other optional ingredients depending on the technical benefit aimed for and the surface treated.

Suitable optional ingredients for use herein include builders, polymers, buffers, bactericides, hydrotropes, colorants, stabilisers, radical scavengers, abrasives, soil suspenders, dye transfer agents, brighteners, anti dusting agents, dispersants, dye transfer inhibitors, pigments, silicones and/or dyes.

Packaging Form of the Compositions

The thickened liquid compositions herein may be packaged in a variety of suitable detergent packaging known to those skilled in the art. Preferably, the liquid compositions are packaged in conventional detergent plastic bottles.

In another preferred embodiment the thickened compositions herein may be packed in a bottle comprising a specific metered dosing cap to deliver accurate dose of product. Preferably the thickened compositions herein are packed in bottles comprising a dispensing devise as described in co-pending patent application EP 10188349.4.

In one embodiment the compositions herein may be packaged in manually or electrically operated spray dispensing containers, which are usually made of synthetic organic polymeric plastic materials. Accordingly, the present invention also encompasses thickened liquid hard surface cleaning compositions of the invention packaged in a spray dispenser, preferably in a trigger spray dispenser or pump spray dispenser.

In yet another embodiment, a thickened liquid hard surface cleaning composition according to the present invention is loaded on a cleaning substrate, whereas the substrate is a paper or nonwoven towel or wipe or a sponge.

The Process of Cleaning a Surface

The present invention encompasses a process of cleaning a surface with a thickened liquid composition according to the present invention. Suitable surfaces herein are described herein above under the heading “The thickened liquid hard surface cleaning composition”.

In a preferred embodiment said surface is contacted with the composition according to the present invention, preferably wherein said composition is applied onto said surface.

In another preferred embodiment, the process herein comprises the steps of dispensing (e.g., by spraying, pouring, squeezing) the thickened liquid composition according to the present invention from a container containing said liquid composition and thereafter cleaning said surface.

A preferred embodiment of the present invention provides that the thickened liquid composition is applied onto the surface to be treated. The composition may be in its neat form or in its diluted form.

By “diluted form”, it is meant herein that said thickened liquid composition is diluted by the user typically with water. The composition is diluted prior to use to a typical dilution level of 10 to 400 times its weight of water, preferably from 10 to 200 and more preferably from 10 to 100. A usually recommended dilution level is from 1.2% to 1.5% dilution of the composition in water, for concentrated compositions recommended dilution level is from 0.4% to 0.6% dilution of the composition in water.

By “in its neat form”, it is to be understood that said thickened liquid composition is applied directly onto the surface to be treated without undergoing any dilution, i.e., the liquid composition herein is applied onto the hard surface as described herein.

In a preferred embodiment of the present invention said hard surface is inclined or vertical. Inclined or vertical hard surfaces include mirrors, lavatory pans, urinals, drains, waste pipes and the like.

In another embodiment of the present invention said liquid composition is poured onto said hard surface. More preferably, said liquid composition is poured in its neat form onto said hard surface.

In another preferred embodiment of the present invention said process of cleaning a hard surface includes the steps of applying, preferably spraying, said liquid composition onto said hard surface, leaving said liquid composition to act onto said surface for a period of time to allow said composition to act, preferably without applying mechanical action, and optionally removing said liquid composition, preferably removing said liquid composition by rinsing said hard surface with water and/or wiping said hard surface with an appropriate instrument, e.g., a sponge, a paper or cloth towel and the like.

The hard surfaces to be treated may be soiled with a variety of soils, e.g., greasy soils (e.g., greasy soap scum, body grease, kitchen grease or burnt/sticky food residues typically found in a kitchen and the like), particulate greasy soils.

Automatic Dishwashing Compositions

The automatic dishwashing compositions disclosed herein typically contain from about 0.05% to about 0.70%, preferably from about 0.07% to about 0.60%, more preferably from about 0.10% to about 0.30% of a perfume disclosed herein. Preferably said perfume is selected from the group consisting of Table 1 perfumes 1, 3, 4, and 5, preferably said perfume is selected from the group consisting of Table 1 perfumes 1 and 5, more preferably said perfume is Table 1 Perfume 5.

Unit Dose Form

The composition of the invention is presented in unit-dose form. Products in unit dose form include tablets, capsules, sachets, pouches, injection moulded containers, etc. Preferably, the composition is in a pack made of water-soluble material. Preferred packs are pouches, where the detergent composition is enveloped by a water-soluble film and injection moulded containers wherein the detergent composition is placed in a container of water-soluble material made by injection moulding. Both the detergent composition and the enveloping material are water-soluble. They readily dissolve when exposed to water in an automatic dishwashing process, preferably during the main wash. The pack can have a single compartment or a plurality of compartments. The compartments can comprise a composition in liquid or solid form.

Preferably, the unit dose detergent can by in the form of a multi-compartment pack. By “multi-compartment pack” is herein meant a pack having at least two compartments, preferably at least three compartments, each compartment contains a composition surrounded by enveloping material, preferably polyvinyl alcohol. The compartments can be in any geometrical disposition. The different compartments can be adjacent to one another, preferably in contact with one another. Especially preferred configurations for use herein include superposed compartments (i.e. one above the other), side-by-side compartments, etc. Especially preferred from a view point of automatic dishwasher dispenser fit, stability and enveloping material reduction are multi-compartment pouches or containers having some superposed compartments and/or some side-by-side compartments.

Enveloping Material

The enveloping material is water soluble. By “water-soluble” is herein meant that the material has a water-solubility of at least 50%, preferably at least 75% or even at least 95%, as measured by the method set out herein after using a glass-filter with a maximum pore size of 20 microns. 50 grams+−0.1 gram of enveloping material is added in a pre-weighed 400 ml beaker and 245 ml +−1 ml of distilled water is added. This is stirred vigorously on a magnetic stirrer set at 600 rpm, for 30 minutes at 20° C. Then, the mixture is filtered through a folded qualitative sintered-glass filter with a pore size as defined above (max, 20 micron). The water is dried off from the collected filtrate by any conventional method, and the weight of the remaining material is determined (which is the dissolved or dispersed faction). Then, the % solubility can be calculated.

The enveloping material is any water-soluble material capable of enclosing the cleaning composition of the product of the invention. The enveloping material can be a polymer that has been injection moulded to provide a casing or it can be a film. Preferably the enveloping material is made of polyvinyl alcohol. Preferably the enveloping material is a water-soluble polyvinyl alcohol film.

The pouch can, for example, be obtained by injection moulding or by creating compartments using a film. The enveloping material is usually moisture permeable. The pouch of the invention is stable even when the enveloping material is moisture permeable. The liquid composition confers stability to the pouch, in terms of both interaction among the different compositions and interaction with the surrounding environment.

Preferred substances for making the enveloping material include polymers, copolymers or derivatives thereof selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Especially preferred for use herein is polyvinyl alcohol and even more preferred polyvinyl alcohol films.

Most preferred enveloping materials are PVA films known under the trade reference Monosol M8630, as sold by Kuraray, and PVA films of corresponding solubility and deformability characteristics. Other films suitable for use herein include films known under the trade reference PT film or the K-series of films supplied by Aicello, or VF-HP film supplied by Kuraray.

The enveloping material herein may comprise other additive ingredients than the polymer or polymer material and water. For example, it may be beneficial to add plasticisers, for example glycerol, ethylene glycol, diethyleneglycol, propylene glycol, dipropylene glycol, sorbitol and mixtures thereof. Preferably the enveloping material comprises glycerol as plasticisers. Other useful additives include disintegrating aids.

Automatic Dishwashing Detergent Composition

The detergent composition of the invention is presented in unit-dose form and it can be in any physical form including solid, liquid and gel form. The composition of the invention is very well suited to be presented in the form of a multi-compartment pack, more in particular a multi-compartment pack comprising compartments with compositions in different physical forms, for example a compartment comprising a composition in solid form and another compartment comprising a composition in liquid form. The composition is preferably enveloped by a water-soluble film such as polyvinyl alcohol. The composition comprises an organic complexing agent, preferably the tri-sodium salt of MGDA, a dispersant polymer, preferably a sulfonated polymer comprising 2-acrylamido-2-methylpropane sulfonic acid monomers, a bleach, preferably sodium percarbonate, and preferably an inorganic builder, more preferably carbonate, a bleach activator, a bleach catalyst, protease and amylase enzymes, non-ionic surfactant, a crystal growth inhibitor, more preferably HEDP. The composition is preferably free of citrate.

The composition of the invention preferably has a pH as measured in 1% weight/volume aqueous solution in distilled water at 20° C. of from about 9 to about 12, more preferably from about 10 to less than about 11.5 and especially from about 10.5 to about 11.5.

The composition of the invention preferably has a reserve alkalinity of from about 10 to about 20, more preferably from about 12 to about 18 at a pH of 9.5 as measured in NaOH with 100 mL of product at 20° C.

Complexing Agent

A complexing agent is a material capable of sequestering hardness ions, particularly calcium and/or magnesium. The composition of the invention comprises a high level of complexing agent, however the level should not be too high due to the negative interaction with enzymes. Too high level can also have glass care issues associated to it.

The composition of the invention comprises greater than about 5 to about 10 grams, preferably greater than about 5.5 to about 8 grams, more preferably greater than about 5.5 to about 8 grams of a complexing agent. The complexing agent is preferably selected from the group consisting of methyl-glycine-diacetic acid, its salts and derivatives thereof, glutamic-N,N-diacetic acid, its salts and derivatives thereof, iminodisuccinic acid, its salts and derivatives thereof, carboxy methyl inulin, its salts and derivatives thereof and mixtures thereof. Especially preferred complexing agent for use herein is a salt of MGDA, in particular the three sodium salt of MGDA.

Dispersant Polymer

The composition of the invention comprises a low level of dispersant polymer, preferably from about 0.1 to about 1, more preferably from about 0.2 to about 0.9 and particularly from 0.3 to 0.6 grams, preferably the dispersant polymer is a sulfonated polymer, more preferably a sulfonated polymer comprising 2-acrylamido-2-methylpropane sulfonic acid monomers and carboxyl monomers.

Polycarboxylate Polymer

For example, a wide variety of modified or unmodified polyacrylates, polyacrylate/maleates, or polyacrylate/methacrylates are highly useful. It is believed these polymers are excellent dispersing agents and enhance overall detergent performance, particularly when used in the composition of the invention.

Suitable polycarboxylate-based polymers include polycarboxylate polymers that may have average molecular weights of from about 500 Da to about 500,000 Da, or from about 1,000 Da to about 100,000 Da, or even from about 3,000 Da to about 80,000 Da. Suitable polycarboxylates may be selected from the group comprising polymers comprising acrylic acid such as Sokalan PA30, PA20, PA15, PA10 and sokalan CP10 (BASF GmbH, Ludwigshafen, Germany), Acusol™ 45N, 480N, 460N and 820 (sold by Rohm and Haas, Philadelphia, Pa., USA) polyacrylic acids, such as Acusol™ 445 and Acusol™ 420 (sold by Rohm and Haas, Philadelphia, Pa., USA) acrylic/maleic co-polymers, such as Acusol™ 425N and acrylic/methacrylic copolymers.

Alkoxylated polycarboxylates such as those prepared from polyacrylates are useful herein to and can provide additional grease suspension. Chemically, these materials comprise polyacrylates having one ethoxy side-chain per every 7-8 acrylate units. The side-chains are ester-linked to the polyacrylate “backbone” to provide a “comb” polymer type structure. The molecular weight can vary, but may be in the range of about 2000 to about 50,000.

Unsaturated monomeric acids that can be polymerized to form suitable dispersing polymers include acrylic acid, maleic acid (or maleic anhydride), fumaric acid, itaconic acid, aconitic acid, mesaconic acid, citraconic acid and methylenemalonic acid. The presence of monomeric segments containing no carboxylate radicals such as methyl vinyl ether, styrene, ethylene, etc. is suitable provided that such segments do not constitute more than about 50% by weight of the dispersant polymer.

Co-polymers of acrylamide and acrylate having a molecular weight of from about 3,000 to about 100,000, preferably from about 4,000 to about 20,000, and an acrylamide content of less than about 50%, preferably less than about 20%, by weight of the dispersant polymer can also be used. Most preferably, such dispersant polymer has a molecular weight of from about 4,000 to about 20,000 and an acrylamide content of from about 0% to about 15%, by weight of the polymer.

Sulfonated Polymers

Suitable sulfonated polymers described herein may have a weight average molecular weight of less than or equal to about 100,000 Da, preferably less than or equal to about 75,000 Da, more preferably less than or equal to about 50,000 Da, more preferably from about 3,000 Da to about 50,000, and specially from about 5,000 Da to about 45,000 Da.

The sulfonated polymers preferably comprises carboxylic acid monomers and sulfonated monomers. Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium (meth) allyl sulfonate, vinyl sulfonate, sodium phenyl (meth) allyl ether sulfonate, or 2-acrylamido-methyl propane sulfonic acid. Preferred non-ionic monomers include one or more of the following: methyl (meth) acrylate, ethyl (meth) acrylate, t-butyl (meth) acrylate, methyl (meth) acrylamide, ethyl (meth) acrylamide, t-butyl (meth) acrylamide, styrene, or a-methyl styrene.

Specially preferred sulfonated polymers for use herein are those comprising monomers of acrylic acid and monomers of 2-acrylamido-methyl propane sulfonic acid.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas, Versaflex Si™ (sold by Alco Chemical, Tennessee, USA) and those described in U.S. Pat. No. 5,308,532 and in WO 2005/090541. Suitable styrene co-polymers may be selected from the group comprising, styrene co-polymers with acrylic acid and optionally sulphonate groups, having average molecular weights in the range 1,000-50,000, or even 2,000-10,000 such as those supplied by Alco Chemical Tennessee, USA, under the tradenames Alcosperse® 729 and 747.

Other dispersant polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate is the most preferred polymer of this group.

Other suitable dispersant polymers are the carboxylated polysaccharides, particularly starches, celluloses and alginates. Preferred cellulose-derived dispersant polymers are the carboxymethyl celluloses.

Yet another group of acceptable dispersing agents are the organic dispersing polymers, such as polyaspartates.

Amphilic graft co-polymer are useful for use herein. Suitable amphilic graft co-polymer comprises (i) polyethylene glycol backbone; and (ii) and at least one pendant moiety selected from polyvinyl acetate, polyvinyl alcohol and mixtures thereof. In other examples, the amphilic graft copolymer is Sokalan HP22, supplied from BASF.

Bleach

The composition of the invention preferably comprises from 1 to 4, preferably from 1.2 to 3 and especially from 1.5 to 2.5 grams of bleach.

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially diperoxydodecanedioc acid, diperoxytetradecanedioc acid, and diperoxyhexadecanedioc acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, c-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Preferably, the level of bleach in the composition of the invention is from about 0 to about 10%, more preferably from about 0.1 to about 5%, even more preferably from about 0.5 to about 3% by weight of the composition.

Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups.

Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). If present the composition of the invention comprises from 0.1 to 2, preferably from 0.2 to 1 grams of bleach activator, preferably TAED.

Bleach Catalyst

The composition herein preferably contains a bleach catalyst, preferably a metal containing bleach catalyst. More preferably the metal containing bleach catalyst is a transition metal containing bleach catalyst, especially a manganese or cobalt-containing bleach catalyst.

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16.

Manganese bleach catalysts are preferred for use in the composition of the invention. Especially preferred catalyst for use here is a dinuclear manganese-complex having the general formula:

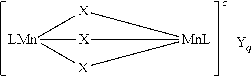

wherein Mn is manganese which can individually be in the III or IV oxidation state; each x represents a coordinating or bridging species selected from the group consisting of H2O, O22-, O2-, OH—, HO2-, SH—, S2-, >SO, Cl—, N3-, SCN—, RCOO—, NH2- and NR3, with R being H, alkyl or aryl, (optionally substituted); L is a ligand which is an organic molecule containing a number of nitrogen atoms which coordinates via all or some of its nitrogen atoms to the manganese centres; z denotes the charge of the complex and is an integer which can be positive or negative; Y is a monovalent or multivalent counter-ion, leading to charge neutrality, which is dependent upon the charge z of the complex; and q=z/[charge Y]

Preferred manganese-complexes are those wherein x is either CH₃COO⁻ or O² or mixtures thereof, most preferably wherein the manganese is in the IV oxidation state and x is O²⁻. Preferred ligands are those which coordinate via three nitrogen atoms to one of the manganese centres, preferably being of a macrocyclic nature. Particularly preferred ligands are:
(1) 1,4,7-trimethyl-1,4,7-triazacyclononane, (Me-TACN); and
(2) 1,2,4,7-tetramethyl-1,4,7-triazacyclononane, (Me-Me TACN).

The type of counter-ion Y for charge neutrality is not critical for the activity of the complex and can be selected from, for example, any of the following counter-ions: chloride; sulphate; nitrate; methylsulphate; surfactant anions, such as the long-chain alkylsulphates, alkylsulphonates, alkylbenzenesulphonates, tosylate, trifluoromethylsulphonate, perchlorate (ClO₄⁻), BPh₄⁻, and PF₆⁻′ though some counter-ions are more preferred than others for reasons of product property and safety.

Consequently, the preferred manganese complexes useable in the present invention are:
(I) [(Me-TACN)Mn^{IV}(Âμ-0)₃Mn^{IV}(Me-TACN)]²⁺(PF₆⁻)₂
(II) [(Me-MeTACN)Mn^{IV}(Âμ-0)₃Mn^{IV}(Me-MeTACN)]²⁺(PF₆⁻)₂
(III) [(Me-TACN)Mn^{III}(Âμ-0)(Âμ-OAc)₂Mn^{III}(Me-TACN)]²⁺(PF₆⁻)₂
(IV) [(Me-MeTACN)Mn^{III}(Âμ-0)(Âμ-OAc)₂Mn^{III}(Me-MeTACN)]²⁺(PF₆⁻)₂

which hereinafter may also be abbreviated as:
(I) [Mn^{IV}₂(Âμ-0)₃(Me-TACN)₂](PF₆)₂
(II) [Mn^{IV}₂(Âμ-0)₃(Me-MeTACN)₂](PF₆)₂
(III) [Mn^{III}₂(Âμ-0)(Âμ-OAc)₂(Me-TACN)₂](PF₆)₂
(IV) [Mn^{III}₂(Âμ-0)(Âμ-OAc)₂(Me-TACN)₂](PF₆)₂

The structure of I is given below:

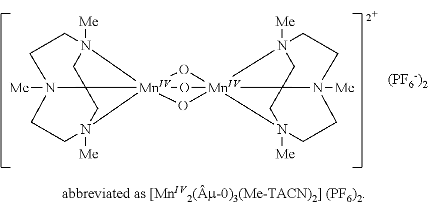

The structure of II is given below:

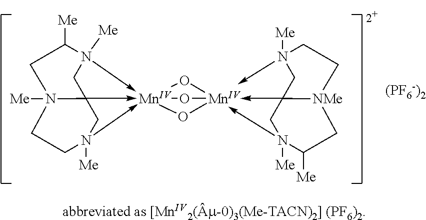

It is of note that the manganese complexes are also disclosed in EP-A-0458397 and EP-A-0458398 as unusually effective bleach and oxidation catalysts. In the further description of this invention they will also be simply referred to as the “catalyst”.

Preferably the composition of the invention comprises from 0.001 to 1, more preferably from 0.002 to 0.01 grams of bleach catalyst. Preferably the bleach catalyst is a manganese bleach catalyst.

Inorganic Builder

The composition of the invention preferably comprises an inorganic builder. Suitable inorganic builders are selected from the group consisting of carbonate, silicate and mixtures thereof. Especially preferred for use herein is sodium carbonate. Preferably the composition of the invention comprises from 1 to 8, more preferably from 2 to 6 and especially from 3 to 5 grams of calcium carbonate.

Surfactant

Surfactants suitable for use herein include non-ionic surfactants, preferably the compositions are free of any other surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Amine oxides surfactants are useful for use in the composition of the invention. Preferred are C10-C18 alkyl dimethylamine oxide, and C10-18 acylamido alkyl dimethylamine oxide.

Surfactants may be present in amounts from 0.1 to 10, more preferably from 0.5 to 5 and especially from 0.8 to 3 grams.

Enzymes

In describing enzyme variants herein, the following nomenclature is used for ease of reference: Original amino acid(s):position(s):substituted amino acid(s). Standard enzyme IUPAC 1-letter codes for amino acids are used.

Proteases

Suitable proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference:V68A, N87S, S99D, S99SD, S99A, S101G, S101M, S103A, V104N/I, G118V, G118R, S128L, P129Q, S130A, Y167A, R170S, A194P, V205I and/or M222S.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).
(i) G118V+S128L+P129Q+S130A
(ii) S101M+G118V+S128L+P129Q+S130A
(iii) N76D+N87R+G118R+S128L+P129Q+S130A+S188D+N248R
(iv) N76D+N87R+G118R+S128L+P129Q+S130A+S188D+V244R
(v) N76D+N87R+G118R+S128L+P129Q+S130A
(vi) V68A+N87S+S101G+V104N

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3®, FN4®, Excellase®, Ultimase® and Purafect OXP® by Genencor International, those sold under the tradename Opticlean® and Optimase® by Solvay Enzymes, those available from Henkel/Kemira, namely BLAP.

Preferred levels of protease in the product of the invention include from about 0.1 to about 10, more preferably from about 0.5 to about 7 and especially from about 1 to about 6 mg of active protease.

Amylases

Preferred enzyme for use herein includes alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:
9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*.
(b) variants exhibiting at least 95% identity with the wild-type enzyme from Bacillus sp.707 (SEQ ID NO:7 in U.S. Pat. No. 6,093, 562), especially those comprising one or more of the following mutations M202, M208, S255, R172, and/or M261. Preferably said amylase comprises one of M202L or M202T mutations.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, POWERASE®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, POWERASE® and mixtures thereof.

Preferably, the product of the invention comprises at least 0.01 mg, preferably from about 0.05 to about 10, more preferably from about 0.1 to about 6, especially from about 0.2 to about 5 mg of active amylase.

Additional Enzymes

Additional enzymes suitable for use in the product of the invention can comprise one or more enzymes selected from the group comprising hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, and mixtures thereof.

Preferably, the protease and/or amylase of the product of the invention are in the form of granulates, the granulates comprise less than 29% of sodium sulfate by weight of the granulate or the sodium sulfate and the active enzyme (protease and/or amylase) are in a weight ratio of less than 4:1.

Crystal Growth Inhibitor

Crystal growth inhibitors are materials that can bind to calcium carbonate crystals and prevent further growth of species such as aragonite and calcite.

Especially preferred crystal growth inhibitor for use herein is HEDP (1-hydroxyethylidene 1,1-diphosphonic acid). Preferably, the composition of the invention comprises from 0.01 to 1, more preferably from 0.05 to 0.8 grams of a crystal growth inhibitor, preferably HEDP.

Metal Care Agents

Metal care agents may prevent or reduce the tarnishing, corrosion or oxidation of metals, including aluminium, stainless steel and non-ferrous metals, such as silver and copper. Preferably the composition of the invention comprises from 0.001 to 0.01, more preferably from 0.002 to 0.009 grams, preferably the metal care agent is benzo triazole (BTA).

Glass Care Agents

Glass care agents protect the appearance of glass items during the dishwashing process. Preferably the composition of the invention comprises from 0.001 to 1, more preferably from 0.002 to 0.5 grams of a glass care agent, preferably the glass care agent is a zinc salt.

Hand Dishwashing Detergent Compositions

The hand dishwashing detergent compositions are preferably in liquid form. They typically contain from about 0.05% to about 0. 1.0%, preferably from about 0.07% to about 0.60%, more preferably from about 0.10% to about 0.50% of a perfume disclosed herein. Preferably said perfume is selected from the group consisting of Table 1 perfumes 1, 3, 4, and 5, preferably said perfume is selected from the group consisting of Table 1 perfumes 1 and 5, more preferably said perfume is Table 1 Perfume 5.

It typically contains from 30% to 95%, preferably from 40% to 90%, more preferably from 50% to 85% by weight of a liquid carrier in which the other essential and optional components are dissolved, dispersed or suspended. One preferred component of the liquid carrier is water.

Preferably the pH of the detergent is adjusted to between 4 and 12, more preferably between 6 and 12 and most preferably between 8 and 10. The pH of the detergent can be adjusted using pH modifying ingredients known in the art.

Enzymes

Enzyme(s) which may be comprised in the composition of the invention include one or more enzymes such as lipase, protease, cutinase, amylase, carbohydrase, cellulase, pectinase, mannanase, arabinase, galactanase, xylanase, perhydrolase, oxidase, e.g., laccase, and/or peroxidase.

A preferred combination of enzymes comprises, e.g., a protease, lipase and amylase. When present in a composition, the aforementioned additional enzymes may be present at levels from 0.00001 to 2 wt %, from 0.0001 to 1 wt % or from 0.001 to 0.5 wt % enzyme protein by weight of the composition.

Lyases: The lyase may be a pectate lyase derived from Bacillus, particularly B. licheniformis or B. agaradhaerens, or a variant thereof. Commercially available pectate lyases are XPect™; Pectawash™ and Pectaway™ (Novozymes A/S).

Mannanases: Suitable mannanases include those of bacterial or fungal origin. Chemically or genetically modified mutants are included. A commercially available mannanase is Mannaway™ (Novozymes A/S).

Proteases: Suitable proteases include those of bacterial, fungal, plant, viral or animal origin e.g. vegetable or microbial origin. Microbial origin is preferred. Chemically modified or protein engineered mutants are included. It may be an alkaline protease, such as a serine protease or a metalloprotease.

Suitable commercially available protease enzymes include those sold under the trade names Alcalase™, Duralase™, Durazym™, Relase™, Relase™ Ultra, Savinase™, Savinase™ Ultra, Primase™, Polarzyme™, Kannase™, Liquanase™, Liquanase™ Ultra, Ovozyme™, Coronase™, Coronase™ Ultra, Neutrase™, Everlase™ and Esperase™ (Novozymes A/S), those sold under the tradename Maxatase™, Maxacal™, Maxapem™, Purafect™, Purafect Prime™, Preferenz™, Purafect MA™, Purafect Ox™, Purafect OxP™, Puramax™,

Properase™, Effectenz™, FN2™, FN3™, FN4™, Excellase™, Opticlean™ and Optimase™ (Danisco/DuPont), Axapem™ (Gist-Brocases N.V.),

Lipases and Cutinases: Suitable lipases and cutinases include those of bacterial or fungal origin. Chemically modified or protein engineered mutant enzymes are included.

Preferred commercial lipase products include Lipolase™, Lipex™; Lipolex™ and Lipoclean™ (Novozymes A/S), Lumafast™ (originally from Genencor) and Lipomax™ (originally from Gist-Brocades). Preferably the lipase is present in the composition of the invention in a level of from 0.001-2%, more preferably from 0.005 to 1.5 and especially from 0.01 to 1% of pure enzyme, by weight of the composition.

Amylases: Suitable amylases include alpha-amylases and/or glucoamylases and may be of bacterial or fungal origin. Chemically modified or protein engineered mutants are included.

Commercially available amylases are Duramyl™, Termamyl™, Fungamyl™, Stainzyme™, Stainzyme Plus™, Natalase™, Liquozyme X™ and BAN™ (from Novozymes A S), and Rapidase™, Purastar™/Effectenz™, Powerase™, Preferenz S1000™, Preferenz S100™ and Preferenz S1 10™ (from Genencor International Inc./DuPont).

The composition of the invention may comprise at least 0.05%, preferably at least 0.15%, more preferably at least 0.25% and most preferably at least 0.35% by weight of the composition of at least one monovalent, divalent or trivalent cation or a mixture thereof. The composition preferably comprises from 0.35% to 4%, more preferably from 0.35% to 3%, more preferably from 0.35 to 2% and especially from 0.35 to 1% by weight of the composition of the at least one cation. Preferably, the cation source the cation source is selected from the inorganic or organic salts of alkali metals, alkaline earth metals, of aluminum, iron, copper and zinc, preferably of the alkali metals and alkaline earth metals, preferably selected from the halides, sulphates, sulphites, carbonates, bicarbonates, phosphates, nitrates, nitrites, phosphates, formates, acetates, propionates, citrates, malates, tartrates, succinates, oxalates, lactates, and mixtures thereof.

More preferably, the cation source is selected from sodium chloride, calcium chloride, potassium chloride, sodium sulfate, potassium sulfate, sodium acetate, potassium acetate, sodium formate, potassium formate, and mixtures thereof: more preferably the cation source is selected from calcium chloride, potassium chloride, potassium sulfate, sodium acetate, potassium acetate, sodium formate and potassium formate, and mixtures thereof and in particular from potassium chloride, potassium sulfate, potassium acetate, potassium formate, and mixtures thereof.

Surfactants

The liquid detergent can comprise from about 1% to about 50%, preferably from about 5% to about 40% more preferably from about 8% to about 35% by weight thereof of a surfactant system. The surfactant system comprises an anionic surfactant, preferably an alkoxylated sulfate anionic surfactant. Most preferably the system further comprises an amphoteric and/or zwitterionic surfactant, and optionally a non-ionic surfactant.

Preferably, the anionic surfactant system comprises alkyl sulfates and/or alkyl ethoxy sulfates; more preferably a combination of alkyl sulfates and/or alkyl ethoxy sulfates with a combined average ethoxylation degree of less than 5, preferably from about 0.2 to about 3, more preferably from about 0.3 to about 2, even more preferably from 0.5 to about 1. Preferably the anionic surfactant system has an average level of branching of from about 5% to about 40%.

Preferably, the composition of the present invention will comprise amphoteric (amine oxide co-surfactant and optionally a zwitterionic co-surfactant, more preferably an amine oxide and optionally but preferably a betaine co-surfactant. The composition can comprise from about 0.01% to about 25% wt, preferably from about 0.2% to about 20% wt, more preferably from about 0.5% to about 15% by weight of the composition of co-surfactant.

The composition can further comprise a nonionic surfactant, preferably an alkoxylated alcohol nonionic surfactant, even more preferably an ethoxylated nonionic surfactant.

The most preferred surfactant system for the detergent composition of the present invention will therefore comprise: (1) 1% to 40%, preferably 6% to 32%, more preferably 8% to 25% weight of the total composition of an anionic surfactant, preferably an alkoxylated sulfate surfactant (2) combined with 0.01% to 25% wt, preferably from 0.2% to 20% wt, more preferably from 0.5% to 15% by weight of the composition of co-surfactant, an amphoteric amine oxide co-surfactant. It has been found that such surfactant system in combination with the lipase will provide the excellent cleaning required from a hand dishwashing detergent.

Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C 8-C 22 alkyl, or acyl group. Such surfactants are employed in the form of water-soluble salts and the salt-forming cation usually is selected from sodium, potassium, ammonium, magnesium and mono-, di- or tri-C 2-C 3 alkanolammonium, with the sodium, cation being the usual one chosen.

The anionic surfactant can be a single surfactant but usually it is a mixture of anionic surfactants. Preferably the anionic surfactant comprises a sulphate surfactant, more preferably a sulphate surfactant selected from the group consisting of alkyl sulphate, alkyl alkoxy sulphate and mixtures thereof. Preferred alkyl alkoxy sulphates for use herein are alkyl ethoxy sulphates.

Preferably the anionic surfactant is alkoxylated, more preferably, an alkoxylated branched anionic surfactant having an alkoxylation degree of from about 0.1 to about 4, even more preferably from about 0.2 to about 3, even more preferably from about 0.3 to about 2 and especially from about 0.5 to about 1. Preferably, the alkoxy group is ethoxy. When the branched anionic surfactant is a mixture of surfactants, the alkoxylation degree is the weight average alkoxylation degree of all the components of the mixture (weight average alkoxylation degree). In the weight average alkoxylation degree calculation the weight of anionic surfactant components not having alkoxylated groups should also be included.

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each anionic surfactant of the mixture and alkoxylation degree is the number of alkoxy groups in each anionic surfactant.

Preferably the anionic surfactant to be used in the detergent of the present invention is a branched anionic surfactant having a level of branching of from about 5% to about 40%, preferably from about 10 to about 35% and more preferably from about 20% to about 30%. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the anionic surfactant used in the detergent of the invention. Most preferably the branched anionic surfactant is selected from alkyl sulphates, alkyl ethoxy sulphates, and mixtures thereof.

The branched anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

Preferably, the anionic surfactant system comprises an alkyl ethoxylated sulphate having an average ethoxylation degree of from about 0.2 to about 3 and preferably a level of branching of from about 5% to about 40%.

Sulphate Surfactants

Suitable sulphate surfactants for use herein include water-soluble salts of C8-C18 alkyl or hydroxyalkyl, sulphate and/or ether sulfate. Suitable counterions include alkali metal cation or ammonium or substituted ammonium, but preferably sodium.

The sulphate surfactants may be selected from C8-C18 primary, branched chain and random alkyl sulphates (AS); C8-C18 secondary (2,3) alkyl sulphates; C8-C18 alkyl alkoxy sulphates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulphates include, those based on Neodol alcohols ex the Shell company, Lial—Isalchem and Safol ex the Sasol company, natural alcohols ex The Procter & Gamble Chemicals company.

Preferably, the branched anionic surfactant comprises at least 50%, more preferably at least 60% and especially at least 70% of a sulphate surfactant by weight of the branched anionic surfactant. Especially preferred detergents from a cleaning view point art those in which the branched anionic surfactant comprises more than 50%, more preferably at least 60% and especially at least 70% by weight thereof of sulphate surfactant and the sulphate surfactant is selected from the group consisting of alkyl sulphate, alkyl ethoxy sulphates and mixtures thereof. Even more preferred are those in which the branched anionic surfactant has a degree of ethoxylation of from about 0.2 to about 3, more preferably from about 0.3 to about 2, even more preferably from about 0.4 to about 1.5, and especially from about 0.5 to about 1 and even more preferably when the anionic surfactant has a level of branching of from about 10% to about 35%, %, more preferably from about 20% to 30%.

Sulphonate Surfactants

Suitable sulphonate surfactants for use herein include water-soluble salts of C8-C18 alkyl or hydroxyalkyl sulphonates; C11-C18 alkyl benzene sulphonates (LAS), modified alkylbenzene sulphonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

Nonionic Surfactants

Nonionic surfactant, when present, is comprised in a typical amount of from 0.1% to 30%, preferably 0.2% to 20%, more preferably 0.3% to 10%, most preferably 0.5-5% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

An alternative nonionic surfactant could be selected from the group of alkyl polyglucoside surfactants (APG's).

Amine Oxide Co-Surfactant

Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or branched alkyl moiety. Typical amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3)O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. The amine oxide further comprises two moieties R2 and R3, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

Zwitterionic Co-Surfactant

Other suitable co-surfactants include betaines, such as alkyl betaines, alkylamidobetaine, amidazoliniumbetaine, sulfobetaine (INCI Sultaines) as well as the Phosphobetaine and preferably meets formula I:

R¹—[CO—X(CH₂)ₙ]ₓ—N⁺(R²)(R₃)—(CH₂)ₘ—[CH(OH)—CH₂]_{y}—Y— (I) wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, O or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(0R⁵)O, whereby R⁵ is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id)

in which R¹1 as the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropylbetain.

The detergent composition herein may comprise a number of optional ingredients such as builders, chelants, conditioning polymers, cleaning polymers, surface modifying polymers, soil flocculating polymers, structurants, emmolients, humectants, skin rejuvenating actives, carboxylic acids, scrubbing particles, bleach and bleach activators, perfumes, malodor control agents, pigments, dyes, opacifiers, beads, pearlescent particles, microcapsules, diamines, antibacterial agents, preservatives and pH adjusters and buffering means.

### Perfume Delivery System

As disclosed, the benefits of the perfumes disclosed herein may be further enhanced by employing a perfume delivery system to apply such perfumes. Non-limiting examples of suitable perfume delivery systems, methods of making perfume delivery systems and the uses of such perfume delivery systems are disclosed in USPA 2007/0275866 A1. Such perfume delivery systems include:
Polymer Assisted Delivery (PAD): This perfume delivery technology uses polymeric materials to deliver perfume materials. Classical coacervation, water soluble or partly soluble to insoluble charged or neutral polymers, liquid crystals, hot melts, hydrogels, perfumed plastics, microcapsules, nano- and micro-latexes, polymeric film formers, and polymeric absorbents, polymeric adsorbents, etc. are some examples. PAD includes but is not limited to:
   Matrix Systems: The fragrance is dissolved or dispersed in a polymer matrix or particle. Perfumes, for example, may be 1) dispersed into the polymer prior to formulating into the product or 2) added separately from the polymer during or after formulation of the product. Diffusion of perfume from the polymer is a common trigger that allows or increases the rate of perfume release from a polymeric matrix system that is deposited or applied to the desired surface (situs), although many other triggers are known that may control perfume release. Absorption and/or adsorption into or onto polymeric particles, films, solutions, and the like are aspects of this technology. Nano- or micro-particles composed of organic materials (e.g., latexes) are examples. Suitable particles include a wide range of materials including, but not limited to polyacetal, polyacrylate, polyacrylic, polyacrylonitrile, polyamide, polyaryletherketone, polybutadiene, polybutylene, polybutylene terephthalate, polychloroprene, polyethylene, polyethylene terephthalate, polycyclohexylene dimethylene terephthalate, polycarbonate, polychloroprene, polyhydroxyalkanoate, polyketone, polyester, polyetherimide, polyethersulfone, polyethylenechlorinates, polyimide, polyisoprene, polylactic acid, polymethylpentene, polyphenylene oxide, polyphenylene sulfide, polyphthalamide, polypropylene, polystyrene, polysulfone, polyvinyl acetate, polyvinyl chloride, as well as polymers or copolymers based on acrylonitrile-butadiene, cellulose acetate, ethylene-vinyl acetate, ethylene vinyl alcohol, styrene-butadiene, vinyl acetate-ethylene, and mixtures thereof.
   “Standard” systems refer to those that are “pre-loaded” with the intent of keeping the pre-loaded perfume associated with the polymer until the moment or moments of perfume release. Such polymers may also suppress the neat product odor and provide a bloom and/or longevity benefit depending on the rate of perfume release. One challenge with such systems is to achieve the ideal balance between 1) in-product stability (keeping perfume inside carrier until you need it) and 2) timely release (during use or from dry situs). Achieving such stability is particularly important during in-product storage and product aging. This challenge is particularly apparent for aqueous-based, surfactant-containing products, such as heavy duty liquid laundry detergents. Many “Standard” matrix systems available effectively become “Equilibrium” systems when formulated into aqueous-based products. One may select an “Equilibrium” system or a Reservoir system, which has acceptable in-product diffusion stability and available triggers for release (e.g., friction). “Equilibrium” systems are those in which the perfume and polymer may be added separately to the product, and the equilibrium interaction between perfume and polymer leads to a benefit at one or more consumer touch points (versus a free perfume control that has no polymer-assisted delivery technology). The polymer may also be pre-loaded with perfume; however, part or all of the perfume may diffuse during in-product storage reaching an equilibrium that includes having desired perfume raw materials (PRMs) associated with the polymer. The polymer then carries the perfume to the surface, and releases it typically via perfume diffusion. The use of such equilibrium system polymers has the potential to decrease the odor intensity of the neat product (usually more so in the case of pre-loaded standard systems). Deposition of such polymers may serve to “flatten” the release profile and provide increased longevity. As indicated above, such longevity would be achieved by suppressing the initial intensity and may enable the formulator to use more high impact or low odor detection threshold (ODT) or low Kovats Index (KI) PRMs to achieve FMOT benefits without initial intensity that is too strong or distorted. It is important that perfume release occurs within the time frame of the application to impact the desired consumer touch point or touch points. Matrix systems also include hot melt adhesives and perfume plastics. In addition, hydrophobically modified polysaccharides may be formulated into the perfumed product to increase perfume deposition and/or modify perfume release. All such matrix systems, including for example polysaccarides and nanolatexes may be combined with other PDTs, including other PAD systems such as PAD reservoir systems in the form of a perfume microcapsule (PMC).
   Silicones are also examples of polymers that may be used as PDT, and can provide perfume benefits in a manner similar to the polymer-assisted delivery “matrix system”. Such a PDT is referred to as silicone-assisted delivery (SAD). One may pre-load silicones with perfume, or use them as an equilibrium system as described for PAD. Examples of silicones include polydimethylsiloxane and polyalkyldimethylsiloxanes. Other examples include those with amine functionality, which may be used to provide benefits associated with amine-assisted delivery (AAD) and/or polymer-assisted delivery (PAD) and/or amine-reaction products (ARP).
Reservoir Systems: Reservoir systems are also known as a core-shell type technology, or one in which the fragrance is surrounded by a perfume release controlling membrane, which may serve as a protective shell. The material inside the microcapsule is referred to as the core, internal phase, or fill, whereas the wall is sometimes called a shell, coating, or membrane. Microparticles or pressure sensitive capsules or microcapsules are examples of this technology. Microcapsules of the current invention are formed by a variety of procedures that include, but are not limited to, coating, extrusion, spray-drying, interfacial, in-situ and matrix polymerization. The possible shell materials vary widely in their stability toward water. Among the most stable are polyoxymethyleneurea (PMU)-based materials, which may hold certain PRMs for even long periods of time in aqueous solution (or product). Such systems include but are not limited to urea-formaldehyde and/or melamine-formaldehyde. Gelatin-based microcapsules may be prepared so that they dissolve quickly or slowly in water, depending for example on the degree of cross-linking. Many other capsule wall materials are available and vary in the degree of perfume diffusion stability observed. Without wishing to be bound by theory, the rate of release of perfume from a capsule, for example, once deposited on a surface is typically in reverse order of in-product perfume diffusion stability. As such, urea-formaldehyde and melamine-formaldehyde microcapsules for example, typically require a release mechanism other than, or in addition to, diffusion for release, such as mechanical force (e.g., friction, pressure, shear stress) that serves to break the capsule and increase the rate of perfume (fragrance) release. Other triggers include melting, dissolution, hydrolysis or other chemical reaction, electromagnetic radiation, and the like. The use of pre-loaded microcapsules requires the proper ratio of in-product stability and in-use and/or on-surface (on-situs) release, as well as proper selection of PRMs. Microcapsules that are based on urea-formaldehyde and/or melamine-formaldehyde are relatively stable, especially in near neutral aqueous-based solutions. These materials may require a friction trigger which may not be applicable to all product applications. Other microcapsule materials (e.g., gelatin) may be unstable in aqueous-based products and may even provide reduced benefit (versus free perfume control) when in-product aged. Scratch and sniff technologies are yet another example of PAD.
Molecule-Assisted Delivery (MAD): Non-polymer materials or molecules may also serve to improve the delivery of perfume. Without wishing to be bound by theory, perfume may non-covalently interact with organic materials, resulting in altered deposition and/or release. Non-limiting examples of such organic materials include but are not limited to hydrophobic materials such as organic oils, waxes, mineral oils, petrolatum, fatty acids or esters, sugars, surfactants, liposomes and even other perfume raw material (perfume oils), as well as natural oils, including body and/or other soils. Perfume fixatives are yet another example. In one aspect, non-polymeric materials or molecules have a CLogP greater than about 2.
Cyclodextrin (CD): This technology approach uses a cyclic oligosaccharide or cyclodextrin to improve the delivery of perfume. Typically a perfume and cyclodextrin (CD) complex is formed. Such complexes may be preformed, formed in-situ, or formed on or in the situs. Without wishing to be bound by theory, loss of water may serve to shift the equilibrium toward the CD-Perfume complex, especially if other adjunct ingredients (e.g., surfactant) are not present at high concentration to compete with the perfume for the cyclodextrin cavity. A bloom benefit may be achieved if water exposure or an increase in moisture content occurs at a later time point. In addition, cyclodextrin allows the perfume formulator increased flexibility in selection of PRMs. Cyclodextrin may be pre-loaded with perfume or added separately from perfume to obtain the desired perfume stability, deposition or release benefit.
Starch Encapsulated Accord (SEA): The use of a starch encapsulated accord (SEA) technology allows one to modify the properties of the perfume, for example, by converting a liquid perfume into a solid by adding ingredients such as starch. The benefit includes increased perfume retention during product storage, especially under non-aqueous conditions. Upon exposure to moisture, a perfume bloom may be triggered. Benefits at other moments of truth may also be achieved because the starch allows the product formulator to select PRMs or PRM concentrations that normally cannot be used without the presence of SEA. Another technology example includes the use of other organic and inorganic materials, such as silica to convert perfume from liquid to solid.
Zeolite & Inorganic Carrier (ZIC): This technology relates to the use of porous zeolites or other inorganic materials to deliver perfumes. Perfume-loaded zeolite may be used with or without adjunct ingredients used for example to coat the perfume-loaded zeolite (PLZ) to change its perfume release properties during product storage or during use or from the dry situs. Silica is another form of ZIC. Another example of a suitable inorganic carrier includes inorganic tubules, where the perfume or other active material is contained within the lumen of the nano- or micro-tubules. Preferably, the perfume-loaded inorganic tubule (or Perfume-Loaded Tubule or PLT) is a mineral nano- or micro-tubule, such as halloysite or mixtures of halloysite with other inorganic materials, including other clays. The PLT technology may also comprise additional ingredients on the inside and/or outside of the tubule for the purpose of improving in-product diffusion stability, deposition on the desired situs or for controlling the release rate of the loaded perfume. Monomeric and/or polymeric materials, including starch encapsulation, may be used to coat, plug, cap, or otherwise encapsulate the PLT.

In one aspect, a perfume delivery system selected from the group consisting of a Polymer Assisted Delivery (PAD) system, Molecule-Assisted Delivery (MAD) system, Cyclodextrin (CD) system, Starch Encapsulated Accord (SEA) system, Zeolite & Inorganic Carrier (ZIC) system, wherein said perfume delivery system may comprise a perfume disclosed in this specification, for example a perfume selected from the perfumes disclosed in the perfume section of this specification, is disclosed.

In one aspect, a Polymer Assisted Delivery (PAD) system wherein said Polymer Assisted Delivery (PAD) system may comprise a Polymer Assisted Delivery (PAD) Reservoir system that may comprise a perfume disclosed in this specification, for example a perfume selected from the perfumes disclosed in the perfume section of this specification, is disclosed.

In one aspect of, said Polymer Assisted Delivery (PAD) Reservoir system said Polymer Assisted Delivery (PAD) Reservoir system may comprise a perfume delivery particle that may comprise a shell material and a core material, said shell material encapsulating said core material, said core material may comprise a perfume disclosed in this specification, for example a perfume selected from the perfumes disclosed in the perfume section of this specification, and said shell comprising a material selected from the group consisting of polyethylenes; polyamides; polystyrenes; polyisoprenes; polycarbonates; polyesters; polyacrylates; aminoplasts, in one aspect said aminoplast comprises a polyurea, polyurethane, and/or polyureaurethane, in one aspect said polyurea comprises polyoxymethyleneurea and/or melamine formaldehyde; polyolefins; polysaccharides, in one aspect alginate and/or chitosan; gelatin; shellac; epoxy resins; vinyl polymers; water insoluble inorganics; silicone; and mixtures thereof.

In one aspect, of said Polymer Assisted Delivery (PAD) Reservoir system said shell may comprise melamine formaldehyde and/or cross linked melamine formaldehyde.

In one aspect of said Polymer Assisted Delivery (PAD) Reservoir system said shell may be coated by a water-soluble cationic polymer selected from the group that consists of polysaccharides, cationically modified starch and cationically modified guar, polysiloxanes, dimethyldiallylammonium polyhalogenides, copolymers of dimethyldiallylammonium polychloride and vinyl pyrrolidone, acrylamides, imidazoles, imidazolinium halogenides and imidazolium halogenides and polyvinyl amine and its copolymers with N-vinyl formamide.

In one aspect of said Polymer Assisted Delivery (PAD) Reservoir system said coating that coats said shell, may comprise a cationic polymer and an anionic polymer.

In one aspect of said Polymer Assisted Delivery (PAD) Reservoir system wherein said cationic polymer may comprise hydroxyl ethyl cellulose; and said anionic polymer may comprise carboxyl methyl cellulose.

In one aspect, said Polymer Assisted Delivery (PAD) Reservoir system is a perfume microcapsule.

### Process of Making Encapsulates

In one aspect, a process that may comprise:
a.) preparing a first solution that may comprise, based on total solution weight from about 20% to about 90%, from about 40% to about 80%, or even from about 60% to about 80% water, of a first emulsifier and a first resin, the ratio of said first emulsifier and said first resin being from about 0.1:0 to about 10:0, from about 0.1:1 to about 10:1, from about 0.5:1 to about 3:1, or even from about 0.8:1 to about 1.1:1;
b.) preparing a second solution that may comprise based on total solution weight from about 20% to about 95% water, of a second emulsifier and a second resin, the ratio of said second emulsifier and said second resin being from about 0:1 to about 3:1, from about 0.04:1 to about 0.2:1, or even from about 0.05:1 to about 0.15:1;
c.) combining a core material that may comprise a perfume disclosed in the present specification, for example, a perfume selected from the group consisting of Table 1 perfumes 1, 3, 4, and 5, a perfume is selected from the group consisting of Table 1 perfumes 1 and 5, or Table 1 Perfume 5; and said first solution to form a first composition;
d.) emulsifying said first composition;
e.) combining said first composition and said second solution to form a second composition and optionally combining any processing aids and said second composition—said first composition and said second solution may be combined in any order but in one aspect said second solution is added to said first composition or said second solution and said first composition are combined simultaneously;
f.) mixing said second composition for at least 15 minutes, at least 1 hour or even from about 4 hours to about 100 hours at a temperature of from about 25° C. to about 100° C., from about 45° C. to about 90° C., or even from about 50° C. to about 80° C. heat and optionally combining any processing aids to said second composition;
g.) optionally combining any scavenger material, structurant, and/or anti-agglomeration agent with said second composition during step f.) or thereafter—such materials may be combined in any order but in one aspect the scavenger material is combined first, any structurant second, and then anti-agglomeration agent is combined; and
h.) optionally spray drying said second composition

is disclosed.

In one or more aspects of the process, said first and second resins may comprise the reaction product of an aldehyde and an amine, suitable aldehydes include, formaldehyde. Suitable amines include melamine, urea, benzoguanamine, glycoluril, and mixtures thereof. Suitable melamines include, methylol melamine, methylated methylol melamine, imino melamine and mixtures thereof. Suitable ureas include, dimethylol urea, methylated dimethylol urea, urea-resorcinol, and mixtures thereof.

In one or more aspects of the process, said first and second emulsifiers may comprise a moiety selected from the group consisting of carboxy, hydroxyl, thiol, amine, amide and combinations thereof. In one aspect, said emulsifier may have a pKa of less than 5, preferably greater than 0 but less than 5. Emulsifiers include acrylic acid-alkyl acrylate copolymer, poly(acrylic acid), polyoxyalkylene sorbitan fatty esters, polyalkylene co-carboxy anhydrides, polyalkylene co-maleic anhydrides, poly(methyl vinyl ether-co-maleic anhydride), poly(propylene-co-maleic anhydride), poly(butadiene co-maleic anhydride), and poly(vinyl acetate-co-maleic anhydride), polyvinyl alcohols, polyalkylene glycols, polyoxyalkylene glycols, and mixtures thereof.

In one or more aspects of the process, the pH of the first and second solutions may be controlled such that the pH of said first and second solution is from about 3.0 to 7.0.

In one or more aspects of the process, during step f.), from about 0% to about 10%, from about 1% to about 5% or even from about 2% to about 4%, based on total second composition weight, of a salt comprising an anion and cation, said anion being selected from the group consisting of chloride, sulfate, phosphate, nitrate, polyphosphate, citrate, maleate, fumarate and mixtures thereof; and said cation being selected from the group consisting of a Periodic Group IA element, Periodic Group IIA element, ammonium cation and mixtures thereof, preferably sodium sulfate, may be combined with said second composition.

In one or more aspects of the process, any of the aforementioned processing parameters may be combined.

Supplemental teachings of making suitable encapsulates as well as suitable shell materials are described in U.S. Pat. No. 6,869,923 B1 and US Published Patent Applications Nos. 2005/0276831 A1 and 2007/020263 A1. Suitable equipment for use in the processes disclosed herein may include continuous stirred tank reactors, homogenizers, turbine agitators, recirculating pumps, paddle mixers, ploughshear mixers, ribbon blenders, vertical axis granulators and drum mixers, both in batch and, where available, in continuous process configurations, spray dryers, and extruders. Such equipment can be obtained from Lodige GmbH (Paderborn, Germany), Littleford Day, Inc. (Florence, Ky., U.S.A.), Forberg A S (Larvik, Norway), Glatt Ingenieurtechnik GmbH (Weimar, Germany), Niro (Soeborg, Denmark), Hosokawa Bepex Corp. (Minneapolis, Minn., U.S.A.), Arde Barinco (New Jersey, U.S.A.).

### Adjunct Materials

While not essential for each consumer product embodiment of the present invention, the non-limiting list of adjuncts illustrated hereinafter are suitable for use in the instant consumer products and may be desirably incorporated in certain embodiments of the invention, for example to assist or enhance performance, for treatment of the substrate to be cleaned, or to modify the aesthetics of the composition as is the case with perfumes, colorants, dyes or the like. The precise nature of these additional components, and levels of incorporation thereof, will depend on the physical form of the composition and the nature of the operation for which it is to be used. Such adjunct are in addition to the perfumes and/or perfume delivery systems previously disclosed herein. Suitable adjunct materials include, but are not limited to, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, thickeners/structurants, fabric softeners, carriers, hydrotropes, processing aids and/or pigments.

As stated, the adjunct ingredients are not essential for each consumer product embodiment of the present invention. Thus, certain embodiments of Applicants' compositions do not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, thickeners/structurants, fabric softeners, carriers, hydrotropes, processing aids and/or pigments. However, when one or more adjuncts is present, such one or more adjuncts may be present as detailed below:

Surfactants—The compositions according to the present invention can comprise a surfactant or surfactant system wherein the surfactant can be selected from nonionic and/or anionic and/or cationic surfactants and/or ampholytic and/or zwitterionic and/or semi-polar nonionic surfactants. The surfactant is typically present at a level of from about 0.1%, from about 1%, or even from about 5% by weight of the cleaning compositions to about 99.9%, to about 80%, to about 35%, or even to about 30% by weight of the cleaning compositions.

Builders—The compositions of the present invention can comprise one or more detergent builders or builder systems. When present, the compositions will typically comprise at least about 1% builder, or from about 5% or 10% to about 80%, 50%, or even 30% by weight, of said builder. Builders include, but are not limited to, the alkali metal, ammonium and alkanolammonium salts of polyphosphates, alkali metal silicates, alkaline earth and alkali metal carbonates, aluminosilicate builders, polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

Dispersants—The compositions of the present invention can also contain dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methyl-enephosphonic acid) and water-soluble salts thereof.

If desired, the compositions herein can be catalyzed by means of a manganese compound. Such compounds and levels of use are well known in the art.

Compositions herein may also suitably include a transition metal complex of a macropolycyclic rigid ligand—abbreviated as “MRL”. As a practical matter, and not by way of limitation, the compositions and cleaning processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor.

Preferred transition-metals in the instant transition-metal bleach catalyst include manganese, iron and chromium. Preferred MRL's herein are a special type of ultra-rigid ligand that is cross-bridged such as 5,12-diethyl-1,5,8,12-tetraazabicyclo [6.6.2]hexa-decane.

Rheology Modifier

The liquid compositions of the present invention may comprise a rheology modifier. The rheology modifier may be selected from the group consisting of non-polymeric crystalline, hydroxy-functional materials, polymeric rheology modifiers which impart shear thinning characteristics to the aqueous liquid matrix of the composition. In one aspect, such rheology modifiers impart to the aqueous liquid composition a high shear viscosity, at 20 sec⁻¹ shear rate and at 21° C., of from 1 to 7000 cps and a viscosity at low shear (0.5 sec⁻¹ shear rate at 21° C.) of greater than 1000 cps, or even 1000 cps to 200,000 cps. In one aspect, for cleaning and treatment compositions, such rheology modifiers impart to the aqueous liquid composition a high shear viscosity, at 20 sec⁻¹ and at 21° C., of from 50 to 3000 cps and a viscosity at low shear (0.5 sec⁻¹ shear rate at 21° C.) of greater than 1000 cps, or even 1000 cps to 200,000 cps. Viscosity according to the present invention is measured using an AR 2000 rheometer from TA instruments using a plate steel spindle having a plate diameter of 40 mm and a gap size of 500 μm. The high shear viscosity at 20 sec⁻¹ and low shear viscosity at 0.5 sec⁻¹ can be obtained from a logarithmic shear rate sweep from 0.1 sec⁻¹ ₜₒ 25 sec⁻¹ in 3 minutes time at 21° C. Crystalline hydroxyl functional materials are rheology modifiers which form thread-like structuring systems throughout the matrix of the composition upon in situ crystallization in the matrix. Polymeric rheology modifiers are preferably selected from polyacrylates, polymeric gums, other non-gum polysaccharides, and combinations of these polymeric materials.

Generally the rheology modifier will comprise from 0.01% to 1% by weight, preferably from 0.05% to 0.75% by weight, more preferably from 0.1% to 0.5% by weight, of the compositions herein.

Structuring agents which are especially useful in the compositions of the present invention may comprise non-polymeric (except for conventional alkoxylation), crystalline hydroxy-functional materials which can form thread-like structuring systems throughout the liquid matrix when they are crystallized within the matrix in situ. Such materials can be generally characterized as crystalline, hydroxyl-containing fatty acids, fatty esters or fatty waxes. In one aspect, rheology modifiers include crystalline, hydroxyl-containing rheology modifiers include castor oil and its derivatives. In one aspect, rheology modifiers include hydrogenated castor oil derivatives such as hydrogenated castor oil and hydrogenated castor wax. Commercially available, castor oil-based, crystalline, hydroxyl-containing rheology modifiers include THIXCIN™ from Rheox, Inc. (now Elementis).

Other types of rheology modifiers, besides the non-polymeric, crystalline, hydroxyl-containing rheology modifiers described heretofore, may be utilized in the liquid detergent compositions herein. Polymeric materials which provide shear-thinning characteristics to the aqueous liquid matrix may also be employed.

Suitable polymeric rheology modifiers include those of the polyacrylate, polysaccharide or polysaccharide derivative type. Polysaccharide derivatives typically used as rheology modifiers comprise polymeric gum materials. Such gums include pectine, alginate, arabinogalactan (gum Arabic), carrageenan, gellan gum, xanthan gum and guar gum.

If polymeric rheology modifiers are employed herein, a preferred material of this type is gellan gum. Gellan gum is a heteropolysaccharide prepared by fermentation of Pseudomonaselodea ATCC 31461. Gellan gum is commercially marketed by CP Kelco U.S., Inc. under the KELCOGEL tradename.

A further alternative and suitable rheology modifier include a combination of a solvent and a polycarboxylate polymer. More specifically the solvent may be an alkylene glycol. In one aspect, the solvent may comprise dipropylene glycol. In one aspect, the polycarboxylate polymer may comprise a polyacrylate, polymethacrylate or mixtures thereof. In one aspect, solvent may be present, based on total composition weight, at a level of from 0.5% to 15%, or from 2% to 9% of the composition. In one aspect, polycarboxylate polymer may be present, based on total composition weight, at a level of from 0.1% to 10%, or from 2% to 5%. In one aspect, the solvent component may comprise mixture of dipropylene glycol and 1,2-propanediol. In one aspect, the ratio of dipropylene glycol to 1,2-propanediol may be 3:1 to 1:3, or even 1:1. In one aspect, the polyacrylate may comprise a copolymer of unsaturated mono- or di-carbonic acid and C₁-C₃₀ alkyl ester of the (meth) acrylic acid. In another aspect, the rheology modifier may comprise a polyacrylate of unsaturated mono- or di-carbonic acid and C₁-C₃₀ alkyl ester of the (meth) acrylic acid. Such copolymers are available from Noveon Inc under the tradename Carbopol Aqua 30®.

In the absence of rheology modifier and in order to impart the desired shear thinning characteristics to the liquid composition, the liquid composition can be internally structured through surfactant phase chemistry or gel phases.

### Processes of Making and Using Consumer Products

The embodiments of consumer products of the present invention can be formulated into any suitable form and prepared by any process chosen by the formulator, non-limiting examples of which are described in U.S. Pat. No. 5,879,584; which is incorporated herein by reference.

### Method of Use and Treated Situs.

Compositions, such as consumer products, comprising Perfumes 1, and 3-5 and or a perfume delivery system comprising Perfumes 1, and 3-5, disclosed herein can be used to clean or treat a situs inter alia a surface or fabric. Thus, a method of treating and/or cleaning a situs, said method comprising
a) optionally washing and/or rinsing said situs;
b) contacting said situs with a consumer product and/or a perfume delivery system according to disclosed herein and mixtures thereof;
c) optionally washing and/or rinsing said situs; and
d) optionally drying said situs.
   Said drying may be active or passive drying.

For purposes of the present invention, washing includes but is not limited to, scrubbing, and mechanical agitation. The situs may comprise most any material, for example a fabric, fabric capable of being laundered or treated in normal consumer use conditions. Liquors that may comprise the disclosed compositions may have a pH of from about 3 to about 11.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

84 wt % Core/16 wt % Wall Melamine Formaldehyde (MF) Capsule 25 grams of butyl acrylate-acrylic acid copolymer emulsifier (Colloid C351, 25% solids, pka 4.5-4.7, (Kemira Chemicals, Inc. Kennesaw, Ga. U.S.A.) is dissolved and mixed in 200 grams deionized water. The pH of the solution is adjusted to pH of 4.0 with sodium hydroxide solution. 8 grams of partially methylated methylol melamine resin (Cymel 385, 80% solids, (Cytec Industries West Paterson, N.J., U.S.A.)) is added to the emulsifier solution. 200 grams of perfume oil according to Table 1 is added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 70° C. and maintained overnight with continuous stirring to complete the encapsulation process. 23 grams of acetoacetamide (Sigma-Aldrich, Saint Louis, Mo., U.S.A.) is added to the suspension. An average capsule size of 30 um is obtained as analyzed by a Model 780 Accusizer.

### Example 2

To demonstrate the benefit of the present invention, Applicants prepared liquid detergent matrix A, below.

| Active Material in weight % | A |
|---|---|
| C₁₄-C₁₅ alkyl poly ethoxylate 7 | 3.39 |
| C₁₂-C₁₄ alkyl poly ethoxylate 7 | 1.13 |
| C₁₂-C₁₄ alkyl poly ethoxylate 3 sulfate Na salt | 7.66 |
| Alkylbenzene sulfonic acid | 1.17 |
| Citric Acid | 2.73 |
| C₁₂₋₁₈ fatty acid | 5.06 |
| Enzymes | 0.2 |
| Boric Acid | 1.40 |
| Trans-sulphated ethoxylated hexamethylene diamine quat | 0.81 |
| Diethylene triamine penta methylene phosphonic acid | 0.12 |
| Hydrogenated Castor Oil structurant | 0.300 |
| Ethanol | 1.59 |
| 1,2 propanediol | 0.07 |
| Sodium hydroxide | 3.48 |
| Silicone PDMS emulsion | 0.0025 |
| Blue Dye | 0.0006 |
| Preservative Acticide MBS 2550 (ex Thor) | 0.0135 |
| Perfume according to Table 1 | 0.34 |
| Merquat 5300 polymer (1) | 0.19 |
| Water | Balance to |
| | 100% |

(1) Merquat 5300: terpolymer with mole ratio: 90% PAM/5% AA/5% MAPTAC produced by Nalco.

### Examples 3-10

Examples of laundry detergent compositions comprising the perfume composition are included below.

| | % w/w of laundry detergent compositions | | | | | | | |
|---|---|---|---|---|---|---|---|---|
| Raw material | 3 | 4 | 5 | 6 | 7 | 8 | 9 | 10 |
| Linear alkyl benzene | 7.1 | 6.7 | 11.0 | 10.6 | 6.9 | 4.5 | 10.1 | 8.9 |
| sulphonate | | | | | | | | |
| Sodium C₁₂₋₁₅ alkyl ethoxy | 3.5 | 0.0 | 1.5 | 0.0 | 0.0 | 0.0 | 0.0 | 1.9 |
| sulphate having a molar | | | | | | | | |
| average degree of | | | | | | | | |
| ethoxylation of 3 | | | | | | | | |
| Acrylic Acid/Maleic Acid | 3.6 | 1.8 | 4.9 | 2.0 | 1.0 | 1.6 | 3.9 | 2.3 |
| Copolymer | | | | | | | | |
| Sodium Alumino Silicate | 4.0 | 0.5 | 0.8 | 1.4 | 16.3 | 0.0 | 17.9 | 2.4 |
| (Zeolite 4A) | | | | | | | | |
| Sodium Tripolyphosphate | 0.0 | 17.5 | 0.0 | 15.8 | 0.0 | 23.3 | 0.0 | 0.0 |
| Sodium Carbonate | 23.2 | 16.8 | 30.2 | 17.3 | 18.4 | 9.0 | 20.8 | 30.0 |
| Sodium Sulphate | 31.4 | 29.4 | 35.5 | 7.2 | 26.3 | 42.8 | 33.2 | 28.3 |
| Sodium Silicate | 0.0 | 4.4 | 0.0 | 4.5 | 0.0 | 6.1 | 0.0 | 4.6 |
| C₁₄₋₁₅ alkyl ethoxylated | 0.4 | 2.6 | 0.8 | 2.5 | 3.1 | 0.3 | 3.8 | 0.4 |
| alcohol having a molar | | | | | | | | |
| average degree of | | | | | | | | |
| ethoxylation of 7 | | | | | | | | |
| Sodium Percarbonate | 16.0 | 0.0 | 8.4 | 20.4 | 13.1 | 3.6 | 0.0 | 7.0 |
| Sodium Perborate | 0.0 | 9.9 | 0.0 | 0.0 | 0.0 | 0.0 | 0.0 | 0.0 |
| Tetraacetylethylenediamine | 2.2 | 1.7 | 0.0 | 4.7 | 3.6 | 0.0 | 0.0 | 0.8 |
| (TAED) | | | | | | | | |
| Calcium Bentonite | 0.0 | 0.0 | 0.0 | 1.8 | 0.0 | 0.0 | 0.0 | 5.6 |
| Citric acid | 2.0 | 1.5 | 2.0 | 2.0 | 2.5 | 1.0 | 2.5 | 1.0 |
| Protease (84 mg active/g) | 0.14 | 0.12 | 0.0 | 0.12 | 0.09 | 0.08 | 0.10 | 0.08 |
| Amylase (22 mg active/g) | 0.10 | 0.11 | 0.0 | 0.10 | 0.10 | 0.0 | 0.14 | 0.08 |
| Lipase (11 mg active/g) | 0.70 | 0.50 | 0.0 | 0.70 | 0.50 | 0.0 | 0.0 | 0.0 |
| Cellulase (2.3 mg active/g) | 0.0 | 0.0 | 0.0 | 0.0 | 0.0 | 0.0 | 0.18 | 0.0 |
| Microcapsules of | 1.4 | 0.6 | 0.8 | 1.0 | 0.7 | 0.3 | 0.7 | 1.2 |
| Example 1 | | | | | | | | |

| | |
|---|---|
| Water & Miscellaneous | Balance to 100% |

### Examples 11-18

Examples of granular laundry detergent compositions comprising the perfume composition are included below.

| | % w/w of laundry detergent compositions | | | | | | | |
|---|---|---|---|---|---|---|---|---|
| Raw material | 11 | 12 | 13 | 14 | 15 | 16 | 17 | 18 |
| Linear alkyl benzene | 7.1 | 6.7 | 11.0 | 10.6 | 6.9 | 4.5 | 10.1 | 8.9 |
| sulphonate | | | | | | | | |
| Sodium C₁₂₋₁₅ alkyl ethoxy | 3.5 | 0.0 | 1.5 | 0.0 | 0.0 | 0.0 | 0.0 | 1.9 |
| sulphate having a molar | | | | | | | | |
| average degree of | | | | | | | | |
| ethoxylation of 3 | | | | | | | | |
| Acrylic Acid/Maleic Acid | 3.6 | 1.8 | 4.9 | 2.0 | 1.0 | 1.6 | 3.9 | 2.3 |
| Copolymer | | | | | | | | |
| Sodium Alumino Silicate | 4.0 | 0.5 | 0.8 | 1.4 | 16.3 | 0.0 | 17.9 | 2.4 |
| (Zeolite 4A) | | | | | | | | |
| Sodium Tripolyphosphate | 0.0 | 17.5 | 0.0 | 15.8 | 0.0 | 23.3 | 0.0 | 0.0 |
| Sodium Carbonate | 23.2 | 16.8 | 30.2 | 17.3 | 18.4 | 9.0 | 20.8 | 30.0 |
| Sodium Sulphate | 31.4 | 29.4 | 35.5 | 7.2 | 26.3 | 42.8 | 33.2 | 28.3 |
| Sodium Silicate | 0.0 | 4.4 | 0.0 | 4.5 | 0.0 | 6.1 | 0.0 | 4.6 |
| C₁₄₋₁₅ alkyl ethoxylated | 0.4 | 2.6 | 0.8 | 2.5 | 3.1 | 0.3 | 3.8 | 0.4 |
| alcohol having a molar | | | | | | | | |
| average degree of | | | | | | | | |
| ethoxylation of 7 | | | | | | | | |
| Sodium Percarbonate | 16.0 | 0.0 | 8.4 | 20.4 | 13.1 | 3.6 | 0.0 | 7.0 |
| Sodium Perborate | 0.0 | 9.9 | 0.0 | 0.0 | 0.0 | 0.0 | 0.0 | 0.0 |
| Tetraacetylethylenediamine | 2.2 | 1.7 | 0.0 | 4.7 | 3.6 | 0.0 | 0.0 | 0.8 |
| (TAED) | | | | | | | | |
| Calcium Bentonite | 0.0 | 0.0 | 0.0 | 1.8 | 0.0 | 0.0 | 0.0 | 5.6 |
| Citric acid | 2.0 | 1.5 | 2.0 | 2.0 | 2.5 | 1.0 | 2.5 | 1.0 |
| Protease (84 mg active/g) | 0.14 | 0.12 | 0.0 | 0.12 | 0.09 | 0.08 | 0.10 | 0.08 |
| Amylase (22 mg active/g) | 0.10 | 0.11 | 0.0 | 0.10 | 0.10 | 0.0 | 0.14 | 0.08 |
| Lipase (11 mg active/g) | 0.70 | 0.50 | 0.0 | 0.70 | 0.50 | 0.0 | 0.0 | 0.0 |
| Cellulase (2.3 mg active/g) | 0.0 | 0.0 | 0.0 | 0.0 | 0.0 | 0.0 | 0.18 | 0.0 |
| Microcapsules of | 1.4 | 0.6 | 0.8 | 1.0 | 0.7 | 0.3 | 0.7 | 1.2 |
| Example 1 | | | | | | | | |

| | |
|---|---|
| Water & Miscellaneous | Balance to 100% |

The equipment and materials described in Examples 1 through to 18 can be obtained from the following: IKA Werke GmbH & Co. KG, Staufen, Germany; CP Kelco, Atlanta, United States; Forberg International AS, Larvik, Norway; Degussa GmbH, Düsseldorf, Germany; Niro A/S, Soeberg, Denmark; Baker Perkins Ltd, Peterborough, United Kingdom; Nippon Shokubai, Tokyo, Japan; BASF, Ludwigshafen, Germany; Braun, Kronberg, Germany; Industrial Chemicals Limited, Thurrock, United Kingdom; Primex ehf, Siglufjordur, Iceland; ISP World Headquarters; Polysciences, Inc. of Warrington, Pa., United States; Cytec Industries Inc., New Jersey, United States; International Specialty Products, Wayne, N.J., United States; P&G Chemicals Americas, Cincinnati, Ohio, United States; Sigma-Aldrich Corp., St. Louis, Mo., United States, Dow Chemical Company of Midland, Mich., USA

### Examples 18-27

### Fabric Conditioner

Non-limiting examples of fabric conditioners containing the polymer coated perfume microcapsules disclosed in the present specification are summarized in the following table.

| | EXAMPLES | | | | | | | | | |
|---|---|---|---|---|---|---|---|---|---|---|
| (% wt) | 18 | 19 | 20 | 21 | 22 | 23 | 24 | 25 | 26 | 27 |
| FSA ^{a} | 14 | 16.47 | 14 | 12 | 12 | 16.47 | — | — | 5 | 10 |
| FSA ^{b} | | | | | — | | 3.00 | — | — | — |
| FSA ^{c} | | | | | — | | — | 6.5 | — | — |
| Ethanol | 2.18 | 2.57 | 2.18 | 1.95 | 1.95 | 2.57 | — | — | 0.81 | |
| Isopropyl | — | — | — | — | — | — | 0.33 | 1.22 | — | 1.0— |
| Alcohol | | | | | | | | | | |
| Starch ^{d} | 1.25 | 1.47 | 2.00 | 1.25 | — | 2.30 | 0.5 | 0.70 | 0.71 | 0.42 |
| Phase | 0.21 | 0.25 | 0.21 | 0.21 | 0.14 | 0.18 | 0.15 | 0.14 | 0.2 | 0.1 |
| Stabilizing | | | | | | | | | | |
| Polymer ^{f} | | | | | | | | | | |
| Suds | — | — | — | — | — | — | — | 0.1 | — | — |
| Suppressor ^{g} | | | | | | | | | | |
| Calcium | 0.15 | 0.176 | 0.15 | 0.15 | 0.30 | 0.176 | — | 0.1-0.15 | — | 0025. |
| Chloride | | | | | | | | | | |
| DTPA ^{h} | 0.017 | 0.017 | 0.017 | 0.017 | 0.007 | 0.007 | 0.20 | — | 0.002 | 0.002 |
| Preservative | 5 | 5 | 5 | 5 | 5 | 5 | — | 250 ^{j} | 5 | 5 |
| (ppm) ^{i, j} | | | | | | | | | | |
| Antifoam^{k} | 0.015 | 0.018 | 0.015 | 0.015 | 0.015 | 0.015 | — | — | 0.015 | 0.015 |
| Dye | 40 | 40 | 40 | 40 | 40 | 40 | 11 | 30-300 | 30 | 30 |
| (ppm) | | | | | | | | | | |
| Ammonium | 0.100 | 0.118 | 0.100 | 0.100 | 0.115 | 0.115 | — | — | — | — |
| Chloride | | | | | | | | | | |
| HCl | 0.012 | 0.014 | 0.012 | 0.012 | 0.028 | 0.028 | 0.016 | 0.025 | 0.011 | 0.011 |
| Perfume | 0.2 | 0.02 | 0.1 | 0.15 | 0.12 | 0.13 | 0.3 | 0.4 | 0.24 | 0.1 |
| microcapsules as | | | | | | | | | | |
| disclosed in | | | | | | | | | | |
| Example 1 | | | | | | | | | | |
| Additional | 0.8 | 0.7 | 0.9 | 0.5 | 1.2 | 0.5 | 1.1 | 0.6 | 1.0 | 0.9 |
| Neat | | | | | | | | | | |
| Perfume | | | | | | | | | | |
| according to | | | | | | | | | | |
| Table 1 | | | | | | | | | | |
| Deionized | † | † | † | † | † | † | † | † | † | † |
| Water | | | | | | | | | | |

^{a} N,N-di(tallowoyloxyethyl)-N,N-dimethylammonium chloride.
^{b} Methyl bis(tallow amidoethyl)2-hydroxyethyl ammonium methyl sulfate.
^{c} Reaction product of Fatty acid with Methyldiethanolamine in a molar ratio 1.5:1, quaternized with Methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.
^{d} Cationic high amylose maize starch available from National Starch under the trade name CATO ®.
^{f} Rheovis DCE ex BASF.
^{g} SE39 from Wacker
^{h} Diethylenetriaminepentaacetic acid.
ⁱ KATHON ® CG available from Rohm and Haas Co. “PPM” is “parts per million.”
^{j} Gluteraldehyde
^{k}Silicone antifoam agent available from Dow Corning Corp. under the trade name DC2310.
† balance

### Examples 28-33

### Liquid Laundry Formulations (HDLs)

| Ingredient | 28 | 29 | 30 | 31 | 32 | 33 |
|---|---|---|---|---|---|---|
| Alkyl Ether Sulphate | 0.00 | 0.50 | 12.0 | 12.0 | 6.0 | 7.0 |
| Dodecyl Benzene | 8.0 | 8.0 | 1.0 | 1.0 | 2.0 | 3.0 |
| Sulphonic Acid | | | | | | |
| Ethoxylated Alcohol | 8.0 | 6.0 | 5.0 | 7.0 | 5.0 | 3.0 |
| Citric Acid | 5.0 | 3.0 | 3.0 | 5.0 | 2.0 | 3.0 |
| Fatty Acid | 3.0 | 5.0 | 5.0 | 3.0 | 6.0 | 5.0 |
| Ethoxysulfated | 1.9 | 1.2 | 1.5 | 2.0 | 1.0 | 1.0 |
| hexamethylene diamine | | | | | | |
| quaternized | | | | | | |
| Diethylene triamine penta | 0.3 | 0.2 | 0.2 | 0.3 | 0.1 | 0.2 |
| methylene phosphonic acid | | | | | | |
| Enzymes | 1.20 | 0.80 | 0 | 1.2 | 0 | 0.8 |
| Brightener (disulphonated | 0.14 | 0.09 | 0 | 0.14 | 0.01 | 0.09 |
| diamino stilbene based | | | | | | |
| FWA) | | | | | | |
| Cationic hydroxyethyl | 0 | 0 | 0.10 | 0 | 0.200 | 0.30 |
| cellulose | | | | | | |
| Poly(acrylamide-co- | 0 | 0 | 0 | 0.50 | 0.10 | 0 |
| diallyldimethylammonium | | | | | | |
| chloride) | | | | | | |
| Hydrogenated Castor Oil | 0.50 | 0.44 | 0.2 | 0.2 | 0.3 | 0.3 |
| Structurant | | | | | | |
| Boric acid | 2.4 | 1.5 | 1.0 | 2.4 | 1.0 | 1.5 |
| Ethanol | 0.50 | 1.0 | 2.0 | 2.0 | 1.0 | 1.0 |
| 1,2 propanediol | 2.0 | 3.0 | 1.0 | 1.0 | 0.01 | 0.01 |
| Glutaraldehyde | 0 | 0 | 19 ppm | 0 | 13 ppm | 0 |
| Diethyleneglycol (DEG) | 1.6 | 0 | 0 | 0 | 0 | 0 |
| 2,3-Methyl-1,3- | 1.0 | 1.0 | 0 | 0 | 0 | 0 |
| propanediol (M pdiol) | | | | | | |
| Mono Ethanol Amine | 1.0 | 0.5 | 0 | 0 | 0 | 0 |
| NaOH Sufficient To | pH 8 | pH 8 | pH 8 | pH 8 | pH 8 | pH 8 |
| Provide Formulation pH of: | | | | | | |
| Sodium Cumene | 2.00 | 0 | 0 | 0 | 0 | 0 |
| Sulphonate (NaCS) | | | | | | |
| Silicone (PDMS) emulsion | 0.003 | 0.003 | 0.003 | 0.003 | 0.003 | 0.003 |
| Neat Perfume according to | 0.02 | 0.15 | 0.0 | 0.2 | 0.3 | 0.1 |
| Table 1 | | | | | | |
| Perfume microcapsules as | 0.2 | 0.02 | 0.1 | 0.15 | 0.12 | 0.13 |
| disclosed in Example 1 | | | | | | |
| Water | Balance | Balance | Balance | Balance | Balance | Balance |

### Examples 34-41

### Liquid Unit Dose

The following are examples of unit dose executions wherein the liquid composition is enclosed within a PVA film. The preferred film used in the present examples is Monosol M8630 76 μm thickness.

| | D | | | E | | F | | |
|---|---|---|---|---|---|---|---|---|
| | 3 compartments | | | 2 compartments | | 3 compartments | | |
| | Compartment # | | | | | | | |
| | 34 | 35 | 36 | 37 | 38 | 39 | 40 | 41 |
| | Dosage (g) | | | | | | | |
| | 34.0 | 3.5 | 3.5 | 30.0 | 5.0 | 25.0 | 1.5 | 4.0 |
| Ingredients | Weight % | | | | | | | |
| Alkylbenzene sulfonic | 20.0 | 20.0 | 20.0 | 10.0 | 20.0 | 20.0 | 25 | 30 |
| acid | | | | | | | | |
| Alkyl sulfate | | | | 2.0 | | | | |
| C₁₂₋₁₄ alkyl 7- | 17.0 | 17.0 | 17.0 | | 17.0 | 17.0 | 15 | 10 |
| ethoxylate | | | | | | | | |
| C₁₂₋₁₄ alkyl ethoxy 3 | 7.5 | 7.5 | 7.5 | | | 7.5 | 7.5 | |
| sulfate | | | | | | | | |
| Citric acid | 0.5 | | 2.0 | 1.0 | | | | 2.0 |
| Zeolite A | | | | 10.0 | | | | |
| C₁₂₋₁₈ Fatty acid | 13.0 | 13.0 | 13.0 | | 18.0 | 18.0 | 10 | 15 |
| Sodium citrate | | | | 4.0 | 2.5 | | | |
| enzymes | 0-3 | 0-3 | 0-3 | 0-3 | | 0-3 | 0-3 | 0-3 |
| Sodium Percarbonate | | | | 11.0 | | | | |
| TAED | | | | 4.0 | | | | |
| Polycarboxylate | | | | 1.0 | | | | |
| Ethoxylated | 2.2 | 2.2 | 2.2 | | | | | |
| Polyethylenimine¹ | | | | | | | | |
| Hydroxyethane | 0.6 | 0.6 | 0.6 | 0.5 | | | 2.2 | |
| diphosphonic acid | | | | | | | | |
| Ethylene diamine | | | | | | 0.4 | | |
| tetra(methylene | | | | | | | | |
| phosphonic) acid | | | | | | | | |
| Brightener | 0.2 | 0.2 | 0.2 | 0.3 | | 0.3 | | |
| Perfume | 0.4 | 1.2 | 1.5 | 1.3 | 1.3 | 0.4 | 0.12 | 0.2 |
| Microcapsules as | | | | | | | | |
| Example 1 | | | | | | | | |
| Water | 9 | 8.5 | 10 | 5 | 11 | 10 | 10 | 9 |
| CaCl2 | | | | | | | 0.01 | |
| Perfume according to | 1.7 | 1.7 | | 0.6 | | 1.5 | 0.5 | |
| Table 1 | | | | | | | | |
| Minors (antioxidant, | 2.0 | 2.0 | 2.0 | 4.0 | 1.5 | 2.2 | 2.2 | 2.0 |
| sulfite, aesthetics, . . .) | | | | | | | | |

| | |
|---|---|
| Buffers (sodium | To pH 8.0 for liquids |
| carbonate, | To RA > 5.0 for powders |
| monoethanolamine) ³ | |
| Solvents (1,2 | To 100p |
| propanediol, ethanol), | |
| Sulfate | |

Polyethylenimine (MW = 600) with 20 ethoxylate groups per —NH.
³ RA = Reserve Alkalinity (g NaOH/dose)

### Example 42

### Shampoo Formulation

| Ingredient | |
|---|---|
| Ammonium Laureth Sulfate (AE₃S) | 6.00 |
| Ammonium Lauryl Sulfate (ALS) | 10.00 |
| Laureth-4 Alcohol | 0.90 |
| Trihydroxystearin | 0.10 |
| Perfume microcapsules as disclosed | 0.60 |
| in Example 1 | |
| Sodium Chloride | 0.40 |
| Citric Acid | 0.04 |
| Sodium Citrate | 0.40 |
| Sodium Benzoate | 0.25 |
| Ethylene Diamine Tetra Acetic Acid | 0.10 |
| Dimethicone | 1.00 |
| Water and Minors (QS to 100%) | Balance |

### Example 43

Examples of free flowing particles products that comprise perfume and/or microcapsules comprising such perfume are provided below. The table below also exemplifies combinations which comprise also perfume free and in microcapsules or combinations of these with aforementioned combinations with malodor reduction materials and/or compositions. The table also exemplifies compositions having only malodor reduction materials and/or compositions free, in microcapsules and combinations thereof that have little to no fragrance to provide a product that is essentially ‘fragrance free’

| | COMPOSITION | | | |
|---|---|---|---|---|
| | 1 | 2 | 3 | 4 |
| | % Wt | % Wt | % Wt | % Wt |
| Component | Active | Active | Active | Active |
| Polyethylene glycol | 70-99 | 0-20 | 0-29 | 0-40 |
| Clay | 0-29 | 0-20 | 0-20 | 0-10 |
| NaCl | 0-29 | 50-99 | 0-29 | 0-40 |
| Na2SO4 | 0-10 | 0-10 | 0-10 | 0-5 |
| Urea | 0-29 | 0-29 | 0-99 | 0-40 |
| Polysaccharide | 0-29 | 0-29 | 0-29 | 0-5 |
| Zeolite | 0-29 | 0-29 | 0-29 | 0-5 |
| Plasticizers/Solvents | | | | |
| Starch/Zeolite | 0-29 | 0-29 | 0-29 | 0-5 |
| Silica | 0-5 | 0-5 | 0-5 | 0-5 |
| Metal oxide | 0-29 | 0-29 | 0-29 | 0-29 |
| Metal catalyst | 0.001-0.5 | 0.001-0.5 | 0.001-0.5 | 0.001-0.5 |
| Opacifier | 0-5 | 0-5 | 0-1 | 0-1 |
| Water | 0-2 | 0-2 | 0-5 | 0-5 |
| Perfume as provided in Table 1 | 0-5 | 0-5 | 0-5 | 0-5 |
| Microcapsules comprising perfume | 0.001-10 | 0.001-4.5 | 0.001-3 | 0.001-7.5 |
| according to Table 1 | | | | |
| | COMPOSITION | | | |
| | 5 | 6 | 7 | 8 |
| | % Wt | % Wt | % Wt | % Wt |
| Component | Active | Active | Active | Active |
| Polyethylene glycol | 70-99 | 0-20 | 0-29 | 0-40 |
| Clay | 0-29 | 0-20 | 0-20 | 0-10 |
| NaCl | 0-29 | 50-99 | 0-29 | 0-40 |
| Na2SO4 | 0-10 | 0-10 | 0-10 | 0-5 |
| Urea | 0-29 | 0-29 | 0-99 | 0-40 |
| Polysaccharide | 0-29 | 0-29 | 0-29 | 0-5 |
| Zeolite | 0-29 | 0-29 | 0-29 | 0-5 |
| Plasticizers/Solvents | | | | |
| Starch/Zeolite | 0-29 | 0-29 | 0-29 | 0-5 |
| Silica | 0-5 | 0-5 | 0-5 | 0-5 |
| Metal oxide | 0-29 | 0-29 | 0-29 | 0-29 |
| Metal catalyst | 0.001-0.5 | 0.001-0.5 | 0.001-0.5 | 0.001-0.5 |
| Opacifier | 0-5 | 0-5 | 0-1 | 0-1 |
| Water | 0-2 | 0-2 | 0-5 | 0-5 |
| Microcapsules comprising perfume | 0.001-10 | 0.001-4.5 | 0.001-3 | 0.001-7.5 |
| according to Table 1 | | | | |

(1) PEG
(2) Clay
(3) Urea
(4) Polysaccharide, mostly starches, unmodified starches, starch derivatives, acid-modified starch and kappa carrageenan
(5) Zeolite
(6) Starch/Zeolite - SEA
(7) Metal oxides - non-limiting examples - TiO2, ZnO, MnO
(8) Metal catalysts
(9) Opacifier

### Example 44

### Aqueous Composition/Fabric Refresher or Air Freshening Composition

The aqueous composition of the present invention comprises a perfume mixture and an aqueous carrier. The final pH of the aqueous composition herein may be from about 1 to about 11, alternatively from about 3 to about 10, alternatively from about 4 to about 8.

Perfume

The perfume is the perfume as provided in Table 1 of this specification.

Flavorants

In one embodiments, the aqueous composition is substantially free of or free of a flavorant. A flavorant is an edible chemical that is added to food and beverage products to alter the taste of the food or beverage product. Where a perfume mixture is free of a flavorant, the perfume mixture is free of flavorants including perfume materials that are known to be used as flavorants in the food and beverage industry. Having a perfume mixture that is free of flavorants can help provide improved hedonic benefits of the aqueous composition.

Aqueous Carrier

The aqueous composition of the present invention also comprises an aqueous carrier. The aqueous carrier which is used may be distilled, deionized, or tap water. Water may be present in any amount for the composition to be aqueous. In some embodiments, water may be present in an amount of about 70% to about 99.9%, or about 80% to about 99.9%, or about 85% to 99.9%, or about 90% to about 99.5%, or about 92% to about 99.5%, or about 95%, by weight of said aqueous composition.

Optional Ingredients

The aqueous composition may also have less than about 30%, or less than about 10%, or less than about 5%, by weight of the composition, of alcohol. However, the volatile low molecular weight monohydric alcohols such as ethanol and/or isopropanol should be limited since these volatile organic compounds may contribute both to flammability problems and environmental pollution problems. If small amounts of low molecular weight monohydric alcohols (e.g., ethanol, methanol, and isopropanol, or polyols, such as ethylene glycol and propylene glycol) are present in the composition of the present invention due to the addition of these alcohols to such things as perfumes and as stabilizers for some preservatives, the level of monohydric alcohol may be about 1% to about 5%, alternatively less than about 5%, by weight of the aqueous composition.

The aqueous perfume composition of the present invention may be formulated into a fabric refresher or air freshening composition comprising malodor counteractants, particulate controlling polymers, emulsifiers and solubilizing surfactants to solubilize any excess hydrophobic organic materials, particularly any perfume materials. Other emulsifiers, solvents, solubilizers and surfactants as described in U.S. Pat. No. 7,998,403 or in US 2012/0288448A1 can be used to enhance performance of the aqueous composition. A suitable solubilizing surfactant, is a no-foaming or low-foaming surfactant. In one embodiment, the aqueous composition contains ethoxylated hydrogenated castor oil. One suitable hydrogenated castor oil is Basophor™, available from BASF. The solubilizer to perfume ratio in aqueous perfume composition may be about 2:1 or greater than 2:1.

### Example 45

The following hard surface cleaner examples will further illustrate the present invention. The compositions are made by combining the listed ingredients in the listed proportions (weight % unless otherwise specified). The following Examples are meant to exemplify compositions used in a process according to the present invention but are not necessarily used to limit or otherwise define the scope of the present invention.

| | A | B | C | D | E | F | G | H | I |
|---|---|---|---|---|---|---|---|---|---|
| Non ionic | | | | | | | | | |
| C9/11 EO 8 | 6.0 | 6.0 | 7.0 | | | 6.0 | 6.2 | 6.0 | 6.2 |
| C9/11EO 5 | | | | 3.5 | | | | | |
| C12/14 EO21 | | | | 3.5 | | | | | |
| C11 EO 5 | | | | | 7.0 | | | | |
| Anionic | | | | | | | | | |
| NaLAS | 2.00 | 2.25 | 1.8 | | | | 1.80 | 2.25 | 1.80 |
| NAPS | | | | 3.1 | 3.0 | 3.0 | | | |
| C12-14AS | | | | | | | | | |
| NaCS | | | | | | | | | |
| Co | | | | | | | | | |
| surfactants | | | | | | | | | |
| C12-14 AO | 1.50 | 1.25 | 1.50 | 3.9 | 2.0 | | 1.50 | 1.25 | 1.50 |
| C12-14 | | | | | 1.0 | 3.0 | | | |
| Betaine | | | | | | | | | |
| Thickeners | | | | | | | | | |
| HM- | 0.76 | 0.65 | 0.75 | | | | 0.70 | 0.65 | 0.65 |
| polyacrylate | | | | | | | | | |
| HM-HEC | | | | 0.6 | 0.8 | | | | |
| X gum | | | | | | 0.42 | | | |
| Buffer | | | | | | | | | |
| Na2CO3 | 0.77 | 0.4 | 0.75 | 0.1 | 0.3 | 0.2 | 0.75 | 0.4 | 0.75 |
| Citric Acid | 0.046 | 0.3 | 0.3 | 0.75 | 0.75 | 0.3 | 0.3 | 0.3 | 0.30 |
| Caustic | 0.46 | 0.76 | 0.72 | 0.5 | 0.5 | 0.3 | 0.65 | 0.65 | 0.66 |
| Suds control | | | | | | | | | |
| Fatty Acid | 0.40 | 1.0 | 1.0 | 0.20 | 0.50 | 0.50 | 0.40 | 0.40 | 1.0 |
| Branched | | | | | | | | | |
| fatty alcohols | | | | | | | | | |
| Isofol 12 | | 0.2 | 0.1 | 0.2 | 0.3 | 0.5 | | | 0.1 |
| Isofol 16 | | | | | | | | | |
| Chelants | | | | | | | | | |
| DTPMP | | 0.3 | 0.30 | | | 0.2 | | | 0.3 |
| DTPA | 0.25 | | | | | | 0.25 | 0.25 | |
| GLDA | | | | | | | | | |
| Solvents | | | | | | | | | |
| IPA | | | | | | 2.0 | | | |
| n-BPPP | | | | | 2.0 | | | | |
| N-BP | | | | 4.0 | 2.0 | | | 2.0 | |
| Minors and | up to | up to | up to | up to | up to | up to | up to | up to | up to |
| Water | 100% | 100% | 100% | 100% | 100% | 100% | 100% | 100% | 100% |
| pH | 10.6 | 10.5 | 10.3 | 9.5 | 9.0 | 10.0 | 10.3 | 10.3 | 10.3 |

C₉₋₁₁ EO₅ is a C₉₋₁₁ EO₅ nonionic surfactant commercially available from ICI or Shell. C_{12,14} EO₅ is a C_{12, 14} EO₅ nonionic surfactant commercially available from Huls, A&W or Hoechst. C₁₁ EO₅ is a C₁₁ EO₅ nonionic surfactant. C_{12,14} EO₂₁ is a C₁₂₋₁₄ EO₂₁ nonionic surfactant. NaPS is Sodium Paraffin sulphonate commercially available from Huls or Hoechst. NaLAS is Sodium Linear Alkylbenzene sulphonate commercially available from A&W. NaCS is Sodium Cumene sulphonate commercially available from A&W. Isalchem® AS is a C₁₂₋₁₃ sulphate surfactant commercially available from Sasol olefins and surfactants. C₁₂₋₁₄ AO is a C₁₂₋₁₄ amine oxide surfactant. C₁₂₋₁₄ Betaine is a C₁₂₋₁₄ betaine surfactant.

DMPEG is a polyethyleneglycol dimethylether. HM-HEC is a cetylhydroxethylcellulose. Isofol 12® is 2-butyl octanol commercially available from Condea. Isofol 16® is 2-hexyl decanol commercially available from Condea. n-BP is normal butoxy propanol commercially available from Dow Chemicals. IPA is isopropanol.

n-BPP is butoxy propoxy propanol available from Dow Chemicals.

### Example 46

### Hygiene Fragrance Composition and Accords A-D

Example 2 provides a fragrance composition in accordance with the presently disclosed subject matter.

TABLE 2
Hygiene Fragrance Composition

| | | | Parts |
|---|---|---|---|
| Name | Parts/weight | Classification | total |
| ALD C-12 LAURIC | 0.300 | Aldehyde | 2.220 |
| DECENAL, CIS-4 | 0.200 | Aldehyde | |
| DECENAL, TRANS-2, | 0.020 | Aldehyde | |
| MANDARIN ALD 10% TEC | 2.000 | Aldehyde | |
| CYMENE, P, | 15.000 | Citrus | 631.400 |
| LEMON OIL TERPENES WHITE | 7.000 | Citrus | |
| LIMONENE THIOL 1% TEC 10% TEC | 1.000 | Citrus | |
| LINALOOL OXIDE | 0.070 | Citrus | |
| ORANGE OIL PERA BRAZIL | 400.000 | Citrus | |
| ORANGE OIL TERPENES WHITE | 200.000 | Citrus | |
| OXANE 969380/TEC 50% | 0.300 | Citrus | |
| RHUBAFURAN | 0.300 | Citrus | |
| RINGONOL 50 TEC | 0.200 | Citrus | |
| TERPINOLENE 20 | 3.500 | Citrus | |
| THIOGERANIOL | 0.003 | Citrus | |
| THYMOL CRYST | 4.000 | Citrus | |
| CITRONELLYL ACET | 1.500 | Floral | 8.940 |
| DIMETH ANTH | 7.000 | Floral | |
| EUGENOL | 0.150 | Floral | |
| INDOLE CRYST | 0.002 | Floral | |
| METH ANTH | 0.007 | Floral | |
| METH JASMONATE | 0.200 | Floral | |
| DYNASCONE NEAT 939.745 | 0.150 | Green | 15.353 |
| GALBANUM OIL A NAT | 0.003 | Green | |
| HEXEN-1-OL, CIS-3, | 15.000 | Green | |
| HEXENAL, TRANS-2, | 0.200 | Green | |
| PERILLA ALD | 2.000 | Herbal | 73.000 |
| PHELLANDRENE, ALPHA | 1.000 | Herbal | |
| LINALOOL SYN | 70.000 | Herbal | |
| DIPROPYLENE GLYCOL | 252.398 | Dilution | 268.895 |
| TRIETHYL CITRATE | 16.497 | Dilution | |
| Total WO Dilutions | 731.105 | | 731.105 |
| Total | 1000.000 | | 1000.000 |

The above hygiene composition provides perception of hygiene when used in consumer products.

The hygiene composition was further investigated, and it was discovered that at least four separate accords (Accords A-D) could be formulated from the hygiene composition. These accords are described in Table 3.

TABLE 3
Accord compositions in units of percent quantity of total.

| | ACCORD A | ACCORD B | ACCORD C | ACCORD D |
|---|---|---|---|---|
| ALD C-12 LAURIC @ 10% IN DPG | | 1.5 | | 2.5 |
| CITRONELLYL ACET | | | | 7.5 |
| CYMENE, P, | 3.75 | | 3.846 | 1.25 |
| DECENAL, CIS-4 @ 10% IN DPG | 0.5 | 1 | 0.513 | 1 |
| DECENAL, TRANS-2, @ 1% IN DPG | 0.5 | 1 | 1.026 | 1 |
| DIMETH ANTH | | 3.5 | | 1.5 |
| DIPROPYLENE GLYCOL | 17 | 30 | 26.41 | 40.5 |
| DYNASCONE NEAT 939.745 @ 10% IN DPG | 0.375 | 0.75 | 0.513 | 0.25 |
| EUGENOL @ 10% IN DPG | 0.375 | | 1.282 | 2.5 |
| GALBANUM NAT EO @ 1% IN DPG | 0.75 | 1.5 | 5.128 | 2.5 |
| HEXEN-1-OL, CIS-3, | 3.75 | 7.5 | 3.846 | 1 |
| HEXENAL, TRANS-2, @ 10% IN DPG | 0.5 | 1 | 0.513 | 0.5 |
| INDOLE CRYST @ 0.1% IN DPG | | 1 | | 1 |
| LIMONENE THIOL 1% TEC @ 10% TEC | 0.25 | | 0.256 | 0.25 |
| LINALOOL SYN | 17.5 | 35 | 25.641 | 20 |
| MANDARIN ALD 10% TEC | 0.5 | 1 | 0.256 | 0.5 |
| METH ANTH @ 0.1% IN DPG | | 3.5 | | |
| METH JASMONATE @ 10% IN DPG | | 1 | | 0.5 |
| ORANGE PERA BRAZIL NAT EO | 50 | | 12.821 | 5 |
| ORANGE WHITE TERPENES NAT EO | | | 12.821 | 7.5 |
| OXANE 969380 @ 10% IN TEC | 0.75 | 1.5 | 0.513 | 0.5 |
| PERILLA ALD | 0.5 | 1 | 0.256 | 0.25 |
| PHELLANDRENE, ALPHA | | 0.5 | 0.513 | 0.25 |
| RHUBAFURAN @ 10% IN DPG | 0.75 | 1.5 | 0.513 | 0.5 |
| RINGONOL 50 @ 10% IN TEC | 0.5 | 1 | 0.513 | 0.5 |
| TERPINOLENE 20 | | 1.75 | 1.026 | |
| THIOGERANIOL @ 0.1% IN TEC | 0.75 | 1.5 | 0.769 | 0.75 |
| THYMOL CRYST | 1 | 2 | 1.026 | 0.5 |

The accords can also be used alone and/or in combination with consumer products to provide perception of hygiene in a consumer.

### Example 47

### Hygiene Fragrances Formulations

Example 47 provides the compositions of fragrance compositions (Fragrances 1-6) which comprise each of Accords A-D as described in Example 46 and an additional fragrance (Fragrance F). The additional fragrance can be described as a Floral-Green-Fruity accord.

The compositions are formulated as described in Table 3.

TABLE 4
Fragrances 1-6.

| | |
|---|---|
| Fragrance 1: | 0.5% dipropylene glycol; Accord A and Fragrance F |
| | in a ratio of 6:4. |
| Fragrance 2: | 0.5% dipropylene glycol; Accord B and Fragrance F |
| | in a ratio of 8:2. |
| Fragrance 3: | 0.5% dipropylene glycol; Accord C and Fragrance F |
| | in a ratio of 7:3. |
| Fragrance 4: | 0.5% dipropylene glycol; Accord D and Fragrance F |
| | in a ratio of 6:4. |
| Fragrance 5: | 0.8% dipropylene glycol; Accord A and Fragrance F |
| | in a ratio of 6:4. |
| Fragrance 6: | 0.5% dipropylene glycol; Fragrance F (control). |

### Example 48

### Consumer Products Containing Hygiene Fragrances

Example 48 provides non-limiting formulation examples of consumer products containing hygiene fragrances. The hygiene composition of Example 46 or one or more of the accords of Example 46 can be used to create the hygiene composition in the following tables.

Table 5 provides a formulation for a hard surface cleaner pump spray. In a suitable vessel, the different ingredients are mixed until completely uniform and clear. With constant agitation, water is slowly added to the clear solution. Preservative is added with stirring after the water. The formulation can then be filled into suitable containers.

TABLE 5

| Ingredient | Percentage | Purpose |
|---|---|---|
| Neodol 91-8 | 4.0 | Surfactant |
| Dowanol DPnB | 4.0 | Solvent |
| Hygiene Composition | 1.0 | Fragrance |
| Kathon CG | 0.07 | Preservative |
| D.I. Water | 90.93 | Solvent |

Table 6 provides a formulation for a water-based aerosol air freshener. This product is considered a 3-stage fill. The mixing is not complete until the aerosol formulation is complete in the container. In a suitable vessel, the Witconol and fragrance is mixed until completely uniform and clear. Separately, the sodium nitrite is dissolved in the water. The formulation is then filled into aerosol cans as separate phases. The fragrance phase is filled first. The water phase is filled second. The can is then crimped and the propellant is pressure filled through the valve. The can is then shaken to complete the W/O emulsion. This formulation meets the VOC requirements of 30% VOCs for aerosol air fresheners. The can should be an epoxy-lined tinplate can. The valve used on this product must be specified for a water-based, fine spray and with a vapor tap. While there are many suitable combinations, an 0.018 stem with an 0.050 capillary dip tube and an 0.013 vapor tap is acceptable. A mechanical break-up actuator with an 0.018 orifice or spray-thru overcap will provide an acceptable spray.

TABLE 6

| Ingredient | Percentage | Purpose |
|---|---|---|
| Witconol 14 | 1.00 | w/o Frag |
| | | Emulsifier |
| Hygiene | 0.50 | Fragrance |
| Composition | | |
| D.I. Water | 69.45 | Solvent |
| Sodium Nitrite | 0.05 | Corrosion |
| | | Inhibitor |
| Hydrocarbon | 29.00 | Propellant |
| Propellant A-46 | | |

Table 7 provides a formulation for a liquid laundry detergent. Water is heated to 65° C. Glucopon is added and is mixed at medium speed until clear. Standapol is added and is mixed until clear and homogenous. The mixture is removed from heat, and the remaining ingredients are added in order, mixing at slow to medium speed for each addition. pH is adjusted with sulfuric acid solution to pH of 8.0 to 8.5. Viscosity is adjusted with sodium chloride.

TABLE 7

| Ingredient | INCI | Percentage |
|---|---|---|
| Water | Water | Q.S. |
| Glucopon 625UP (1) | Alkyl Polyglucosides | 12.50 |
| Standapol ES-40 (1) | Alkyl Ether Sulfates | 25.60 |
| Versene 100 (38%) (2) | Tetrasodium EDTA | 00.40 |
| MEA (2) | Monoethanolamine | 01.00 |
| Sulfuric Acid (25% Aq.) | Acid | 03.00 |
| Sodium Chloride (25%) | Salt | 01.20 |
| Hygiene composition | Fragrance | 00.75 |

Table 8 provides a formulation for a fabric deodorizer. In a suitable vessel, Alcohol SD-40B, Tergitol, DPG, PG and fragrance are mixed until completely uniform and clear. With constant agitation, water is slowly added to the solution. With agitation, Kathon is added. The final formulation should be clear. The formulation can be then filled into suitable plastic containers (PET preferred), with the proper trigger or pump closure.

TABLE 8

| Ingredient | Percentage | Purpose |
|---|---|---|
| Tergitol 15-S-9 | 15.00 | Emulsifier |
| DPG | 12.00 | Solvent |
| Propylene Glycol | 6.00 | Solvent |
| Alcohol SD 40B | 6.00 | Solvent |
| Hygiene | 5.00 | Fragrance |
| Composition | | |
| D.I. Water | 55.92 | Solvent |
| Kathon CG | 0.08 | Preservative |

Table 9 provides a formulation for a clear liquid hand soap. DI water is heated to 65° C. and Methyl Paraben is slowly added, mixing together at medium/high speed using an overhead mixer until completely into solution and clear. (Seq.#1) Seq. #2 is added to Sequence #1 at low speed until completely clear. Seq. #3 is added to batch without heating, in order of addition, and cooled down to 35° C. with low agitation. Seq. #4 is premixed until clear, and added to batch. Seq. #5 is added to batch with low agitation, cooling down to 25° C. Seq. #6 is added to adjust batch to desired pH. The product is jarred up, pouring very slowly onto the sides of the jars to eliminate any additional aeration.

TABLE 9

| SEQ. | INGREDIENTS | | INCI | PERCENT |
|---|---|---|---|---|
| 1 | Deionized water | | Water | 66.50 |
| 1 | Methyl Paraben | (1) | Methyl Paraben | 00.25 |
| 2 | Liponic EG-1 | (2) | Glycereth-26 | 01.00 |
| 2 | Glycerin | (3) | Glycerin | 01.00 |
| 2 | Lipopeg 6000DS | (2) | PEG-150 Distearate | 00.50 |
| 3 | Monamid 716 | (4) | Lauramide DEA | 03.50 |
| 3 | Standapol ES-2 | (3) | Sodium Laureth | 25.00 |
| | | | Sulfate | |
| 3 | Velvetex BK-35 | (3) | Cocamidopropyl | 15.00 |
| | | | Betaine | |
| 4 | Deionized Water | | Water | 01.00 |
| 4 | Unicide U-13 | (2) | Imidazolidinyl Urea | 00.25 |
| 5 | Hygiene Composition | | | 00.50 |
| 6 | Citric acid (25% Sol'n) | | | QS |

Table 10 provides a formulation for auto dish wash detergent. In a suitable vessel, TKPP and Kasil 1 is dissolved in water until uniform. The remainder of the ingredients are slowly added in the order given with constant agitation. The formulation should be a clear liquid.

TABLE 10

| Ingredient | Percentage |
|---|---|
| TKPP Tetrapotassium | 33.30 |
| Pyrophosphate, 60% | |
| KASIL 1 Potassium Silicate | 20.00 |
| Sodium Hypochlorite (15%) | 8.00 |
| Bio-terge PAS-8S | 3.00 |
| Sodium Hydroxide 50% | 1.00 |
| solution | |
| Hygeien Composition | 0.50 |
| D.I. Water | q.s. |

The appearance of the detergent is clear liquid. The pH is 12.0. This detergent has low viscosity and can be used in dishwashing machines at a concentration of 2 to 4 oz/gal.

### Example 49

### Testing of Odorants with Photographs

Example 49 provides the results from a study that tested the compositions of the presently disclosed subject matter.

30 female participants ranging in ages 21 to 55 were included in this study. The participants were also the primary dish washer in their homes. Each participant was shown various photographs of home kitchens, and each participant was exposed to a series of odors (separated by air). Upon exposure to a specific odor, the participants scored the photographs on a 9-point scale for different attributes.

There were five test odors (#1-#5). Odor 1 was a hygiene composition with a fougere fragrance. Odor 2 was a hygiene composition with a citrus fragrance. Odor 3 was a hygiene composition with a citrus green fragrance. Odor 4 was a lemon oil control fragrance. Odor 5 was simply air.

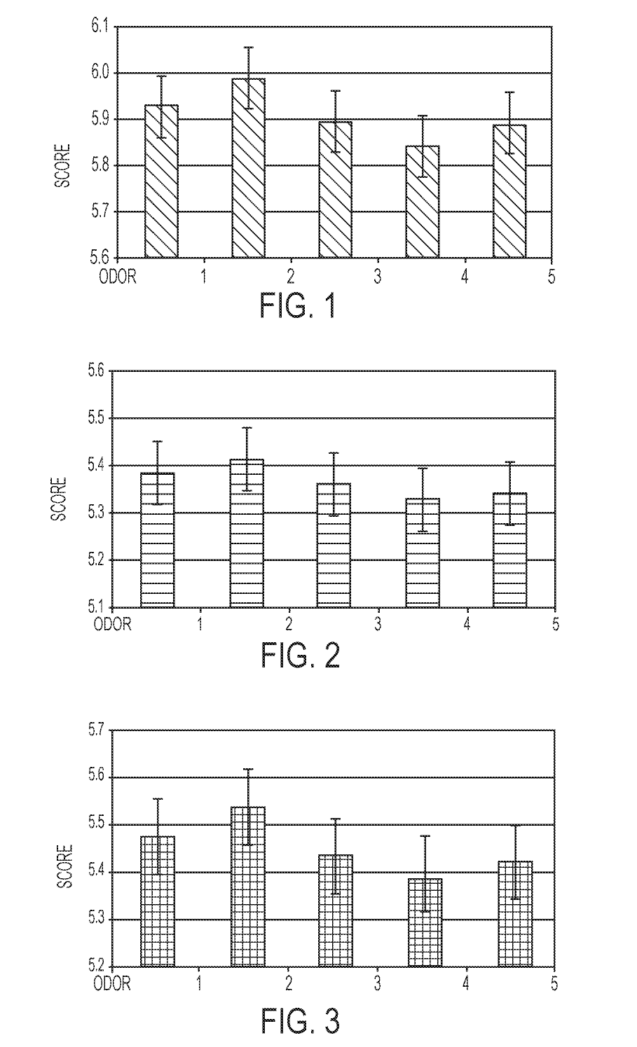

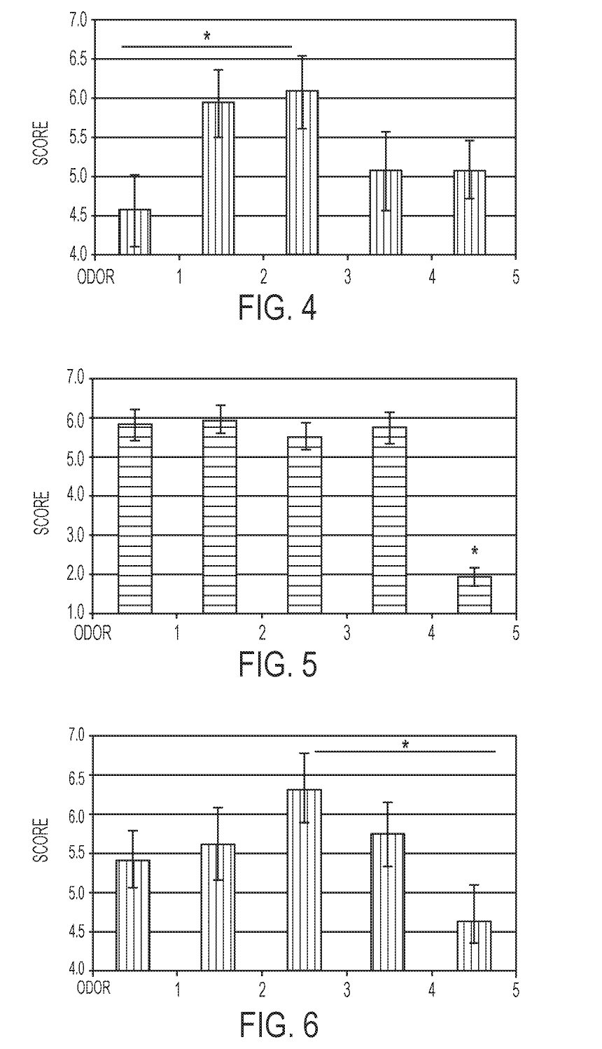

There were three attributes that were assessed: germ removal, germ kill and clean. Results of the scoring are shown in FIGS. 1-3. Participants were then asked to self-report their impressions of hedonicity, intensity, and cleanliness of each odor on the same scale. Results of the self-reporting are shown in FIGS. 4-6.

The results showed that Odor 2 had the highest score for all attributes. Odor 3 had the best overall self-reporting scores. Germ kill assessments were lower than germ removal.

### Example 50

### Impact of Odors on Varying Attributes

Example 51 demonstrates how different specific odors affect different measurable attributes. Participants were shown photographs of home kitchens and home bathrooms (including bathroom surfaces and toilets). Participants were exposed to the different odors and were asked to assess attributes on a numerical scale. The different odors were floral, citrus, aromatic, fougere, rosemary and control air. The different attributes measured were sanitized/hygienic, clean, and proud/pleasing (to invite friends).

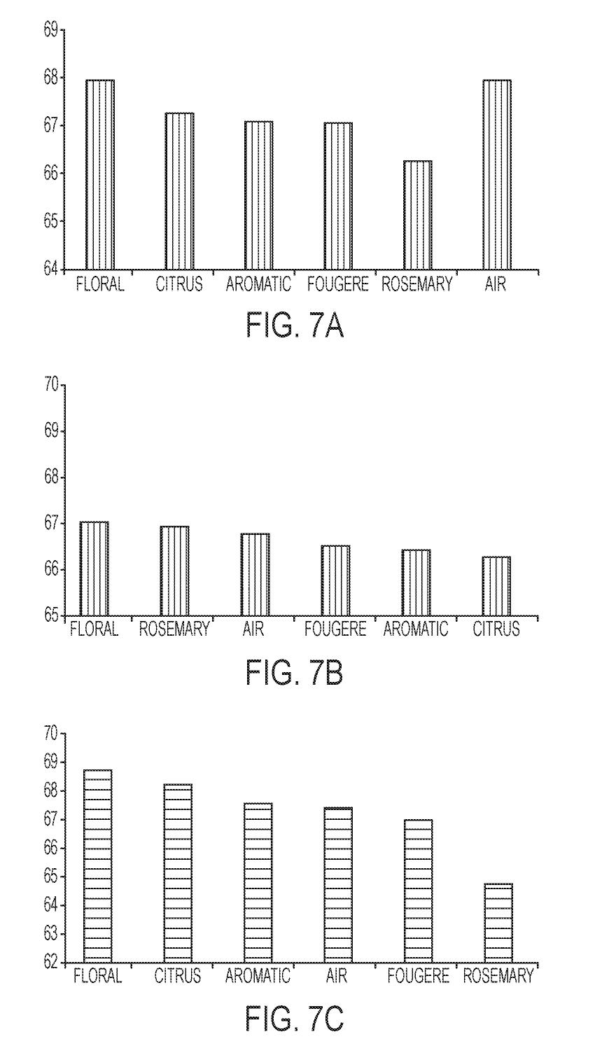

Results of the assessments are shown in FIGS. 7A-7C. The data show that there is a difference in the hygienic clean judgment between the olfactive directions. The floral direction enhanced the perception of the hygiene of all rooms compared to rosemary and air. The citrus direction enhanced the perception of the hygiene of all rooms compared to air. There was no different in the cleanliness dimension. Differences were obtained regarding the complex proud/pleasing dimension. The floral direction enhanced the perception of the proud dimension of all rooms compared to rosemary and fougere. The other directions and air enhanced the perception of the hygiene of all rooms compared to rosemary.

### Example 51

### Impact of Odors on Varying Attributes

Example 51 is a repeated study of Example 50, with minor revisions to duration of experiments with further balancing of strength and intensity perception across odorants. Participants were shown photographs of home kitchens and home bathrooms (including bathroom surfaces and toilets). The same odorants from Example 50 were used.

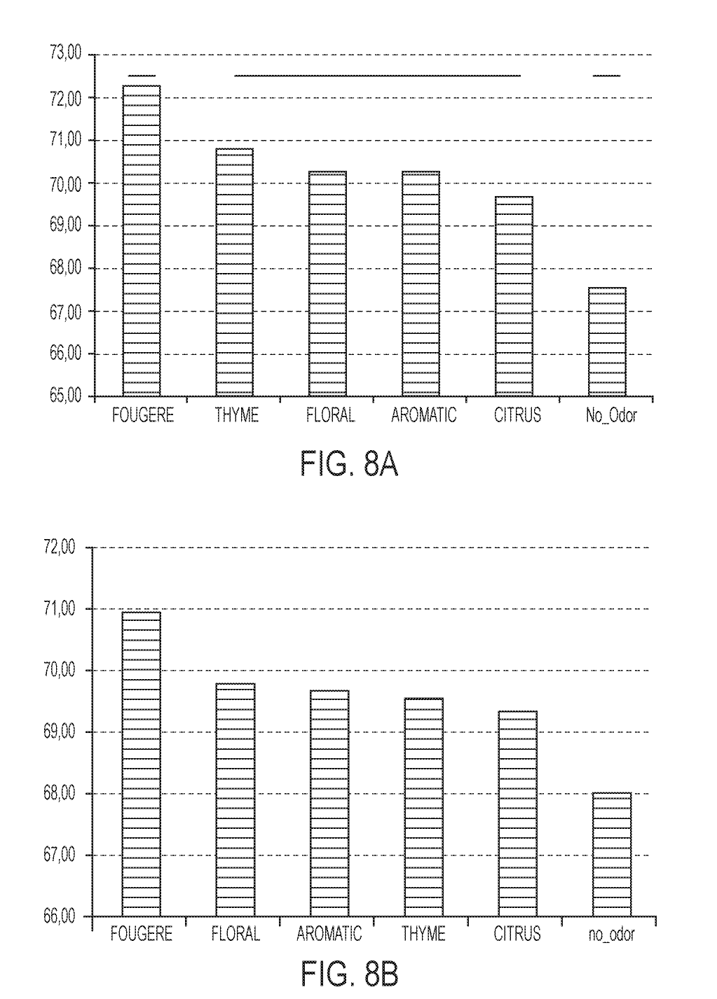

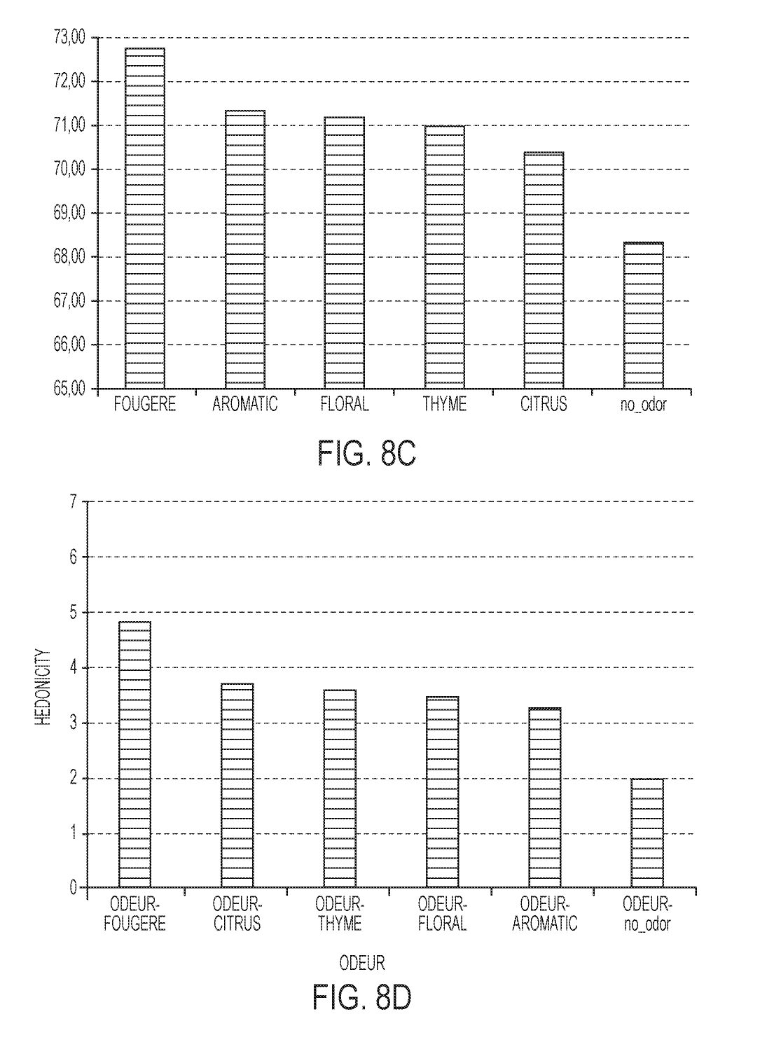

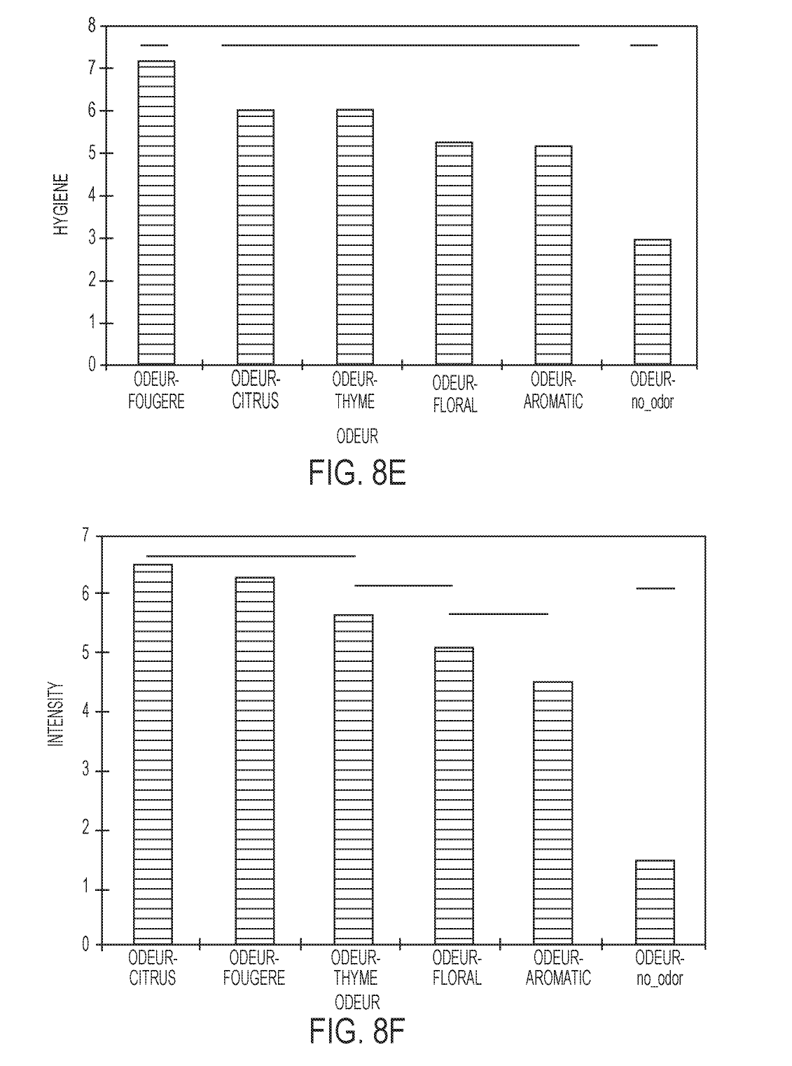

Results are shown in FIGS. 8A-8F. In FIG. 8A, the data show a very strong effect of the odorant on the hygienic variable. A key difference was that the fougere odor had the largest impact on hygiene perception. The other odorants improve the hygiene dimension compared to no odor. In FIG. 8B, the data showed a good effect on the odorants on the cleanliness dimension. In FIG. 8C, the data showed a similar strong effect of the odorant on the proud variable. The fougere odor improved the hygiene perception compared to thyme, citrus, and the blank air samples. The other odorants improved the hygiene dimension compared to the blank air. FIGS. 8D-8F show the self-reporting data for the odors based on hedonicity, hygiene and intensity.

### Example 52

### Testing of Odorants with Photographs

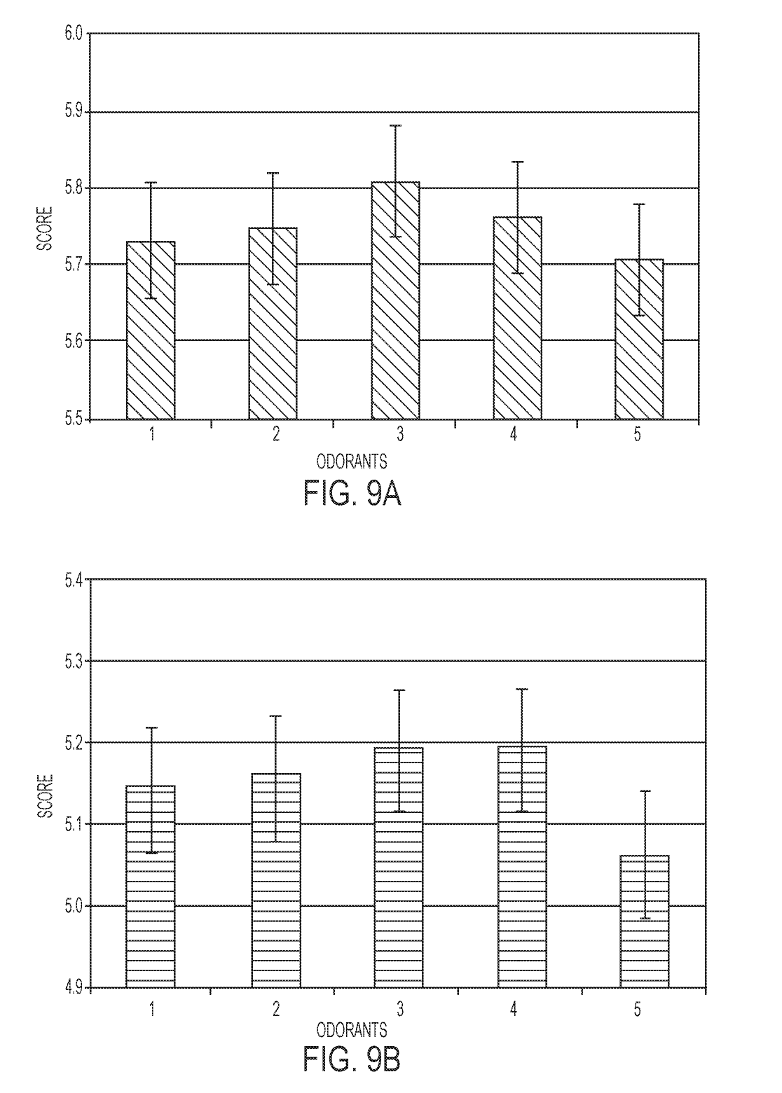

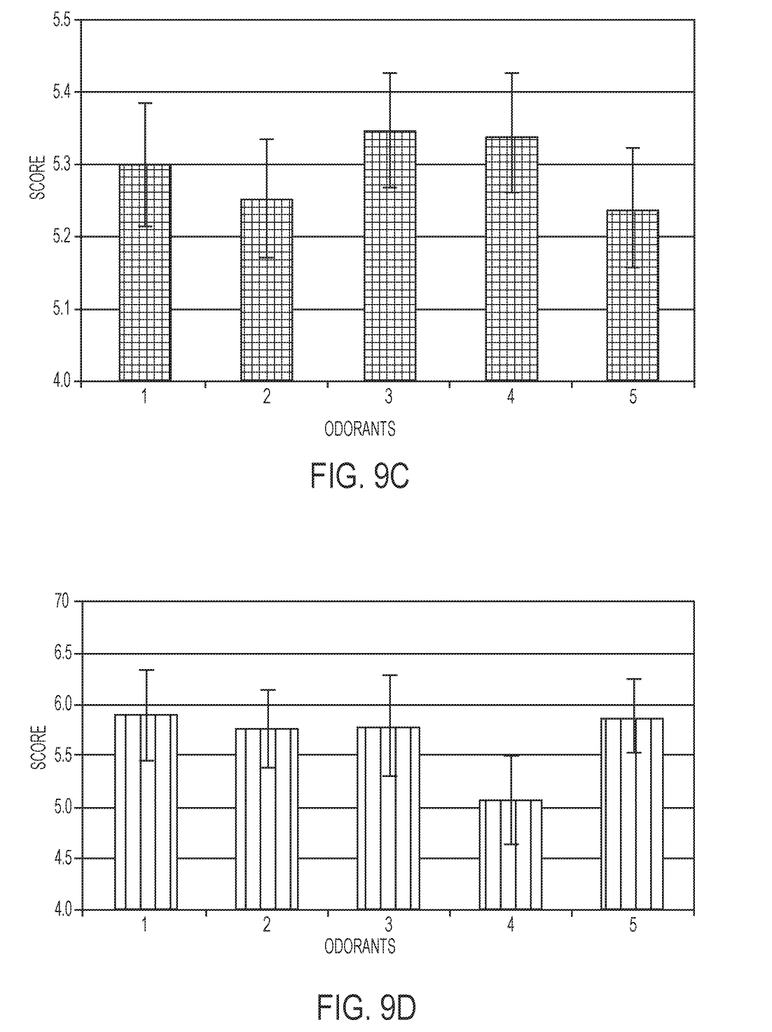

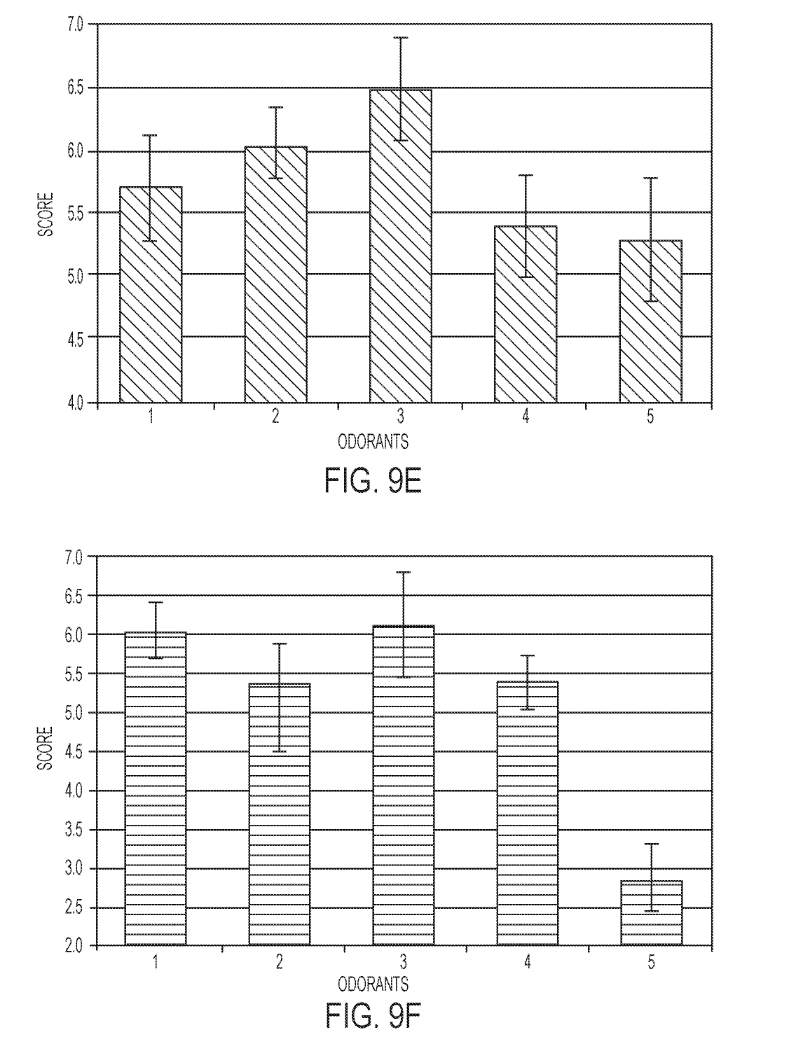

Example 52 follows the testing parameters of Example 49. Each participant was shown various photographs of home kitchens. Results are shown in FIGS. 9A-9F. In FIG. 9A, the data show the results for germ removal. In FIG. 9B, the data showed overall lower scores for germ kill. Odorants 3 and 4 show higher scores for germ kill. In FIG. 9C, the data showed that Odorants 3 and 4 were directionally higher for cleanliness. FIGS. 9D-9F show the self-reporting data for the odorants based on hedonicity, hygiene and intensity.

### Example 53

### Testing of Odorants with Photographs

Example 53 provides the results from a study that tested the compositions of the presently disclosed subject matter.

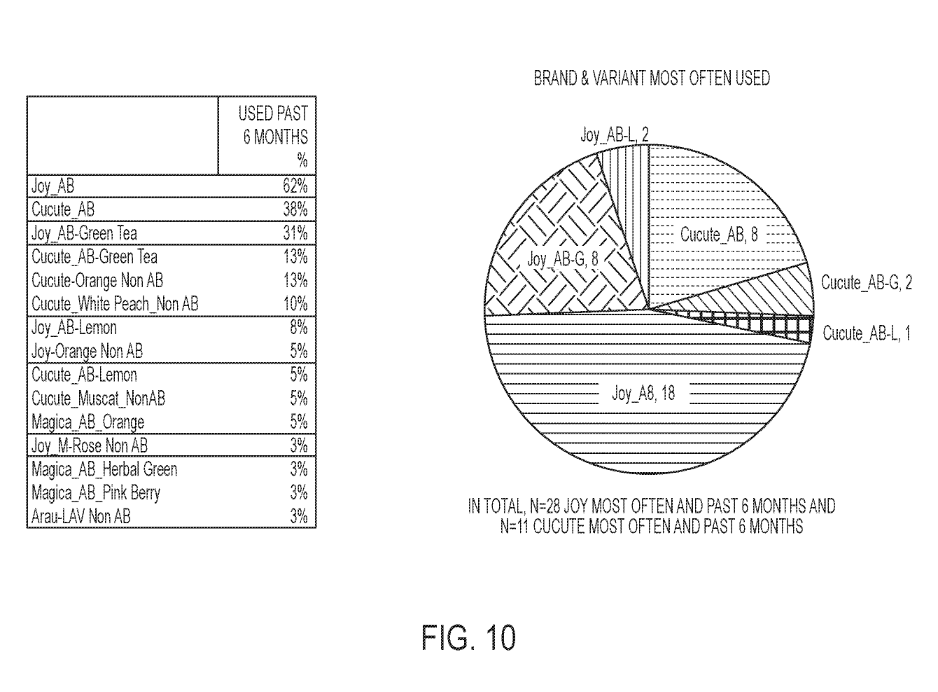

39 female participants ranging in ages 25 to 54 were included in this study. The participants were also the primary dish washer in their homes. Each participant was shown various photographs of home kitchens, and each participant was exposed to a series of odors (separated by air). Upon exposure to a specific odor, the participants scored the photographs on a 9-point scale for different attributes. Participant cleansing brand use history over the past 6 months is shown in FIG. 10.

There were three test odors (#1-#3). Odor 1 was a hygiene composition with a citrus green fragrance. Odor 2 was a lemon oil control fragrance. Odor 3 was simply air (control blank).

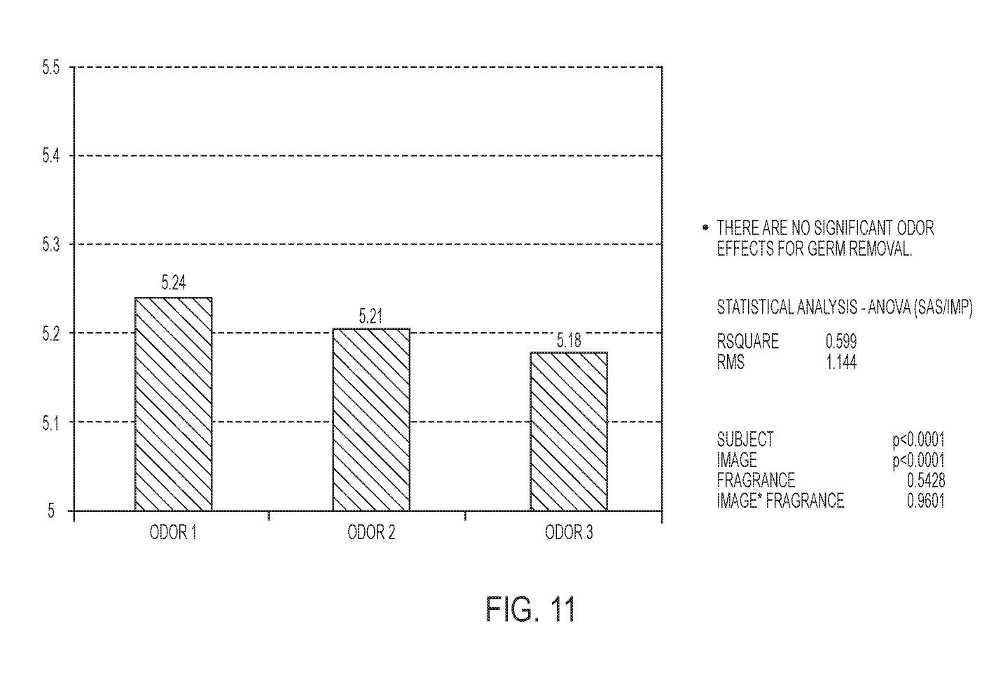

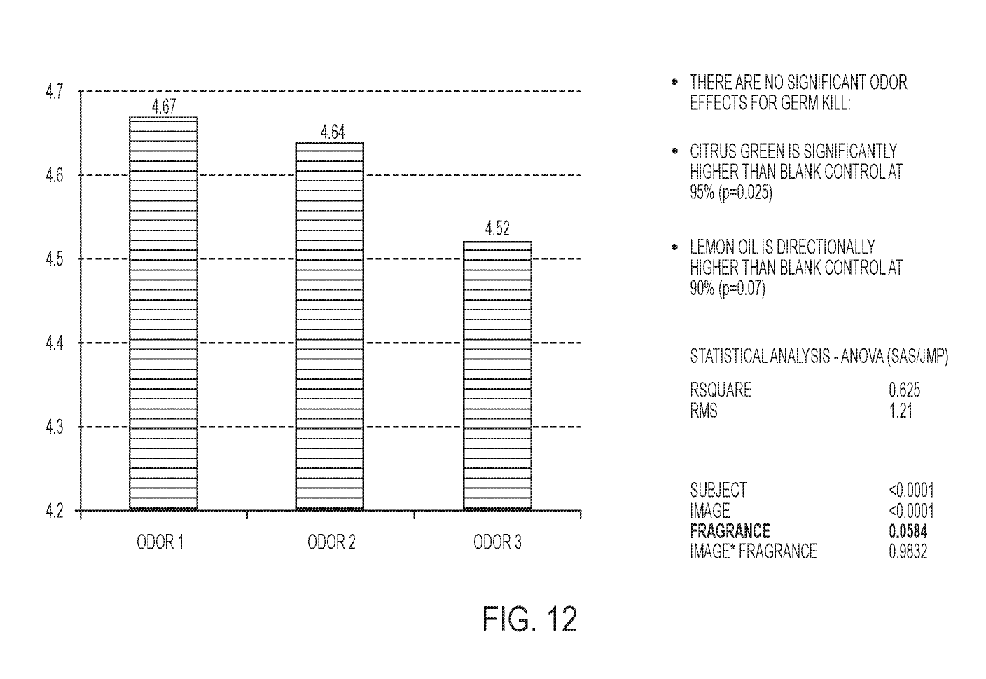

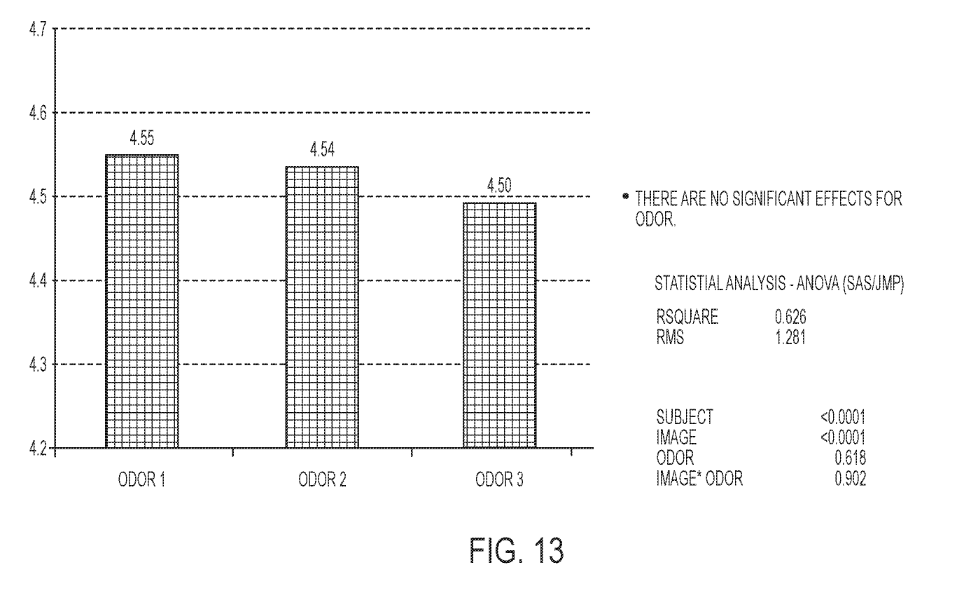

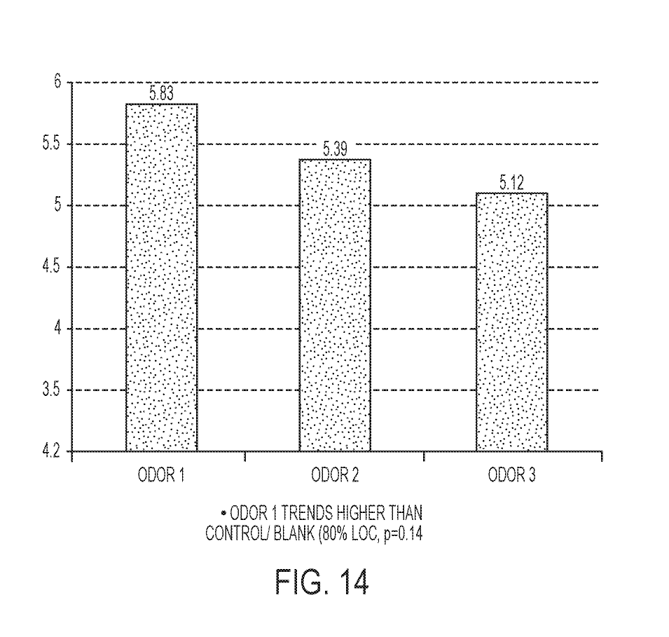

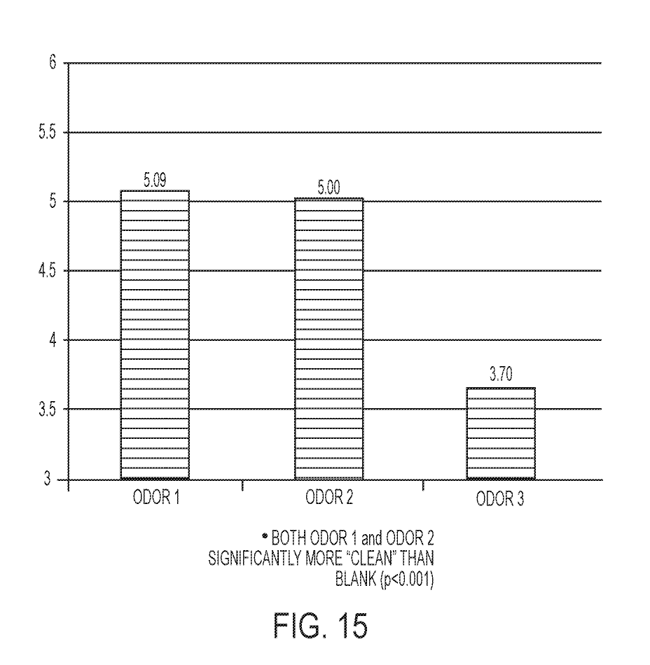

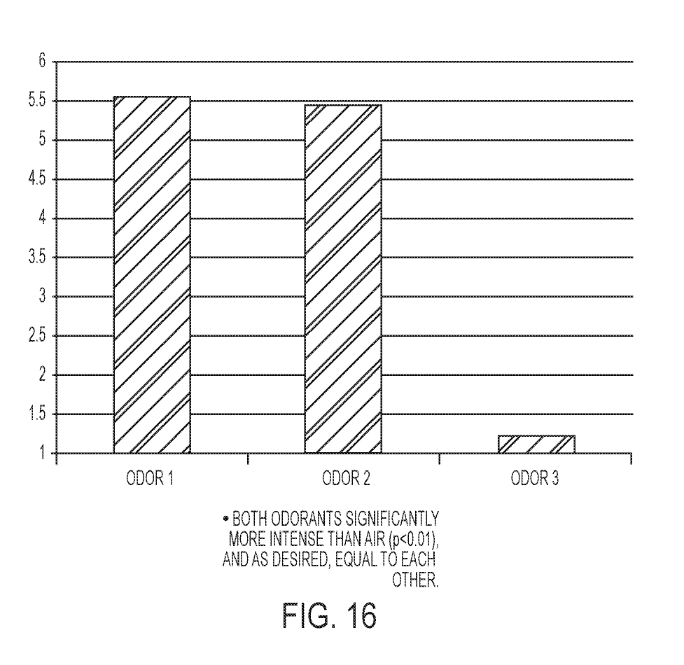

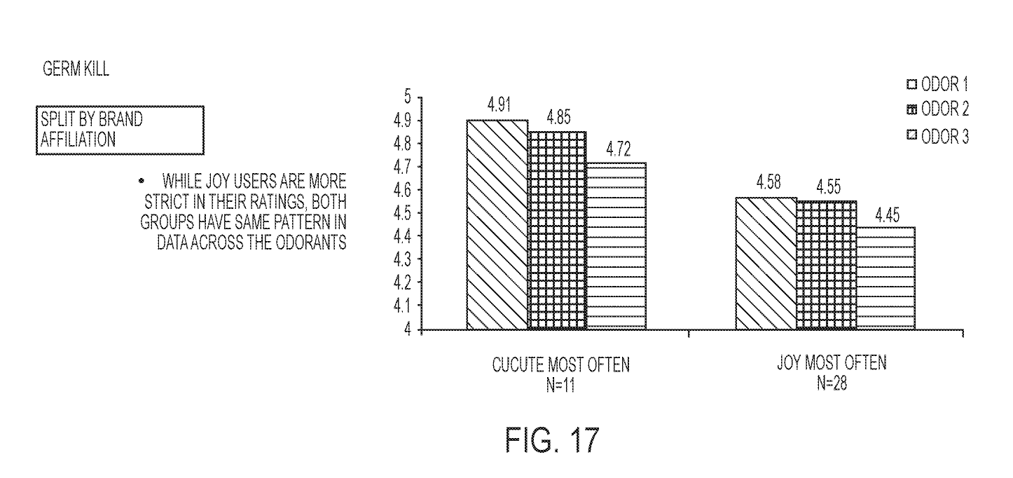

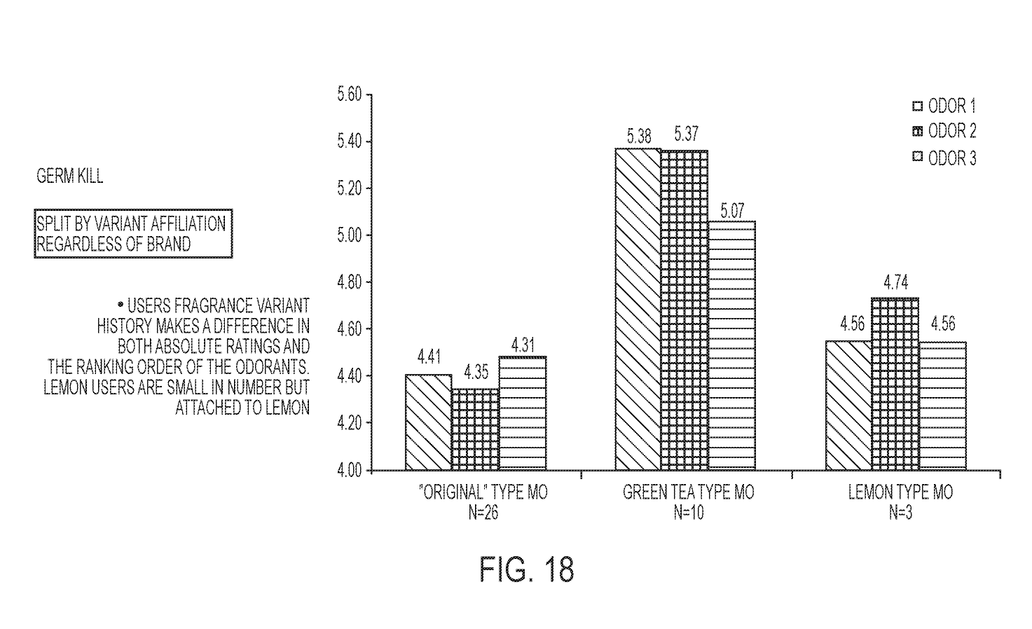

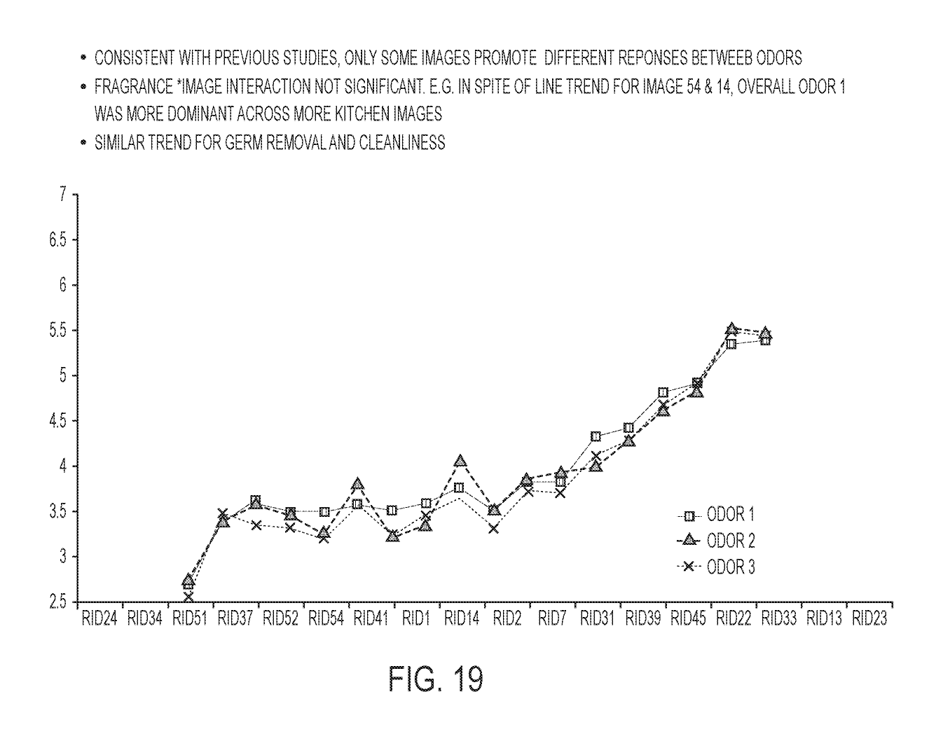

There were three attributes that were assessed: germ removal, germ kill and clean. Results of the scoring are shown in FIGS. 11-13. Participants were then asked to self-report their impressions of hedonicity, intensity, and cleanliness of each odor on the same scale. Results of the self-reporting are shown in FIGS. 14-16. Assessment of germ kill by participant cleansing brand use history and cleansing fragrance use history is shown in FIGS. 17-8. Assessment of germ kill for each of the kitchen images is shown in FIG. 19.

The results showed that Odor 1 and Odor 2 had similar scores that were higher than air across all attributes. Germ kill assessments were lower than germ removal. Previous brand usage history impacts results of attribute assessment.

### Example 54

### Consumer Testing

Example 54 provides the results from a study that tested the compositions of the presently disclosed subject matter. In particular, the study was to identify the portion(s) of the fragrance most responsible for cuing efficacy and hygiene.

60 female participants ranging in ages 18 to 55 were included in this study. The participants were also the primary dish washer in their homes. Each participant stated that “antibacterial” is an important quality in the choice of their dish washing product. Half of the users use Brand Product A most often over the past six months, and the other half used Brand Product B the most over the past six months. Each participant was presented four odor accords (randomized) and six finished products with different amounts of the odor accords (randomized). Upon exposure to a specific odor, the participants scored the odor on whether or not it embodied a particular attribute or fragrance. Participants also scored the scents on a 9-point scale for certain attributes.

There were ten odors (#1-#10). Odor 1 was Accord 1 (citrus green fragrance). Odor 2 was Accord 2 (floral fragrance). Odor 3 was Accord 3 (herbal green rebalance fragrance). Odor 4 was Accord 4 (floral aldehyde rebalance fragrance). Odor 5 was a floral fragrance with control odor. Odor 6 was a floral fragrance with Accord 1 at a ratio of 6:4. Odor 7 was a floral fragrance with Accord 1 at a higher level. Odor 8 was a floral fragrance with Accord 2 at a ratio of 8:2. Odor 9 was a floral fragrance with Accord 3 at a ratio of 7:3. Odor 10 was a floral fragrance with Accord 4 at a ratio of 6:4.

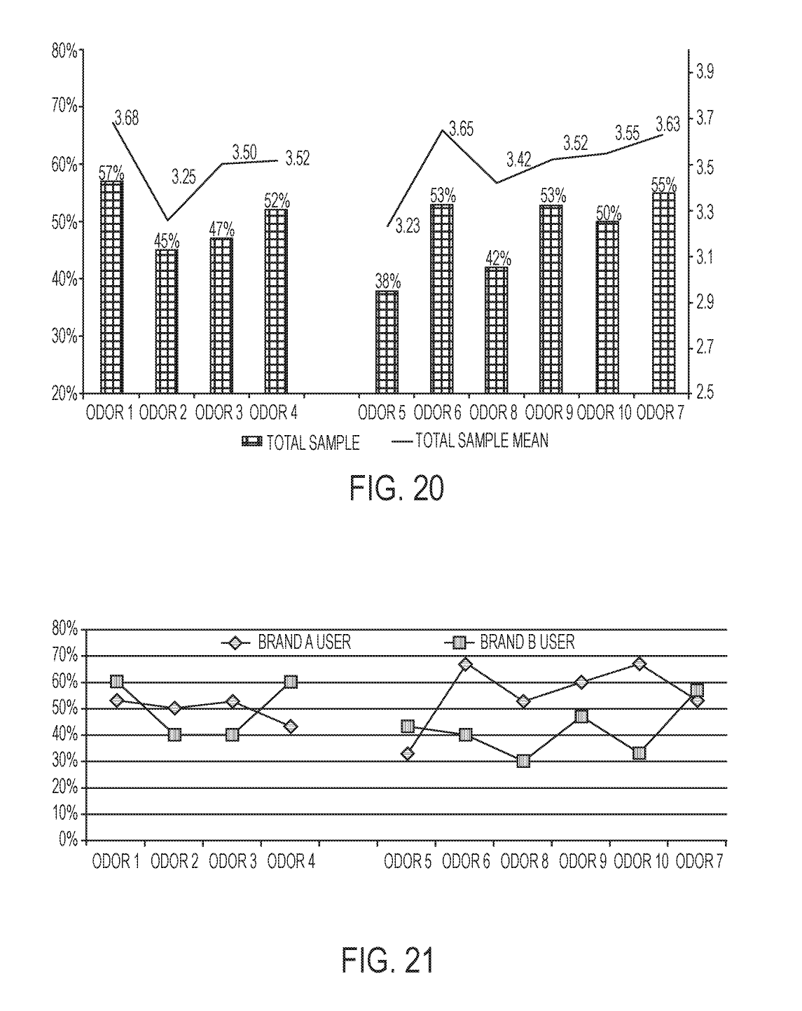

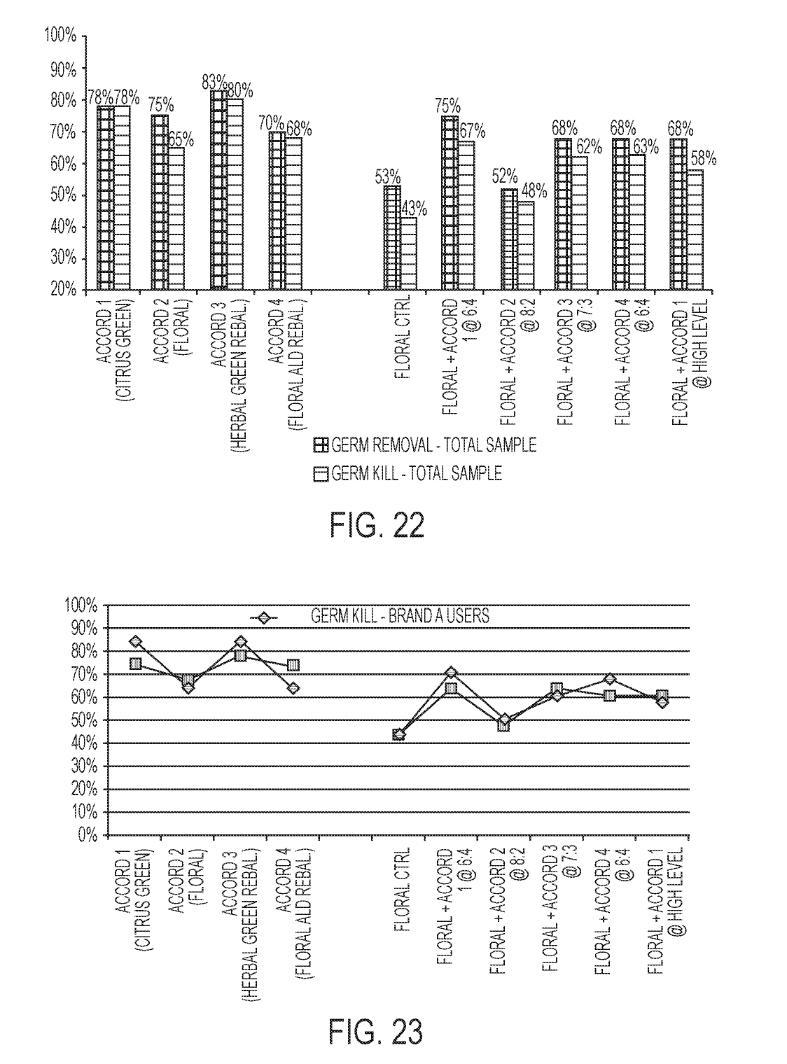

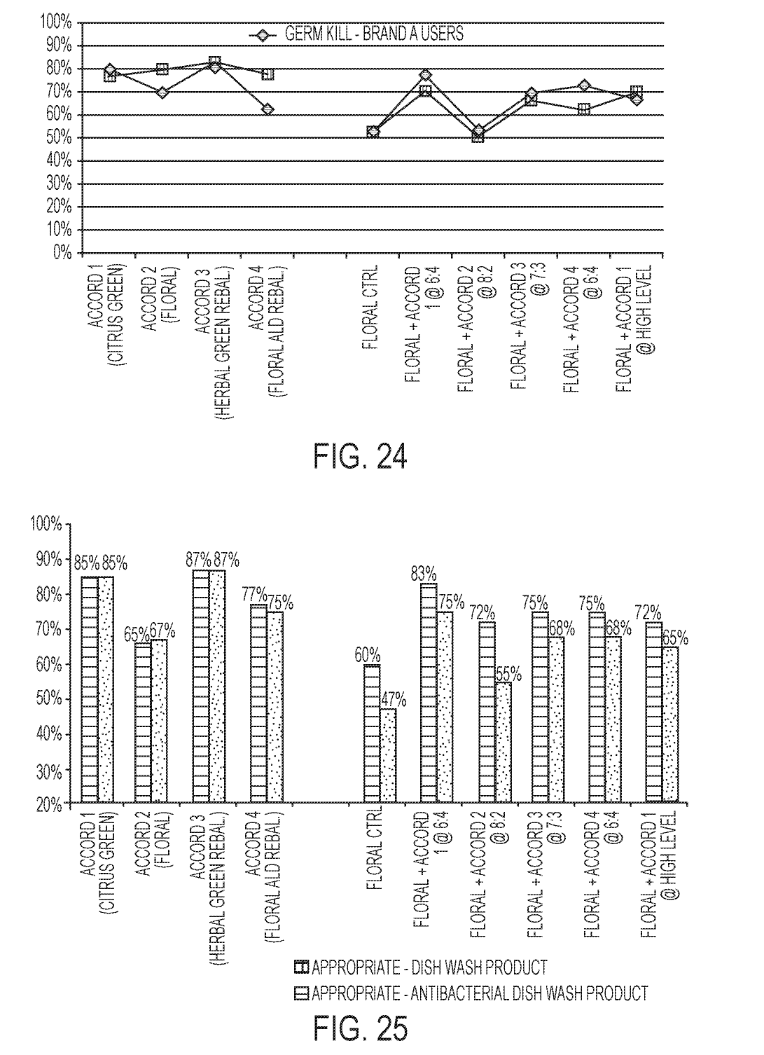

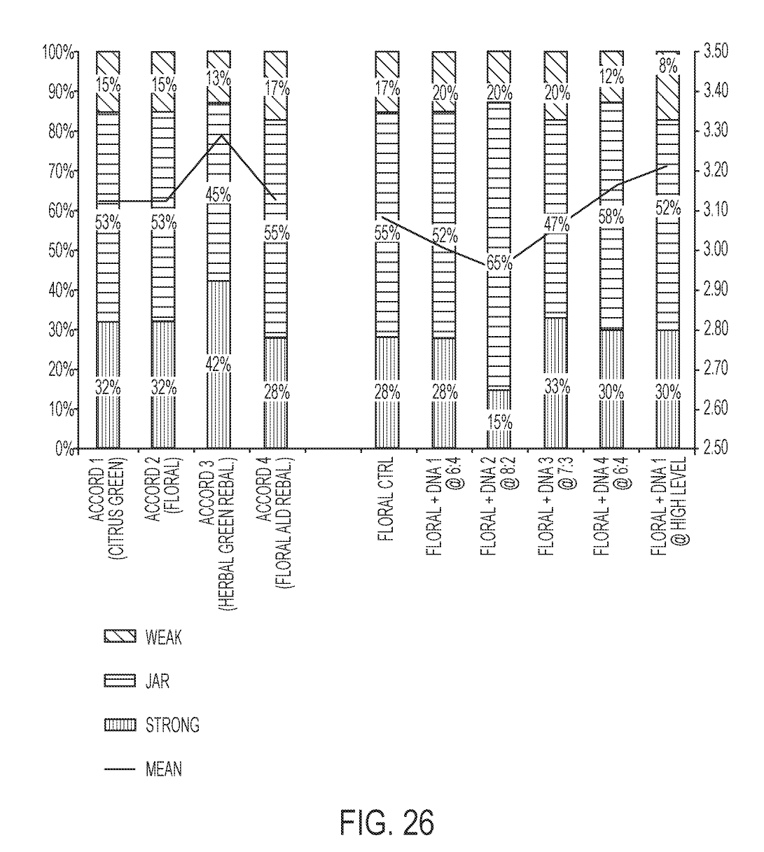

There were five attributes that were assessed: overall hygiene, germ removal, germ kill, suitability for a hand dish soap and perceived strength. Results of the scoring are shown in FIGS. 20-26. Participants were then asked to report whether the odor contained a particular fragrance. Results of perceived fragrance are shown in Table 11 (numbers in percentages). Participants were also asked to report whether the odor embodied a particular functional attribute. Results of perceived functional attribute are shown in Table 12 (numbers in percentages).

TABLE 11

| | 1 | 2 | 3 | 4 | 5 | 6 | 7 | 8 | 9 | 10 |
|---|---|---|---|---|---|---|---|---|---|---|
| Citrus | 83 | 63 | 82 | 82 | 22 | 65 | 37 | 48 | 57 | 63 |
| Fruity | 62 | 30 | 42 | 55 | 40 | 57 | 50 | 47 | 48 | 50 |
| Herbal/ | 23 | 50 | 30 | 23 | 13 | 18 | 12 | 22 | 10 | 15 |
| Leafy | | | | | | | | | | |
| Airy | 18 | 20 | 17 | 12 | 17 | 15 | 25 | 15 | 10 | 13 |
| breezy | | | | | | | | | | |
| Artificial | 15 | 25 | 20 | 20 | 32 | 12 | 7 | 12 | 25 | 20 |
| Sweet | 8 | 5 | 2 | 10 | 20 | 17 | 18 | 15 | 13 | 13 |
| Floral | 5 | 5 | 3 | 5 | 33 | 23 | 33 | 20 | 28 | 27 |
| Watery | 5 | 10 | 10 | 10 | 20 | 15 | 13 | 15 | 12 | 13 |
| Marine | | | | | | | | | | |
| Perfume | 3 | 5 | 8 | 5 | 18 | 12 | 17 | 22 | 18 | 13 |
| Woody | 3 | 30 | 18 | 12 | 7 | 5 | 7 | 10 | 7 | 5 |
| Cosmetic | 0 | 0 | 0 | 0 | 5 | 3 | 10 | 3 | 5 | 3 |
| Soapy | 0 | 3 | 2 | 2 | 13 | 2 | 17 | 10 | 8 | 5 |

TABLE 12

| | 1 | 2 | 3 | 4 | 5 | 6 | 7 | 8 | 9 | 10 |
|---|---|---|---|---|---|---|---|---|---|---|
| Fruity | 93 | 72 | 87 | 87 | 65 | 88 | 80 | 82 | 82 | 83 |
| Clean | 90 | 70 | 82 | 82 | 55 | 75 | 63 | 73 | 67 | 67 |
| tough | | | | | | | | | | |
| food/grease | | | | | | | | | | |
| Clean | 90 | 73 | 87 | 82 | 67 | 88 | 80 | 87 | 80 | 77 |
| Keeps skin | 63 | 62 | 60 | 60 | 70 | 70 | 77 | 67 | 72 | 62 |
| soft | | | | | | | | | | |
| Leaves | 80 | 62 | 75 | 65 | 48 | 72 | 53 | 65 | 62 | 65 |
| dishes | | | | | | | | | | |
| shiny | | | | | | | | | | |

Accords 1, 3, and 4 showed high potential to be active. These Accords can improve a finished fragrance from a different olfactive family.

Attribute deltas for fragrance plus Accord vs. control were larger for hygiene and functionality benefits than they were for hedonics or other attributes; this suggests that the Accords were driving these benefits.

Addition of any of the Accords (particularly Accord 1 and 3) improved functionality perception to the same extent. Accord 1 (Citrus Green component) and Accord 3 (Herbal Green Citrus component Rebalanced) showed the greatest promise for cuing hygiene benefits (although hedonics of Accord 4 married well with the tested floral fragrance). Accord 1 seemed to drive the benefit the most holistically across user groups while also carrying hedonics.

The results showed that brand usage had no significant effect on the perception of germ kill or germ removal; although, the groups do have somewhat different hedonic preferences.

### Example 55

The dual-compartment automatic dishwashing pouch is made comprising the ingredients detailed herein below. The pouches were made of polyvinyl alcohol (Monosol 8630 available from Kuraray) with the solid and liquid components in different compartments.

| Ingredients (active grams) | Composition |
|---|---|
| Solid | |
| MGDA | 6.00 |
| Sulphonated Polymer | 0.40 |
| Sodium carbonate | 4.00 |
| Amylase | 0.004 |
| Protease | 0.034 |
| Sodium Percarbonate | 2.00 |
| Bleach catalyst and bleach activator | 0.004 |
| HEDP | 0.10 |
| Miscellaneous | Balance to 15.26 |
| Liquid | |
| Plurafac SLF-180 | 0.84 |
| Lutensol TO7 | 0.89 |
| Miscellanous* | Balance to 2.18 |
| pH of 1% w/v in deionised water | 10.99 |
| RA at pH = 9.5 in NaOH 100 mL of | 14.31 |
| solid product | |

MGDA Tri-sodium salt of methyl glycine diacetic acid.
Amylase Stainzyme plus ® avalable from Novozymes
Protease Ultimase ® avalable from DuPont
Bleach activator TAED (Tetraacetylethylenediamine)
Bleach catalyst Manganese bleach catalyst
HEDP 1-hydroxyethylidene 1,1-diphosphonic acid
Plurafac SLF-180 Nonionic surfactant supplied by BASF
Lutensol TO7 Nonionic surfactant supplied by BASF
RA Reserve alkalinity
*Perfume disclosed herein. Preferably said perfume is selected from the group consisting of Table 1 perfumes 1, 3, 4, and 5, preferably said perfume is selected from the group consisting of Table 1 perfumes 1 and 5, more preferably said perfume is Table 1 Perfume 5

### Example 56

### Hand Dish Liquid Detergent Compositions

In this example, various hand dish liquid detergent formulations are provided. The following hand dish liquid detergent compositions of the present invention are provided below.

| | Composition | | | |
|---|---|---|---|---|
| | A | B | C | D |
| Linear Alkylbenzene Sulfonate¹ | — | | — | — |
| Alkyl Ethoxy Sulfate² | 18% | 17% | 17% | 18% |
| Paraffin Sulfonate (C15) | — | — | — | — |
| CAP = coco amido propyl Betaine | — | — | 9% | 5% |
| Nonionic³ | — | — | 1% | — |
| Amine Oxide⁴ | 6% | 5.5% | — | 4% |
| Alkylpolyglucoside | | | | 4% |
| Alcohol⁵ | — | — | 5% | 7% |
| Pura = polypropyleneglycol | 1% | 0.8% | — | — |
| Citrate | — | — | 0.3% | 0.6% |
| Salt⁶ | 1.2% | 1.0% | — | 0.5% |
| SCS = sodium cumene sulfonate | — | — | 0.8% | — |
| glycerol | 15% | 5% | 3% | — |
| Na-lactate | — | — | — | 5% |
| cationic polymer⁷ | 0.1% | 0.1% | 0.3% | 0.2% |
| Protease | 0.0075 | 0.0050 | 0.0025 | 0.030 |
| Glycol distearate from Euperlan ® | 0.4 | 0 | 0.4 | 0 |
| Cognis | | | | |
| Hydrogenated Castor Oil Thixcin ® | 0 | 0.1 | 0 | 0.1 |
| Elementis | | | | |
| Mica (BASF Mearlin superfine) | 0 | 0.05 | 0 | 0.05 |
| Perfume⁸ | 0.1 | 0.2 | 0.3 | 0.4 |
| Water & minors⁹ | Balance to 100% | | | |
| pH | 9 | 9 | 6 | 6 |

¹Linear Alkylbenzene Sulfonate: LAS: C11.4
²Alkyl Ethoxy Sulfate: AExS:
³Nonionic: AlkylEthoxylate
⁴Di-methyl coco alkyl amine oxide
⁵Alcohol: Ethanol
⁶Salt: NaCl
⁷cationically modified hydroxyethyl cellulose (Polyquaternium-10-UCARE LR-400 ex Amerchol).
⁸Perfume from Table 1 Nos. 1, 3, 4 and 5
⁹dyes, opacifier, perfumes, preservatives, hydrotropes, processing aids, and/or stabilizers

Examples of Hand Dishwashing formulations comprising a lipase.

| | 1 | 2 | 3 | 4 | 5 | 6 | 7 |
|---|---|---|---|---|---|---|---|
| | Wt % | Wt % | Wt % | Wt % | Wt % | Wt % | Wt % |
| Alkyl C₁₀₋₁₄ Ethoxy Sulphate | 26.9 | 21 | — | — | — | 5 | 15 |
| (AE0.6S) | | | | | | | |
| Alkyl C₁₀₋₁₄ Ethoxy Sulphate | — | — | 18 | 14 | 13 | — | — |
| (AE2S) | | | | | | | |
| Sodium alkyl benzene sulfonate | — | — | — | — | — | 8 | — |
| Sodium paraffin sulfonate | — | — | — | 6 | — | — | — |
| C12-14 dimethyl amine oxide | 6.1 | 7 | 6 | 5 | — | — | 6 |
| Cocamido propyl betaine | — | — | 8 | 5 | 4 | 2 | 4 |
| C12-13 EO7 nonionic | — | — | 0.2 | 0.1 | 0.5 | 2 | — |
| Branched Nonionic: 3-propyl | 1.0 | 0.5 | — | — | — | — | 1.0 |
| heptanol EO8 | | | | | | | |
| PEI600-EO10-PO7 block | — | 0.5 | — | — | — | 0.4 | 0.8 |
| polymer | | | | | | | |
| Lipase ¹ | 0.02 | 0.02 | 0.001 | 0.03 | 0.1 | 0.01 | 0.02 |
| Protease ² | — | 0.04 | — | — | — | — | — |
| Amylase ³ | 0.04 | 0.02 | 0.06 | 0.2 | 0.2 | 0.05 | 0.02 |
| 4-Formylphenylboronic acid | — | 0.1 | — | — | — | — | — |
| Potassium chloride | 1.5 | — | — | — | — | — | — |
| Calcium chloride | — | 1 | — | — | — | — | — |
| Sodium acetate | — | — | 1.5 | — | — | — | — |
| Potassium acetate | — | — | — | 2 | — | — | — |
| Sodium sulfate | — | — | — | — | 1 | — | — |
| Potassium sulfate | — | — | — | — | — | 1.5 | — |
| Potassium formate | — | — | — | — | — | — | 2 |
| Ethanol | 4.0 | 5.0 | 3.0 | 3.0 | 2.0 | — | 3.0 |
| Polypropylene glycol MW2000 | 1.1 | 0.8 | 1.1 | 1.1 | 1.1 | 0.5 | 1.1 |
| Sodium chloride | 1.3 | 0.8 | 1.3 | 0.5 | 0.8 | 1.3 | 1.3 |
| Perfume⁴ | 0.05 | 0.07 | 0.1 | 0.3 | 0.6 | 1.5 [symbol] | 0.2 |

| | |
|---|---|
| Water | to balance up to 100% |

Notes
¹ Lipase supplied by Novozymes A/S, Bagsvaerd, Denmark
² Protease is Savinase ®, supplied by Novozymes A/S, Bagsvaerd, Denmark
³ Amylase is Stainzyme ® supplied by Novozymes A/S, Bagsvaerd, Denmark
⁴Perfume from Table 1 Nos. 1, 3, 4 and 5

The dimensions and values disclosed herein are not to be understood as being strictly limited to the exact numerical values recited. Instead, unless otherwise specified, each such dimension is intended to mean both the recited value and functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A consumer product comprising:
a) a perfume selected from the group consisting of Table 1 perfumes 1, 3, 4, and 5; and
b) a cleaning and/or treatment ingredient.

2. A perfume delivery system selected from the group consisting of a Polymer Assisted Delivery (PAD) system, Molecule-Assisted Delivery (MAD) system, Cyclodextrin (CD) system, Starch Encapsulated Accord (SEA) system, Zeolite & Inorganic Carrier (ZIC) system, said perfume delivery system comprising a perfume selected from the group consisting of Table 1 perfumes 1, 3, 4, and 5.

3. A Polymer Assisted Delivery (PAD) system according to claim 2, wherein said Polymer Assisted Delivery (PAD) system comprises a Polymer Assisted Delivery (PAD) Reservoir system, preferably said Polymer Assisted Delivery (PAD) Reservoir system comprises a perfume delivery particle that comprises a shell material and a core material, said shell material encapsulating said core material, said core material comprising a perfume a perfume selected from the group consisting of Table 1 perfumes 1, 3, 4, and 5; said shell comprising a material selected from the group consisting of polyethylenes; polyamides; polystyrenes; polyisoprenes; polycarbonates; polyesters; polyacrylates; aminoplasts; and mixtures thereof.

4. The Polymer Assisted Delivery (PAD) Reservoir system of claim 3 wherein said shell comprises melamine formaldehyde and/or cross linked melamine formaldehyde.

5. The Polymer Assisted Delivery (PAD) Reservoir system of claim 4 wherein said shell is coated by a water-soluble cationic polymer selected from the group that consists of polysaccharides, cationically modified starch and cationically modified guar, polysiloxanes, dimethyldiallylammonium polyhalogenides, copolymers of dimethyldiallylammonium polychloride and vinyl pyrrolidone, acrylamides, imidazoles, imidazolinium halogenides and imidazolium halogenides and polyvinyl amine and its copolymers with N-vinyl formamide.

6. The Polymer Assisted Delivery (PAD) Reservoir system of claim 6 wherein said coating that coats said shell, comprises a cationic polymer and an anionic polymer.

7. The perfume delivery system of claim 2, wherein said perfume delivery particle is a perfume microcapsule.

8. A consumer product according to claim 1 comprising a perfume delivery system according to any of claims 2 through 6.

9. A consumer product comprising a perfume delivery system according to any of claims 2 through 7.

10. A method of treating and/or cleaning a situs, said method comprising
a) optionally washing and/or rinsing said situs;
b) contacting said situs with a consumer product according to claims 1, 8, and/or 9 and mixtures thereof; and/or a perfume delivery system according to claims 2-7 and mixtures thereof;
c) optionally washing and/or rinsing said situs; and
d) optionally drying said situs.

11. A situs treated with a consumer product according to claims 1, 8, and/or 9 and mixtures thereof; and/or a perfume delivery system according to claims 2 through 7 and mixtures thereof.

12. A process of making a perfume microcapsule comprising:
a) preparing a first solution comprising, based on total solution weight, from about 20% to about 90%, of a first emulsifier and a first resin, the ratio of said first emulsifier and said first resin being from about 0.1:1 to about 10:1;
b) preparing a second solution comprising based on total solution weight from about 20% to about 95% water, of a second emulsifier and a second resin, the ratio of said second emulsifier and said second resin being from about 0:1 to about 3:1;
c) combining a core material comprising a perfume selected from the group consisting of Table 1 perfumes 1, 3, 4, and 5; and said first solution to form a first composition;
d) emulsifying said first composition;
e) combining said first composition and said second solution to form a second composition and optionally combining any processing aids and said second composition;
mixing said second composition for at least 15 minutes at a temperature of from about 25° C. to about 100° C. and optionally combining any processing aids to said second composition;
g) optionally combining any scavenger material, structurant, and/or anti-agglomeration agent with said second composition during step f) or thereafter
h) optionally spray drying said second composition.
